(19) United States
(12) Patent Application Publication
(10) Pub. No.: US 2023/0380428 A1
(43) Pub. Date: Nov. 30, 2023

(54) BIODEGRADABLE CLEANING PRODUCTS, METHODS OF PRODUCTION, AND THEIR COMPOSITIONS

(71) Applicant: SUSTAINABLE COMMUNITY DEVELOPMENT, LLC, Kansas City, MO (US)

(72) Inventors: Matthew Wood, Kansas City, MO (US); Narin Tipsrisukond, Prairie Village, KS (US); Hasitha Guvvala, Overland Park, KS (US)

(21) Appl. No.: 18/031,856

(22) PCT Filed: Oct. 16, 2020
(86) PCT No.: PCT/US2020/056113

§ 371 Date: Apr. 13, 2023

(51) Int. Cl. A01N 63/22; A01P 1/00

(52) U.S. Cl. CPC A01N 63/22; A01P 1/00

(57) ABSTRACT

A biodegradable cleaning composition comprises one or more species of lactic acid bacteria, one or more species of Bacillus, water, and at least one additional element selected from the group consisting of at least one biodetergent, organic acid, diol, polyol, polymyxin, polysaccharide-lipid complex, fatty acid, monoterpene, sesquiterpene, preservative, essential oil, and carbon source. A biodegradable cleaning composition kit comprises at least one textile that has been treated with the biodegradable cleaning composition, wherein the treated textile is contained within an openable container.

### TECHNICAL FIELD

The present disclosure relates to biodegradable cleaning compositions, methods of production, and methods of use. More particularly, the present disclosure comprises a microbial consortium in culture medium configured for cleaning use.

### BACKGROUND

Scientific research and public opinion both increasingly value green technologies as replacements for traditional cleaning compositions. To achieve this end, beneficial microorganisms are used to obtain biochemicals through a controlled fermentation of natural ingredients. This process results in a composition comprising a consortium of viable beneficial microorganisms and their metabolites that provides cleaning properties.

### SUMMARY

The present disclosure provides for one or more biodegradable cleaning compositions containing at least one (i) species of beneficial microorganism, (ii) organic acid, and (iii) carbon source. In one or more embodiments, the biodegradable cleaning composition may comprise (i) at least one species of microbe selected from the group consisting of lactic acid bacteria and Bacillus, (ii) at least one carboxylic acid, (iii) at least one carbon source, and (iv) one or more added elements such as but not limited to an essential oil, monoterpene, sesquiterpene, carboxylic acid, fatty acid, and/or polyol.

The present disclosure also provides for one or more methods of using one or more biodegradable cleaning compositions of the present disclosure, generally comprising contacting a surface with a composition made according to any embodiment described herein. One illustrative and non-limiting example of a surface may comprise a countertop. One or more biodegradable cleaning compositions may be useful to achieve other beneficial outcomes as well.

### BRIEF DESCRIPTION OF THE DRAWINGS

FIG. 1 shows a first untargeted metabolomic data set pertaining to at least one embodiment of the biodegradable cleaning composition.

FIG. 2 shows a second untargeted metabolomic data set pertaining to at least one embodiment of the biodegradable cleaning composition.

FIG. 3 shows a third untargeted metabolomic data set pertaining to at least one embodiment of the biodegradable cleaning composition.

FIG. 4 shows a fourth untargeted metabolomic data set pertaining to at least one embodiment of the biodegradable cleaning composition.

FIG. 5 shows a fifth untargeted metabolomic data set pertaining to at least one embodiment of the biodegradable cleaning composition.

FIG. 6 shows a sixth untargeted metabolomic data set pertaining to at least one embodiment of the biodegradable cleaning composition.

FIG. 7 shows a seventh untargeted metabolomic data set pertaining to at least one embodiment of the biodegradable cleaning composition.

FIG. 8 shows an eighth untargeted metabolomic data set pertaining to at least one embodiment of the biodegradable cleaning composition.

FIG. 9 shows a ninth untargeted metabolomic data set pertaining to at least one embodiment of the biodegradable cleaning composition.

FIG. 10 shows a tenth untargeted metabolomic data set pertaining to at least one embodiment of the biodegradable cleaning composition.

FIG. 11 shows an eleventh untargeted metabolomic data set pertaining to at least one embodiment of the biodegradable cleaning composition.

FIG. 12 shows a twelfth untargeted metabolomic data set pertaining to at least one embodiment of the biodegradable cleaning composition.

FIG. 13 shows a thirteenth untargeted metabolomic data set pertaining to at least one embodiment of the biodegradable cleaning composition.

FIG. 14 shows a fourteenth untargeted metabolomic data set pertaining to at least one embodiment of the biodegradable cleaning composition.

FIG. 15 shows a fifteenth untargeted metabolomic data set pertaining to at least one embodiment of the biodegradable cleaning composition.

FIG. 16 shows a sixteenth untargeted metabolomic data set pertaining to at least one embodiment of the biodegradable cleaning composition.

FIG. 17 shows a seventeenth untargeted metabolomic data set pertaining to at least one embodiment of the biodegradable cleaning composition.

FIG. 18 shows an eighteenth untargeted metabolomic data set pertaining to at least one embodiment of the biodegradable cleaning composition.

### DETAILED DESCRIPTION

The present biodegradable cleaning composition may comprise at least one species of beneficial microorganism, at least one organic acid, at least one carbon source, and water. In some embodiments, the biodegradable cleaning composition may comprise one or more species of lactic acid bacteria, one or more species of Bacillus, water, and at least one additional element selected from the group consisting of at least one essential oil, carbon source, biodetergent, organic acid, diol, polyol, polymyxin, polysaccharide-lipid complex, fatty acid, monoterpene, sesquiterpene, ketone, hydrocarbon, aldehyde, polymer, and gas.

In some embodiments, the present invention may comprise a kit comprising an individual use packet containing a textile that has been soaked in the biodegradable cleaning composition. In some embodiments, the present invention may comprise a kit comprising a dispenser that contains multiple textiles that have been soaked with the biodegradable cleaning composition.

In some embodiments, the at least one species of lactic acid bacteria may be one or more species of Carnobacterium sp. Enterococcus sp. Lactobacillus sp. Lactococcus sp. Leuconostoc sp. Oenococcus sp. Streptococcus sp. Tetragenococcus sp. Vagococcus sp. and Weissella sp.

In some embodiments, the at least one species of Bacillus may be selected from the group consisting of Bacillus licheniformis, Bacillus coagulans, and Bacillus subtilis.

In some embodiments, the microorganism consortium in culture medium may produce one or more metabolites. These metabolites, in some embodiments, may be characterized by strong polar groups, mainly anionic, and active functional radicals that enable them to combine with other organic molecules. In some embodiments, the metabolites may provide high reactivity to combine other molecules through multiple functional radicals. The metabolites, in some embodiments, may comprise molecules that can disseminate into small spaces, such as between fibers or into fine cracks on a surface, such as a countertop. The metabolites, in some embodiments, may possess bactericidal-like properties due to the presence of one or more carboxylic acids. The metabolites, in some embodiments, may possess hydrotropic properties that provide hydration and increase solubility of the substances to which they combine.

In some embodiments, the biodegradable cleaning composition may be prepared by fermenting a culture medium for a period of time. In some embodiments, the fermentation period may comprise at least 5 days. In preferred embodiments, the fermentation period may comprise 14 days or more.

In some embodiments, following the fermentation period, the fermented product may be decanted from a fermentation tank via at least one centrifuge. In some embodiments, the centrifuge may be a solid-liquid separation centrifuge. The solid-liquid separation centrifuge, in some embodiments, may comprise a bowl centrifuge configured to run at 10,000 rpm to 15,000 rpm for a gravitational force equivalent (g-force) of 12,400 g to 15,000 g, or in some embodiments at 22,000-23,000 rpm. In some embodiments, the fermented product may be passed through a filter prior to introduction into the centrifuge. In some embodiments, the filter may comprise a 30-micron filter. In some embodiments, after passing through the filter, the fermented product may be fed into the centrifuge at a material feed rate of 150 cc/minute. The centrifuge may spin the base material at 22,000 to 23,000 rpm for one or more minutes. The biodegradable cleaning composition may then be extracted from the centrifuge.

As used herein, the term “additional element” refers to any element named in reference to the term “added element,” whether that element is a metabolite of any microorganism found in the biodegradable cleaning composition or a metabolite produced by a microorganism of another source, or whether the element is produced via another process not involving a microorganism and is then added to the biodegradable cleaning composition at any step or phase, including but not limited to any day or stage of fermentation or to its finished form or state. Generally, it is contemplated that one or more microbial species of the biodegradable cleaning composition may produce the one or more added elements that may comprise part of the biodegradable cleaning composition. In other embodiments, however, the one or more added elements of the biodegradable cleaning composition may be produced independently of the biodetergent cleaning composition and may be added to the biodegradable cleaning composition. It is contemplated, therefore, that any added element comprising part of the biodegradable cleaning composition may have been produced as a metabolite by a microbe that is itself part of the biodegradable cleaning composition, may have been produced by another means and added to the biodegradable cleaning composition, or both.

Similarly, as used herein, the term “biodetergent” refers to any detergent produced as a metabolite by a microorganism, whether the microorganism is a part of the biodegradable cleaning composition or of another source. “Detergent” means a detergent not produced by a microorganism. Similarly, any molecule produced by a microorganism may be referred to herein as a biomolecule. Generally, it is contemplated that one or more microbial species of the biodegradable cleaning composition may produce the one or more biodetergents that may comprise part of the biodegradable cleaning composition. In other embodiments, the one or more biodetergents of the biodegradable cleaning composition may be produced independently of the biodetergent cleaning composition and may be added to the biodegradable cleaning composition. It is contemplated, therefore, that any biodetergent comprising part of the biodegradable cleaning composition may have been produced as a metabolite by a microbe that is itself part of the biodegradable cleaning composition, may have been produced by another means and added to the biodegradable cleaning composition, or both.

In some embodiments, the at least one biodetergent may include but is not limited to glycolipid biodetergents, phospholipid biodetergents, polymeric biodetergents, lipopeptide biodetergents, cyclic lipopeptides, crude cyclic lipopeptides, lipopeptide detergents, surfactin, iturin, fengycin, arthrofactin, emulsan, sophorolipids, rhamnolipids, trehalose

lipids, sucrose lipids, fructose lipids, mycolates, mannosyl erythritol lipids, corynemycolic acids, lichenysins, peptidolipids, mannan-fatty acid complex, proteo-lipid-carbohydrate complexes, biodetergents produced by Achromobacter sp. Acinetobacter sp. Arthrobacter sp. Bacillus sp. Bacillus atrophaeus, Bacillus cereus, Bacillus licheniformis, Bacillus pumilus, Bacillus siamensis, Bacillus subtilis, Bacillus thuringiensis, Candida sp. Candida bogoriensis, Candida petrophilum, Candida tropicalis, Corynebacterium lepus, Corynebacterium hydrocarboclastus, Flavobacterium sp. Micrococcus sp. Paenibacillus sp. Pseudomonas sp. Rhodococcus sp. Torulopsis sp. and biodetergents produced by any other microbial species named herein or known to produce biodetergents.

Additionally, in one or more embodiments, the at least one biodetergent may comprise one or more of docusate (dioctyl sodium sulfosuccinate), lithium dodecyl sulfate (LDS), sodium laureth sulfate (sodium dodecyl sulfate or SDS), sodium myreth sulfate, ammonium lauryl sulfate, perfluorooctanesulfonate (PFOS), perfluorobutanesulfonate, sodium cholate, sodium deoxycholate, sodium glycholate, sodium taurocholate, sodium tauro-deoxycholate, sodium lauroyl sarcosinate (N-laurylsarcosine), hexadecyltrimethylammonium bromide, tetradecyltrimethylammonium bromide, dodecyltrimethylammonium bromide, alkyl polyglycoside, cetomacrogol 1000, cetostearyl alcohol, cetyl alcohol, cocamide DEA, cocamide MEA, decyl glucoside, decyl polyglucose, Eusapon BW, Eusapon EM, Eusapon FB-WT, Eusapon OC, Eusapon OD, Eusapon OE, Eusapon W, glycerol, glycerol trilaurate monostearate, IGEPAL CA-630, isoceteth-20, lauryl glucoside, maltosides, monolaurin, mycosubtilin, narrow-range ethoxylate, nonidet P-40, nonoxynol-9, nonoxynols, nonyl phenoxypolyethoxylethanol, octaethylene glycol monododecyl ether, n-octyl-β-D-glucoside, n-octyl beta-D-thioglucopyranoside, n-octyl-β-D-gluco-pyranoside, genapol C-100, genapol X-100, octyl glucoside, oleyl alcohol, PEG-10 sunflower glycerides, pentaethylene glycol monododecyl ether, polidocanol, poloxamer, poloxamer 407, polyethoxylated tallow amine, polyglycerol polyricinoleate, polysorbate, polysorbate 20, polysorbate 40, polysorbate 60, polysorbate 65, polysorbate 80, sorbitan, sorbitan monolaurate, sorbitan monostearate, sorbitan tristearate, stearyl alcohol, surfactin, digitonin, n-Dodecyl β-D-maltoside (DDM), triton X-100, triton X-114, tween 20, tween 40, tween 60, tween 80, n-dodecyl tetra (ethylene oxide), n-octyl β-D-thioglucopyranoside (octylthioglucoside, OTG), dimethyl dodecyl phosphine oxide, dimethyldecylphosphine oxide, n-decyl-β-D-maltopyranoside, n-dodecyl-β-D-maltopyranoside, 6-cyclohexyl-1-hexyl-β-D-maltopyranoside n-octyl glucoside, n-nonanoyl-n-methylglucamine, n-octanoyl-n-methylglucamine, n-decanoyl-n-methylglucamine, any acyl-n-methylglucamide (MEGA) detergent, amidosulfobetaine-14, amidosulfobetaine-16, 3-[(3-cholamidopropyl)dimethylammonio]-1-propanesulfonate (CHAPS), 3-[(3-Cholamidopropyl)dimethylammonio]-2-hydroxy-1-propanesulfonate (CHAPSO), 3-(4-Heptyl)phenyl-3-hydroxypropyl)dimethylammoniopropanesulfonate (C7BzO), 3-(N,N-dimethyloctylammonio)propanesulfonate, 3-(dimethyl-octylazaniumyl)propane-1-sulfonate, cocamidopropyl hydroxysultaine, cocamidopropyl betaine, and 3-(1-pyridinio)-1-propanesulfonate.

In some embodiments, the biodegradable cleaning composition may comprise one or more organic acids, such as but not limited to acetic acid, adipic acid, azelaic acid, carboxylic acid(s) such as but not limited to enoic acid, methyl 13,16-octadecadiynoate, and trimethylsilyl (3E)-3-methyl-5-[(trimethylsilyl)oxy]-3,5-hexadienoate, benzoic acid, dihydroxy benzoic acid, 2,3-benzoic acid, dihydroxy benzoic acid, tricarboxylic acid(s), propane-1, 2, 3-tricarboxylic acid, citric acid, homo citric acid, isocitric acid, itaconic acid, gluconic acid, glycolic acid, lactic acid, malic acid, methylmaleic acid, propionic acid, pyruvic acid, succinic acid, sebacic acid, tartaric acid, and uric acid.

In some embodiments, the biodegradable cleaning composition may comprise one or more diols such as but not limited to 1,2-propanediol (propylene glycol), 2,2-propanediol, 1,1-propanediol, 1,3-propanediol, butane diol(s), 1,4-butanediol, ethylene glycol, geminal diols, vicinal diols, 1,3-diols, 1,4-diols, 1,5-diols, longer than 1,5-diols, 5-(1-Hydroxy-1-methylethyl)-2-methyl-2-cyclohexene-1,4-diol, and aliphatic diols.

In some embodiments, the biodegradable cleaning composition may comprise one or more polyols, or sugar alcohols, such as but not limited to ethylene glycol, glycerol, glycerol trilaurate, erythritol, threitol, arabitol, D-(+)-arabitol, L-(−)-arabitol, xylitol, ribitol, mannitol, D-mannitol, sorbitol, glucitol, D-glucitol, galactitol, fucitol, iditol, inositol, volemitol, isomalt, maltitol, lactitol, maltotriitol, maltotetraitol, and polyglycitol, as well as any polyethylene glycol, or more polyethylene glycols (PEG), such as but not limited to monofunctional PEGs, homobifunctional PEGs, heterobifunctional PEGs, linear PEGs, multi-arm PEGs, Y-shaped PEGs, low molecular weight PEGs (less than 5 kDa), PEGs of less than 40 kDa, PEGs greater than 40 kDa, poly(ethylene glycol), polyethylene glycol 40, polyethylene glycol 200, polyethylene glycol 300, polyethylene glycol 400, polyethylene glycol 600, polyethylene glycol 1000, polyethylene glycol 1500, polyethylene glycol 3000, polyethylene glycol 3500, polyethylene glycol 4000, polyethylene glycol 6000, polyethylene glycol 8000, poly(ethylene glycol) bis(amine), poly(ethylene glycol) bisazide, poly(ethylene glycol) bis(carboxymethyl) ether, poly(ethylene glycol) diacrylate, poly(ethylene glycol) diamine, poly(ethylene glycol) dibenzoate, poly(ethylene glycol) diglycidyl ether, poly(ethylene glycol) dimethacrylate, poly(ethylene glycol) dimethyl ether, poly(ethylene glycol) dithiol, poly(ethylene glycol) methacrylate, poly(ethylene glycol) methyl ether, poly(ethylene glycol) methyl ether methacrylate, poly(ethylene glycol) monolaurate, poly(ethylene glycol) monooleate, poly(ethylene glycol) sorbitol, glucitol, D-glucitol hexaoleate, poly(ethylene glycol) tetrahydrofurfuryl ether, and any other PEG. The present invention contemplates the use of any commercially available PEG not named herein as well. In some embodiments, the at least one polyol may comprise, but is not limited to, a sugar alcohol or a low molecular weight polyol.

In some embodiments, the biodegradable cleaning composition may comprise one or more polymyxins, such as but not limited to polymyxin A, polymyxin B, polymyxin B1, polymyxin B nonapeptide, polymyxin C, polymyxin D, and polymyxin E (colistin), and other cationic cyclic decapeptides.

In some embodiments, the biodegradable cleaning composition may comprise one or more polysaccharide-lipid complexes, and polysaccharide-lipid-protein complexes, such as but not limited to lipopolysaccharides, lipooligosaccharides, and endotoxins produced by a microbe selected from the group comprising but not limited to E. coli O26, E. coli EH-100, E. coli 0111, E. coli 055, E. coli 0127, E. coli 0128, E. coli F-583, E. coli J5, E. coli K-235, Pseudomonas aeroginosa 10, Salmonella, Salmonella enteritidis, Salmonella minnesota, Salmonella minnesota strain Re595, Salmonella typhimurium, Salmonella typhimurium strain SL1181, Salmonella typhimurium strain TV119, Salmonella typhosa, and Serratia marcescens.

In some embodiments, the biodegradable cleaning composition may comprise one or more fatty acids, either one or more saturated fatty acids, one or more unsaturated fatty acids, or one or more saturated fatty acids and unsaturated fatty acids. In some embodiments, the fatty acid of the biodegradable cleaning composition may comprise a saturated fatty acid including but not limited to formic acid, acetic acid, propionic acid, butyric acid, isobutyric acid, valeric acid, isovaleric acid, caproic acid, enanthic acid, caprylic acid, pelargonic acid, capric acid, undecylic acid, lauric acid, tridecylic acid, myristic acid, pentadecanoic acid, palmitic acid, margaric acid, stearic acid, nonadecylic acid, arachidic acid, heneicosylic acid, behenic acid, tricosylic acid, lignoceric acid, pentacosylic acid, cerotic acid, heptacosylic acid, montanic acid, nonacosylic acid, melissic acid, hentriacontylic acid, lacceroic acid, psyllic acid, geddic acid, ceroplastic acid, hexatriacontylic acid, heptatriacontanoic acid, octatriacontanoic acid, nonatriacontanoic acid, and tetracontanoic acid.

In some embodiments, the fatty acid of the biodegradable cleaning composition may comprise one or more unsaturated fatty acids, such as but not limited to (i) Omega-3 unsaturated fatty acids, including but not limited to octanoic acid, decanoic acid, decadienoic acid, eicosatrienoic acid, hexadecatrienoic acid, lauroleic acid, laurolinoleic acid, myristovaccenic acid, myristolinoleic acid, myristolinolenic acid, palmitolinolenic acid, palmitidonic acid, α-linolenic acid, stearidonic acid, dihomo-α-linolenic acid, eicosatrienoic acid, eicosatetraeonic acid, eicosapentaenoic acid, heneicosapentaenoic acid, clupanodonic acid, docosahexaenoic acid, docosapentaenoic acid tetracosapentaenoic acid, and tetracosahexaenoic acid; (ii) Omega-5 unsaturated fatty acids, including but not limited to myristoleic acid, palmitovaccenic acid, α-eleostearic acid, β-eleostearic acid, punicic acid, 7,10,13-octadecatrienoic acid, 9,12,15-eicosatrienoic acid, and β-eicosatetraenoic acid; (iii) Omega-6 unsaturated fatty acids, including but not limited to 8-tetradecenoic acid, 12-octadecenoic acid, linoleic acid, linolelaidic acid, gamma-linolenic acid, calendic acid, eicosadienoic acid, pinolenic acid, dihomo-linoleic acid, dihomo-gamma-linolenic acid, docosadienoic acid, arachidonic acid, tetracosatetraenoic acid, tetracosapentaenoic acid, adrenic acid, and osbond acid; (iv) Omega-7 unsaturated fatty acids, including but not limited to palmitoleic acid, vaccenic acid, 11-octadecanoic acid, cis-vaccenic acid, rumenic acid, paullinic acid, 5-dodecenoic acid, 7-tetradecenoic acid, 7,10,13-eicosatrienoic acid, 15-docosenoic acid, and 17-tetracosenoic acid; (v) Omega-9 unsaturated fatty acids, including but not limited to oleic acid, elaidic acid, gondoic acid, erucic acid, nervonic acid, 8,11-eicosadienoic acid, ximenic acid, and mead acid; (vi) Omega-10 unsaturated fatty acids, including but not limited to sapienic acid; (vii) Omega-11 unsaturated fatty acids, including but not limited to gadoleic acid; and (viii) Omega-12 unsaturated fatty acids, including but not limited to 4-hexadecenoic acid, petroselinic acid, and 8-eicosenoic acid.

In some embodiments, the biodegradable cleaning composition may comprise one or more terpenes or terpenoids, such as but not limited to one or more monoterpenes, sesquiterpenes, diterpenes, sesterterpenes, triterpenes, sesquarterpenes, tetraterpenes, polyterpenes, norisoprenoids, ursane-type triterpenes, isoprene, prenol, isovaleric acid, geraniol, terpineol or a-terpineol, limonene, myrcene, linalool, 6,7-dihydro-7-hydroxylinalool, pinene, iridoids, humulene, farnesenes, farnesol, cafestol, kahweol, cembrene, taxadiene, terpin, geranylfarnesol, lanosterol, cycloartenol, ferrugicadiol, tetraprenylcurcumene, lycopene, gamma-carotene, any alpha-carotene or beta-carotene, gutta-percha, 3-oxo-α-ionol, 7,8-dihydroionone, megastigmane-3,9-diol, 3-oxo-7,8-dihydro-α-ionol, citronellal, camphor, 3-carene, ascaridole, bornane, borneol, camphene, camphor, camphorquinone, carvacrol, carveol, carvone, carvonic acid, chrysanthemic acid, chrysanthenone, citral, a-citral, b-citral, citronellal, citronellol, cuminaldehyde, p-cymene, cymenes, epomediol, eucalyptol, 1,8-cineole (11, eucalyptol), 2,3-dehydro-1,8-cineole, fenchol, fenchone, geranic acid, geraniol, geranyl acetate, geranyl pyrophosphate, grandisol, grapefruit mercaptan, halomon, hinokitiol, hydroxycitronellal, 8-hydroxygeraniol, incarvillateine, (s)-ipsdienol, jasmolone, lavandulol, lavandulol acetate, lavandulyl acetate, levoverbenone, limonene, linalool, 6,7-dihydro-7-hydroxylinalool, linalyl acetate, lineatin, p-menthane-3,8-diol, menthofuran, menthol, menthone, menthoxypropanediol, menthyl acetate, 2,6-octadien-1-ol, 3,7-dimethyl-,acetate, 2-methylisoborneol, myrcene, myrcenol, nerol, neryl alcohol, nerol, neryl alcoholic acid, ocimene, 8-oxogeranial, paramenthane hydroperoxide, perilla ketone, perillaldehyde, perillartine, perillene, phellandrene, α-phellandrene, α-phellandrene-8-ol, β-phellandrene, picrocrocin, pinene, alpha-pinene, beta-pinene, piperitone, pulegone, rhodinol, rose oxide, sabinene, safranal, sobrerol, terpinen-4-ol, terpinene, terpineol or a-terpineol, thujaplicin, thujene, thujone, thymol, thymoquinone, umbellulone, verbenol, verbenone, abscisic acid, amorpha-4,11-diene, aristolochene, artemether, artemotil, artesunate, bergamotene, bisabolene, bisabolol, bisacurone, botrydial, cadalene, cadinene, y-cadinene, cadina-1,4 diene, cadina-1(10),4-diene, alpha-cadinol, delta-cadinol, capnellene, capsidiol, carotol, caryophyllene, b-caryophyllene, caryphyllene oxide, cedrene, cedrol, copaene, cubebene, cubebol, curdione, curzerene, curzerenone, dictyophorine, drimane, elemene, farnesene, farnesol, farnesyl pyrophosphate, germacrene, germacrone, guaiazulene, guaiene, guaiol, gyrinal, hernandulcin, humulene, indometacin farnesyl, ionone, isocomene, juvabione, khusimol, koningic acid, ledol, longifolene, matricin, mutisianthol, nardosinone, nerol, neryl alcoholidol, nootkatone, norpatchoulenol, onchidal, patchoulol, periplanone b, petasin, phaseic acid, polygodial, rishitin, α-santalol, β-santalol, santonic acid, selinene, spathulenol, thujopsene, tripfordine, triptofordin c-2, valencene, velleral, verrucarin a, vetivazulene, α-vetivone, zingiberene, wine lactone and others. Terpenes and other organic or nonorganic compounds useful in the present invention are described by Allinger et al. in Organic Chemistry, pages 783-786 (1971), Worth Publishers Inc., and in Kirk and Othmer's Encyclopedia of Chemical Technology, Vol. 22, pages 709-762 (1978), John Wiley & Sons, which are incorporated herein by reference.

In some embodiments, the biodegradable cleaning composition may also comprise at least one preservative, such as but not limited to potassium sorbate, calcium sorbate, calcium ascorbate, sodium sorbate, sodium ascorbate, sodium erythorbate, sodium benzoate, sodium sulfite, sodium bisulfite, sodium metabisulfite, sodium nitrite, sodium nitrate, sodium iso-ascorbate, potassium ascorbate, potassium acetate, potassium benzoate, potassium bisulphite, potassium nitrate, potassium nitrite, potassium bisulfite, potassium metabisulfite, potassium diacetate, potassium lactate, butylated hydroxyanisole (BHA), butylated hydroxytolu balsam oilene (BHT), disodium ethylenediaminetetraacetic acid (EDTA), citric acid, organic citric acid, sulphur dioxide, propyl paraben, methyl paraben, benzene, acetic acid, tocopherol, ascorbic acid, erythorbic acid, iso-ascorbic acid, benzoic acid, wood smoke, ethyl lauroyl arginate, 4-hexylresorcinol, methyl-ρ-hydroxy benzoate, nisin, propionic acid, propyl-ρ-hydroxy benzoate, sorbic acid, natamycin, dimethyl decarbonate, and any other commercially available preservative.

In embodiments containing one or more preservatives, by way of non-limiting illustration, the biodegradable cleaning composition may comprise one or more preservatives in a ratio of from about 0.01-3.0 wt/wt %. Preferably, the biodegradable cleaning composition may comprise one or more preservatives in a ratio of from about 0.1-0.3 wt/wt %.

In embodiments of the biodegradable cleaning composition comprising one or more preservatives, the biodegradable cleaning composition containing one or more preservatives may demonstrate a novel and unexpected antimicrobial effect. At least one antimicrobial effect may comprise, but it not limited to, the inhibition or elimination of pathogens on a surface without the inhibition or elimination of one or more microorganisms comprising part of the biodegradable cleaning composition. Data confirming this premise is presented as Example 3. In preferred embodiments, the preservative may comprise potassium sorbate in a ratio of from about 0.01-0.3 wt/wt % of the biodegradable cleaning composition. In other preferred embodiments, the preservative may comprise potassium sorbate in a ratio of from about 0.01-0.1 wt/wt % of the biodegradable cleaning composition. However, any ratio described herein is contemplated. In other preferred embodiments, the preservative may comprise citric acid or organic citric acid in a ratio of from about 0.01-0.3 wt/wt % of the biodegradable cleaning composition. In other preferred embodiments, the preservative may comprise potassium sorbate in a ratio of from about 0.1-0.5 wt/wt % of the biodegradable cleaning composition. However, any ratio described herein is contemplated.

In some embodiments, the biodegradable cleaning composition containing one or more preservatives may inhibit or eliminate pathogens such as, but not limited to, S. typhimurium, Pseudomonas aeruginosa, Staphylococcus aureus, and Escherichia coli. Additional pathogenic microorganisms that may be inhibited or eliminated by the biodegradable cleaning composition can be found in A Clinician's Dictionary of Pathogenic Microorganisms by James H. Jorgensen, Michael A. Pfellerauthors, ASM Press, Washington, DC, ISBN: 1-55581-280-5.

In some embodiments, the biodegradable cleaning composition may also comprise one or more essential oils (or “natural oils”) that may, in some embodiments, serve as a deodorant, a deodorizer, an insect repellant, an insecticide, an adjuvant that enhances one or more of the biodegradable cleaning composition's other properties, or as a fertilizer or biostimulant. Such essential oils or natural oils may include, without limitation, African lemon bush (Lippia javanica) oil, anise oil, bay oil, bergamot oil, boronia oil, canola oil, carrot oil, cassia oil, catnip oil, cedarwood oil, chamomile oil, cilantro oil, cinnamon oil, citronella oil, clary sage oil, clove oil, coriander oil, cypress oil, eucalyptus oil, galbanum oil, garlic oil, ginger oil, geranium oil, grapefruit oil, hazelnut oil, jasmine oil, jojoba oil, lavender oil, lavandin oil, lemon oil, lemongrass oil, lime oil, mandarin oil, nutmeg oil, orange oil, palma rosa oil, patchouli oil, pine oil, Peru balsams, peppermint oil, rosemary oil, rosewood oil, sage oil, sandalwood oil, spear mint oil, star anise oil, tea tree oil, tangerine oil, thyme oil, tolu balsam oil, verbena oil, white clover oil, ylang ylang oil, and combinations thereof. Essential oils may be organic or not organic. Preferably, the essential oil is provided in an organic form. In preferred embodiments, the essential oil is present in an organic form.

In some embodiments, the at least one added element may further comprise a hydrocarbon, such as but not limited to cyclohexane, cyclohexene, 3-acetoxy-4-(1-hydroxy-1-methylethyl)-1-methyl, cycloehexane, an aldehyde such as but not limited to 2-furaldehyde (furfural), a ketone such as but not limited to sulcatone, nonanone, or 4-nonanone, tagalose, D-(−)-tagalose, D-(+)-tagalose, mannopyranose, b-D-(+)-mannopyranose, b-D-(−)-mannopyranose, sulctone, 2,3-dehydro-1,8-cineole, a-phellandren-8-ol, 2,6-octadien-1-ol, 3,7-dimethyl-acetate, caryophyllene, g-cadinene, cadina-1(10),4-diene, carophyllene oxide, [(2-ethyl-5-methylfuran-3,4-diyl)bis(oxy)]bis(trimethylsilane), a polymer such as siloxane or pentasiloxane, or a gas such as silane or [(2-Ethyl-5-methylfuran-3,4-diyl)bis(oxy)]bis(trimethylsilane).

The biodegradable cleaning composition may further comprise one or more carbon sources, including rum, molasses, glucose, starch, cellulose, fructose, sucrose, or the like. In one embodiment, the carbon source is plant material such as silage. In another embodiment, the carbon source is a plant material from the grass family Poaceae. In some embodiments, the carbon source may comprise a relatively unrefined plant material, such as silage, stover, chaff, grass, stalks, leaves, and the like. In other embodiments, the carbon source comprises a more refined plant material, such as flour, syrup, molasses, or the like. In another embodiment, the carbon source comprises purified or semi-purified organic molecules, such as protein, fat, fatty acids, carbohydrates, or the like. In a more specific embodiment, the carbon source comprises a bran from grain, such as, e.g., rice bran, or a syrup or molasses from sugar cane. Further examples of suitable carbon sources include, without limitation, peptone, yeast extract, amino acids, other sugars such as arabinose, mannose, glucosamine, maltose, sugar cane, molasses, rum, and the like; salts of organic acids such as acetic acid, fumaric acid, adipic acid, propionic acid, citric acid, gluconic acid, malic acid, methylmaleic acid, pyruvic acid, malonic acid and the like; alcohols such as ethanol, glycerol, glycerol trilaurate, and the like; or oil or fat such as soybean oil, rice bran oil, olive oil, corn oil, and sesame oil. The amount of the carbon source added varies according to the kind of carbon source and is typically between 1 to 100 grams per liter of medium. The weight fraction of the carbon source in the biodegradable cleaning composition may be about 98% or less, about 95% or less, about 90% or less, about 85% or less, about 80% or less, about 75% or less, about 70% or less, about 65% or less, about 60% or less, about 55% or less, about 50% or less, about 45% or less, about 40% or less, about 35% or less, about 30% or less, about 25% or less, about 20% or less, about 15% or less, about 10% or less, about 5% or less, about 2%, or about 1% or less of the total weight of the biodegradable cleaning composition. Preferably, molasses is contained in the medium as a carbon source, at a concentration of about 2 to 20% (w/v). More preferably, the molasses is at a concentration of about 4 to 6% (w/v).

In some embodiments, the biodegradable cleaning composition may be applied to a textile or textile-derived products, such as but not limited to a towel, wipe, gauze roll, gauze pad, cloth, glove, handkerchief, washcloth, mophead, microfiber cloth, or other porous or nonporous item configured to apply the biodegradable cleaning composition to a surface. In some embodiments, the textile may be composed of lyocell, rayon, cotton polyester, polypropylene, or more generally of woven or nonwoven materials, or synthetic or nonsynthetic materials. Any commercially available textile known to be used in cleaning wipes is contemplated herein.

In embodiments providing for the use of the biodegradable cleaning composition on a textile, the biodegradable cleaning composition may be applied to the textile according to at least one ratio. In such embodiments, the ratio my comprise 0.01 ml per sheet to 30 ml per sheet, 1 ml per sheet to 20 ml per sheet, 5 ml per sheet to 15 ml per sheet, 1 ml per sheet, 1.5 ml per sheet, 2 ml per sheet, 2.5 ml per sheet, 3 ml per sheet, 3.5 ml per sheet, 4 ml per sheet, 4.5 ml per sheet, 5 ml per sheet, 5.5 ml per sheet, 6 ml per sheet, 6.5 ml per sheet, 7 ml per sheet, 7.5 ml per sheet, 8 ml per sheet, 8.5 ml per sheet, 9 ml per sheet, 9.5 ml per sheet, 10 ml per sheet, 10.5 ml per sheet, 11 ml per sheet, 11.5 ml per sheet, 12 ml per sheet, 12.5 ml per sheet, 13 ml per sheet, 13.5 ml per sheet, 14 ml per sheet, 14.5 ml per sheet, 15 ml per sheet, 15.5 ml per sheet, 16 ml per sheet, 16.5 ml per sheet, 17 ml per sheet, 17.5 ml per sheet, 18 ml per sheet, 18.5 ml per sheet, 19 ml per sheet, 19.5 ml per sheet, 20 ml per sheet, 20.5 ml per sheet, and greater than 20.5 ml per sheet. In some embodiments, the ratio is from 6.67 ml per sheet to 11.67 ml per sheet. All of the above ratio ranges are contemplated.

In some embodiments, one or more compounds of the biodegradable cleaning composition may be produced by fermentation of selected probiotic strains in a selected medium under defined fermentation conditions; wherein final product has a pH value of <4.0 with activity in pH range from 2 to 12, percent total acidity (Lactic Acid meq) between about 0.6 and about 3.2 E24 values-between about 50% and about 90%; and surface tension between about 20 dyne/cm and about 38 dyne/cm.

In some embodiments, methods of manufacturing the biodegradable cleaning composition may comprise adding one or more stabilizers, microbial inoculants, antioxidants, or preservatives to the starting probiotic culture, the fermented product, or the biodegradable cleaning composition product. In some embodiments, one or more elements named elsewhere herein, such as but not limited to one or more biodetergents, fatty acids, polyethylene glycols, polyols, diols, polysaccharide-lipid complexes, may be used as one or more stabilizers. In some embodiments, one or more organic acids, monoterpenes, sesquiterpenes, essential oils, diols, or any other element named herein may be used as one or more preservatives. In some embodiments, one or more organic acids, diols, polyols, monoterpenes, sesquiterpenes, essential oils, biodetergents, or any other element named herein may be used as one or more antioxidants. In some embodiments, one or more stabilizers, microbial inoculants, antioxidants, or preservatives may comprise one or more element of the biodegradable cleaning composition.

Trial of at least one embodiment of the biodegradable cleaning composition indicate that the use of a centrifuge as described herein may provide for the enhancement of product consistency and efficacy. Specifically, the results tend to show higher consistency in product clarity by using the centrifuge. The advantage to this unique and unpredictable discovery lies in the fact that the centrifuge lowers turbidity levels in the product, which increases efficacy as measured by one or more cleaning efficiency tests. Accordingly, the novel and nonobvious use of the centrifuge as described herein provides enhanced benefits to a user.

In some embodiments, the biodegradable cleaning composition may be in a concentrated or diluted form. In some embodiments, 5-99% wt/wt % of the biodegradable cleaning may comprise water. In some embodiments, 20-80% wt/wt % of the biodegradable cleaning composition may comprise water. In some embodiments, 30-70% wt/wt % of the biodegradable cleaning composition may comprise water. In some embodiments, 75-97% wt/wt % of the biodegradable cleaning composition may comprise water. In some preferred embodiments, 80-85% wt/wt % of the biodegradable cleaning composition may comprise water. In other preferred embodiments, 90-95% wt/wt % of the biodegradable cleaning composition may comprise water.

In some embodiments of the present invention, the biodegradable cleaning compositions may comprise hydrotropes that possess the ability to increase solubility of sparingly soluble molecules in water. They may include some hydrophilic and lipophilic fractions, like typical surfactants, but they may also contain a very small hydrophobic fraction that does not allow the formation of aggregates such as micelles. The final biodegradable composition used in place of or in addition to conventional cleaning products or detergents may comprise not only biochemical/metabolite fermentation broth, but also viable probiotic microorganisms with a defined profile based on metagenomics and metabolomics analysis (ie., fingerprint).

In some embodiments, the biodegradable cleaning composition may provide a metagemonics profile characterized by percent Relative Richness of microorganisms such as one or more lactic acid bacteria and one or more Bacillus sp. as presented in more detail herein, in ranges from about 1 to about 98%. More preferably, the range is from about 20% to about 40%.

In some embodiments, the biodegradable cleaning composition may provide a metabolomics profile characterized by one or more untargeted metabolomics analyses provided in the experiments section herein. The untargeted metabolomics analysis may indicate, without limitation, one or more metabolites produced by one or more microorganisms of the present biodegradable cleaning composition, which may include but are not required to include, without limitation, one or more biodetergents, organic acids, diols, polyols, polymyxins, polysaccharide-lipid complexes, fatty acids, monoterpenes or monoterpenoids, sesquiterpenes or sesquiterpenoids, preservatives, or other compound referred to herein as a second metabolite.

In some embodiments, the untargeted metabolomics analysis my indicate the presence of one or more metabolites produced by one or more microorganisms of the present biodegradable cleaning composition, including but not limited to eucalyptol, linalool, alcanfor, linderol, a-terpineol, 6,7-dihydro-7-hydroxylinalool, neryl alcohol, lavandulol acetate, 2,3-dehydro-1,8-cineole linalool a-phellandrene-8-ol, geraniol, citral, cyclohexene, isocaryophyllene, lactic acid, sorbic acid, glycerol, succinic acid, itaconic acid, terpin, methylmaleic acid, citric acid, d-mannitol, palmitic acid, stearic acid, lactic acid, glycerol, succinic acid, D-(+)-arabitol, D-(−)-fructofuranose, d-fructose, d-glucitol, b-d-glucopyranose, D-fructose, furanose, fructofuranose, D-(+)-fructofuranose, pyranose, glucopyranose, D-glucopyranose, b-D-glucopyranose, fructopyranose, D-(+)-fructopyranose, oleic acid, benzene, 2-furaldehyde, 5-(1-hydroxy-1-methylethyl)-2-methyl-2-cyclohexene-1,4-diol #, methyl 13,16-octadecadiynoate #, trimethylsilyl (3e)-3-methyl-5-[(trimethylsilyl)oxy]-3,5-hexadienoate, d-(−)-fructopyranose, cis-vaccenic acid, glycerol trilaurate, d-(−)-lactic acid, glycerol, succinic acid, d-mannitol, palmitic acid, sulcatone, 2,3-dehydro-1,8-cineole, 4-nonanone, tagalose, D-(−)-tagalose, D-(+)-tagalose, mannopyranose, b-D-(+)-mannopyranose, b-D-(−)-mannopyranose, sulctone, 2,3-dehydro-1,8-cineole, a-phellandren-8-ol, 2,6-octadien-1-ol, 3,7-dimethyl-acetate, caryophyllene, g-cadinene, cadina-1(10),4-diene, carophyllene oxide, [(2-ethyl-5-methylfuran-3,4-diyl)bis(oxy)]bis(trimethylsilane), linalool, a-phellandren-8-ol, b-citral, geraniol, a-citral, cyclohexene, 3-acetoxy-4-(1-hydroxy-1-methylethyl)-1-methyl, 2,6-octadien-1-ol, 3,7-dimethyl-, acetate, caryophyllene, y-cadinese, cadina-1(10),4-diene, caryphyllene oxide, pentasiloxane, [(2-ethyl-5-methylfuran-3,4-diyl)bis(oxy)]bis(trimethylsilane), L-(−)-arabitol, and 11-octadecenoic acid.

In some embodiments, the biodegradable cleaning composition contains Lactic Acid Bacteria counts of from about 1.0E+1 to about 1.0E+6. Preferably, the biodegradable cleaning composition includes Lactic Acid Bacteria counts of from about 1.0E+5 to about 8.0E+5 CFU per milliliter. More preferably, the biodegradable cleaning composition includes Lactic Acid Bacteria counts of from about 2.50E+5 to about 6.0E+5 CFU per milliliter. Most preferably, the biodegradable cleaning composition includes a total number of microorganisms of about 3.0E+5 CFU per milliliter.

In some embodiments, the biodegradable cleaning composition contains Bacillus counts of from about 1.0E+1 to about 1.0E+6. Preferably, the biodegradable cleaning composition includes Bacillus counts of from about 1.0E+5 to about 8.0E+5 CFU per milliliter. More preferably, the biodegradable cleaning composition includes Bacillus counts of from about 2.50E+5 to about 6.0E+5 CFU per milliliter. Most preferably, the biodegradable cleaning composition includes Bacillus counts from about 3.0×10\hat{ }5 to about 4.8×10\hat{ }5 CFU per milliliter. However, any range discussed herein or described in an example may constitute a preferred amount or range.

Additionally, in some embodiments, the biodegradable cleaning composition may provide viable and active probiotics at the following minimums: lactic acid bacteria minimum 8.9×10\hat{ }4 cfu/g and Bacillus minimum 3.2×10\hat{ }4 cfu/g. The biodegradable cleaning composition may also have a pH of <3.5 and be free of detectable mold and coliforms. The biodegradable cleaning composition may provide for a surface tension minimum of 32 dyne/cm. The biodegradable cleaning composition may have a % Titratable Acidity of from about 0.03 to about 0.4%.

In embodiments wherein the biodegradable cleaning composition has been applied to a textile, the biodegradable cleaning composition may have a pH of <3.2 as well as viable and active probiotics (LAB minimum 1.0×10\hat{ }5 cfu/g and Bacillus minimum 1.0×10\hat{ }5 cfu/g).

Using Test Method ASTM D4488-A5, the biodegradable cleaning composition may provide a cleaning efficacy (CE) of 80% (minimum) 7 days after dilution 87% CE and 80% CE (minimum) 21 days after dilution.

Additionally, in some embodiments, the biodegradable cleaning composition may be free from petroleum, dyes, sulfates, phthalates, parabens, tricosan, ammonia, formaldehyde, bleach, and quaternary ammonium compounds.

Moreover, in some embodiments, and as certain examples provided herein tend to show, the beneficial microorganisms of the biodegradable cleaning composition may form spores on surfaces, and the spores may re-germinate. In some embodiments, the spores may regerminate beginning less than 24 hours of application. In some embodiments, the spores may regerminate beginning at 24 hours of application. In some embodiments, the spores may regerminate beginning after 24 hours of application. Example 3 shows results of experimental data supporting this assertion.

In some embodiments, therefore, embodiments of the biodegradable cleaning composition provide several beneficial aspects. For example, the biodegradable cleaning composition provides live, viable probiotics and probiotic-produced biosurfactants and organic acids that give it triple microscopic cleaning capability.

In some embodiments, the biodegradable cleaning composition is essentially free of purple sulfur bacteria. In another preferred embodiment, the biodegradable cleaning composition contains purple sulfur bacteria. In some embodiments, the biodegradable cleaning composition contains purple sulfur bacteria at a level of from about 1.0E+1 to about 1.0E+5, and preferably, from about between 1.0E+1 to 1.0E+4.

In some embodiments, the biodegradable cleaning composition is essentially free of pathogenic or putrefactive microorganisms. Preferably, the biodegradable cleaning composition is essentially free of pathogenic mold and total coliform. Most preferably, pathogenic mold and total coliform is undetectable in the biodegradable cleaning composition.

In some embodiments, one or more embodiments of the biodegradable cleaning composition may be formulated as a counter-cleaner solution, an all-purpose cleaning solution, a floor cleaning solution, a floor cleaning concentrate, a probiotic floor cleaning concentrate, an air freshener solution, a fabric refresher solution, an air and fabric freshener solution, a window cleaning solution, or any solution used to treat or clean a surface or the air.

It is contemplated that where two or more microorganisms are present within one or more embodiments of the biodegradable cleaning composition, the microorganisms may be co-cultured. The microorganisms may be propagated by methods known in the art. For example, the microorganisms may be propagated in a liquid medium under anaerobic or aerobic conditions. Suitable liquid mediums used for growing microorganisms include those known in the art. It is contemplated that, in some embodiments, the one or more strains of useful microorganisms described herein may be co-cultured under laboratory conditions in any combination before being transferred to one or more fermentation tanks. In some embodiments, the one or more strains of useful microorganisms may be co-cultured partly under laboratory conditions, then transferred to one or more fermentation tanks, where the co-culture process may continue. In other embodiments, the one or more strains of useful microorganisms may be co-cultured within one or more fermentation tanks.

In some embodiments, one or more microbial organisms of the microorganism consortium may comprise, but are not limited to, one or more of Lactobacillus acetotolerans, Lactobacillus acidifarinae, Lactobacillus acidipiscis, Lactobacillus acidophilus, Lactobacillus agilis, Lactobacillus algidus, Lactobacillus alimentarius, Lactobacillus amylolyticus, Lactobacillus amylophilus, Lactobacillus amylotrophicus, Lactobacillus amylovorus, Lactobacillus animalis, Lactobacillus antri, Lactobacillus apodemi, Lactobacillus aviarius, Lactobacillus bifermentans, Lactobacillus brevis, Lactobacillus buchneri, Lactobacillus camelliae, Lactobacillus casei, Lactobacillus catenaformis, Lactobacillus ceti, Lactobacillus coleohominis, Lactobacillus collinoides, Lactobacillus composti, Lactobacillus concavus, Lactobacillus coryniformis, Lactobacillus crispatus, Lactobacillus crustorum, Lactobacillus curvatus, Lactobacillus delbrueckii subsp. bulgaricus, Lactobacillus delbrueckii subsp. delbrueckii, Lactobacillus delbrueckii subsp. lactis, Lactobacillus dextrinicus, Lactobacillus diolivorans, Lactobacillus equi, Lactobacillus equigenerosi, Lactobacillus farraginis, Lactobacillus farciminis, Lactobacillus fermentum, Lactobacillus fornicalis, Lactobacillus fructivorans, Lactobacillus frumenti, Lactobacillus fuchuensis, Lactobacillus gallinarum, Lactobacillus gasseri, Lactobacillus gastricus, Lactobacillus ghanensis, Lactobacillus graminis, Lactobacillus hammesii, Lactobacillus hamsteri, Lactobacillus harbinensis, Lactobacillus hayakitensis, Lactobacillus helveticus, Lactobacillus hilgardii, Lactobacillus homohiochii, Lactobacillus iners, Lactobacillus ingluviei, Lactobacillus intestinalis, Lactobacillus jensenii, Lactobacillus johnsonii, Lactobacillus kalixensis, Lactobacillus kefiranofaciens, Lactobacillus kefiri, Lactobacillus kimchii, Lactobacillus kitasatonis, Lactobacillus kunkeei, Lactobacillus leichmannii, Lactobacillus lindneri, Lactobacillus malefermentans, Lactobacillus mali, Lactobacillus manihotivorans, Lactobacillus mindensis, Lactobacillus mucosae, Lactobacillus murinus, Lactobacillus nagelii, Lactobacillus namurensis, Lactobacillus nantensis, Lactobacillus oligofermentans, Lactobacillus oris, Lactobacillus panis, Lactobacillus pantheris, Lactobacillus parabrevis, Lactobacillus parabuchneri, Lactobacillus paracasei, Lactobacillus paracollinoides, Lactobacillus parafarraginis, Lactobacillus parakefiri, Lactobacillus paralimentarius, Lactobacillus paraplantarum, Lactobacillus pentosus, Lactobacillus perolens, Lactobacillus plantarum, Lactobacillus pontis, Lactobacillus protectus, Lactobacillus psittaci, Lactobacillus rennini, Lactobacillus reuteri, Lactobacillus rhamnosus, Lactobacillus rimae, Lactobacillus rogosae, Lactobacillus rossiae, Lactobacillus ruminis, Lactobacillus saerimneri, Lactobacillus sakei, Lactobacillus salivarius, Lactobacillus sanfranciscensis, Lactobacillus satsumensis, Lactobacillus secaliphilus, Lactobacillus sharpeae, Lactobacillus siliginis, Lactobacillus spicheri, Lactobacillus suebicus, Lactobacillus thailandensis, Lactobacillus ultunensis, Lactobacillus vaccinostercus, Lactobacillus vaginalis, Lactobacillus versmoldensis, Lactobacillus vini, Lactobacillus vitulinus, Lactobacillus zeae, and Lactobacillus zymae.

In some embodiments, the one or more microbial organisms of the microorganism consortium may include, but are not limited to, Alcaligenes sp. Aerobacter aerogenes, Achromobacter sp. Acinetobacter sp. Actinomadura oligospora, Agrobacterium sp. Azospirillum sp. Bacillus sp. Bacillus circulans, B. cereus, B. fusiformis, B. pumilis, B. megaterium, B. mycoides, B. polymyxa Paenibacillus polymyxa, B. coagulans, B. chitinolyticus Paenibacillus chitinolyticus, B. subtilis, Bacillus subtilis natto, Bradyrhizobium sp. Brevibacterium sp. Citrobacter sp. Pseudomonas sp. P putida, P. striata, P. fluorescens, P. calcis, Flavobacterium sp. Nitrosomonas sp. Erwinia sp. Micrococcus sp. Escherichia intermedia, Enterobacter asburiae, Serratia phosphoticum, Nitrobacter sp. Thiobacillus ferroxidans, T. thioxidans, Rhizobium meliloti, Xanthomonas sp. Aspergillus awamori, A. niger, A. tereus, A. flavus, A. nidulans, A. foetidus, A. wentii. Fusarium oxysporum, Alternaria teneius, Achrothcium sp. Penicillium digitatum, P lilacinium, P balaji, P. funicolosum, Cephalosporium sp. Cladosprium sp. Curvularia lunata, Cunnighamella, Candida sp. Chaetomium globosum, Humicola inslens, Humicola lanuginosa, Helminthosporium sp. Paecilomyces fusisporous, Pythium sp. Phoma sp. Populospora mytilina, Myrothecium roridum, Morteirella sp. Micromonospora sp. Oideodendron sp. Rhizoctonia solani, Rhizopus sp. Mucor sp. Trichoderma viridae, Torula thermophila, Schwanniomyces occidentalis, Sclerotium rolfsii, Actinomyces, Streptomyces, Anabena sp. Calothrix braunii, Nostoc sp. Scytonema sp. or Glomus fasciculatum.

In some embodiments, the one or more microbial organisms of the microorganism consortium may include, but are not limited to, Bacillus coagulans Hammer ATCC 7050 Strain Designations: NRS 609 [NCIB 9365, NCTC 10334], Bacillus coagulans Hammer ATCC 12245 Strain Designations: [NCA 308], Bacillus coagulans Hammer ATCC 31284, Bacillus coagulans Hammer ATCC 53595, Bacillus coagulans Hammer ATCC 8038 Strain Designations: NCA 43P [NCIB 8080, NRS 770], Bacillus coagulans Hammer ATCC 15949 Strain Designations: NCA 4259, Bacillus coagulans Hammer ATCC 23498 Strain Designations: M-39, Bacillus coagulans Hammer ATCC 11369, Bacillus coagulans Hammer ATCC BAA-738, Bacillus coagulans Hammer ATCC 11014 Strain Designations: NRS T27 [78G], Bacillus coagulans Hammer ATCC 10545 Strain Designations: NRS 784 [NCIB 8041], pCR46 [Bacillus subtilis IS75] ATCC 67736, Bacillus cereus Frankland and Frankland ATCC 21366, Bacillus smithii Nakamura et al. ATCC 35670 Strain Designations: NRS 22 [815], Bacillus smithii Nakamura et al. ATCC 51232 Strain Designations: FRR B666 [SLS 37], or Bacillus cereus Frankland and Frankland ATCC 55055 Strain Designations: NEB 566.

In some embodiments, the one or more microbial organisms of the microorganism consortium may include, but are not limited to, Bacillus cereus Frankland and Frankland ATCC 14579, Bacillus cereus Frankland and Frankland ATCC 10876, Bacillus cereus Frankland and Frankland ATCC 13061, Bacillus cereus Frankland and Frankland ATCC 10876, Bacillus cereus Frankland and Frankland ATCC 11778, Bacillus cereus Frankland and Frankland ATCC BAA-1005, Bacillus cereus Frankland and Frankland ATCC 15816, Bacillus cereus Frankland and Frankland ATCC 15817, Bacillus cereus Frankland and Frankland ATCC BAA-512, Bacillus cereus Frankland and Frankland ATCC 23261, Bacillus cereus Frankland and Frankland ATCC 21772, Bacillus cereus Frankland and Frankland ATCC 21634, Bacillus cereus Frankland and Frankland ATCC 7004, Bacillus cereus Frankland and Frankland ATCC 19637, Bacillus cereus Frankland and Frankland ATCC 21182, Bacillus cereus Frankland and Frankland ATCC 7064, Bacillus cereus Frankland and Frankland ATCC 23260, Bacillus cereus Frankland and Frankland ATCC 4342, Bacillus cereus Frankland and Frankland ATCC 49063, Bacillus cereus Frankland and Frankland ATCC 31430, Bacillus cereus Frankland and Frankland ATCC 43881, Bacillus cereus Frankland and Frankland ATCC 49064, Bacillus cereus Frankland and Frankland ATCC 14603, Bacillus cereus Frankland and Frankland ATCC 55000, Bacillus cereus Frankland and Frankland ATCC 9592, Bacillus cereus Frankland and Frankland ATCC 12480, Bacillus cereus Frankland and Frankland ATCC 21366, Bacillus cereus Frankland and Frankland ATCC 10702, Bacillus cereus Frankland and Frankland ATCC 700282, Bacillus cereus Frankland and Frankland ATCC 33018, Bacillus cereus Frankland and Frankland ATCC 10987, Bacillus cereus Frankland and Frankland ATCC 53522, Bacillus cereus Frankland and Frankland ATCC 246, Bacillus cereus Frankland and Frankland ATCC 21769, Bacillus cereus Frankland and Frankland ATCC 9139, Bacillus cereus Frankland and Frankland ATCC 27522, Bacillus cereus Frankland and Frankland ATCC 33019, Bacillus cereus Frankland and Frankland ATCC 7039, Bacillus cereus Frankland and Frankland ATCC 55055, Bacillus cereus Frankland and Frankland ATCC 21768, Bacillus cereus Frankland and Frankland ATCC 27877, Bacillus cereus Frankland and Frankland ATCC 14737, Bacillus cereus Frankland and Frankland ATCC 55609, Bacillus cereus Frankland and Frankland ATCC 27348, Bacillus cereus Frankland and Frankland ATCC 9818, Bacillus cereus Frankland and Frankland ATCC 6464, Bacillus cereus Frankland and Frankland ATCC 25621, Bacillus cereus Frankland and Frankland ATCC 11950, Bacillus cereus Frankland and Frankland ATCC 14893, Bacillus cereus Frankland and Frankland ATCC 13472, Bacillus cereus Frankland and Frankland ATCC 13824, Bacillus cereus Frankland and Frankland ATCC 14579D-5, Bacillus cereus Frankland and Frankland ATCC 10987D-5, Bacillus cereus Frankland and Frankland ATCC 10702D-5, Bacillus cereus Frankland and Frankland ATCC 13061D-5, Bacillus cereus Frankland and Frankland ATCC 10876D-5, Bacteriophage of Bacillus cereus-anthracis, NikoA PTA-4171, Bacteriophage of Bacillus cereus-anthracis, DDBa PTA-4172, Bacteriophage of Bacillus cereus-anthracis, MHWa PTA-4173, or Bacillus cereus 21771.

In some embodiments, the one or more microbial organisms of the microorganism consortium may include, but are not limited to, Bacillus licheniformis Weigmann Chester ATCC 25972 or Bacillus thuringiensis Berliner ATCC 700872.

In some embodiments, the one or more microbial organisms of the microorganism consortium may include, but are not limited to, Bacillus megaterium de Bary ATCC 14581 Strain Designations: [BCRC 10608, CCM 2007, CCUG 1817, CIP 66.20, DSM 32, HAMBI 2018, IAM 13418, JCM 2506, KCTC 3007, LMG 7127, NBRC 15308, NCCB 75016, NCINIB 9376, NCTC 10342, NRIC 1710, NRRL B-14308, VKM B-512], Bacillus megaterium de Bary ATCC 14581, Bacillus megaterium de Bary ATCC 13632, Bacillus megaterium de Bary ATCC 15117, Bacillus megaterium de Bary ATCC 7703, Bacillus megaterium de Bary ATCC 19135, Bacillus megaterium de Bary ATCC 33169, Bacillus megaterium de Bary pathovar cerealis ATCC 35075, Bacillus megaterium de Bary ATCC 25848, Bacillus megaterium de Bary ATCC 19213, Bacillus megaterium de Bary ATCC 6459, Bacillus megaterium de Bary ATCC 33166, Bacillus megaterium de Bary ATCC 21209, Bacillus megaterium de Bary ATCC 19160, Bacillus megaterium de Bary ATCC 33168, Bacillus megaterium de Bary ATCC 39118, Bacillus megaterium de Bary pathovar cerealis ATCC 35076, Bacillus megaterium de Bary ATCC 31294, Bacillus megaterium de Bary ATCC 13639, Bacillus megaterium de Bary ATCC 11478, Bacillus megaterium de Bary ATCC 33165, Bacillus megaterium de Bary ATCC 33729, Bacillus megaterium bacteriophage G ATCC 43725-B1, Bacillus megaterium de Bary ATCC 15451, Bacillus megaterium de Bary ATCC 7051, Bacillus megaterium de Bary ATCC 89, Bacillus megaterium de Bary ATCC 15374, Bacillus megaterium de Bary ATCC 33164, Bacillus megaterium de Bary ATCC 15127, Bacillus megaterium de Bary ATCC 15118, Bacillus megaterium de Bary ATCC 6458, Bacillus megaterium de Bary ATCC 12872, Bacillus megaterium de Bary ATCC 7052, Bacillus megaterium de Bary ATCC 21916, Bacillus megaterium de Bary ATCC 9885, Bacillus megaterium de Bary ATCC 33167, Bacillus megaterium de Bary ATCC 11562, Bacillus megaterium de Bary ATCC 25300, Bacillus megaterium de Bary ATCC 10778, Bacillus megaterium de Bary ATCC 13402, Bacillus megaterium de Bary ATCC 25833, Bacillus megaterium de Bary ATCC 21181, Bacillus megaterium de Bary ATCC 7056, Bacillus megaterium de Bary ATCC 4531, Bacillus megaterium de Bary ATCC 43725, Bacillus megaterium de Bary ATCC 27327, Bacillus megaterium de Bary ATCC 15781, Bacillus megaterium de Bary ATCC 49099, Bacillus megaterium de Bary ATCC 11561b, Bacillus megaterium de Bary ATCC 11561d, Bacillus megaterium de Bary ATCC 15450, Bacillus megaterium de Bary ATCC 49096, Bacillus megaterium de Bary ATCC 35985, Bacillus megaterium de Bary ATCC 14945, Bacillus megaterium de Bary ATCC 11561a, Bacillus megaterium de Bary ATCC 11561e, Bacillus megaterium de Bary ATCC 11561c, Bacillus megaterium de Bary ATCC 14946, Bacillus megaterium de Bary ATCC 11561, Bacillus megaterium 19161, Bacillus megaterium 15047, Bacillus megaterium 15046, Bacillus megaterium 19137, Bacillus megaterium 19218, Bacillus megaterium, SB 3112 PTA-3142, PTA-3142, Bacillus megaterium 15128, Bacillus megaterium 15177, Bacillus simplex Priest et al. ATCC 49097 Strain Designations: NRS 960 [DSM 1321], Bacillus flexus Priest et al. ATCC 49095 Strain Designations: NRS 665 [DSM 1320], Bacillus cereus Frankland and Frankland ATCC 55000 Strain Designations: B 153-2-2, Bacillus circulans Jordan ATCC 21737 Strain Designations: T5 [FERM-P 935], Bacillus simplex Priest et al. ATCC 13368 Strain Designations: 41, Bacillus sp. ATCC 13062 Strain Designations: MB-1073 [14-B22], Bacillus simplex Priest et al. ATCC 8011 Strain Designations: NRS 335 [NCTC 2597], Bacillus simplex Priest et al. ATCC 49098 Strain Designations: NRS 986 [DSM 1323], ATCC 19136, ATCC 39383, ATCC 39383, ATCC 21738, ATCC 21603, ATCC 19380, pBC16 ATCC 37338, ATCC 8245, or ATCC 51946.

In some embodiments, the one or more microbial organisms of the microorganism consortium may include, but are not limited to, Bacillus mycoides Flugge ATCC 6462 Strain Designations: NRS 273 [155, CCUG 26678, CIP 103472, DSM 2048, HAMBI 1827, LMG 7128, NCTC 12974, NRRL B-14799, NRRL B-14811], Bacillus mycoides bacteriophage ATCC 11986-B1, Bacillus mycoides Flugge ATCC 31101, Bacillus mycoides Flugge ATCC 31103, Bacillus mycoides Flugge ATCC 10206, Bacillus mycoides Flugge ATCC 21929, Bacillus mycoides Flugge ATCC 11986, Bacillus mycoides Flugge ATCC 19647, Bacillus mycoides Flugge ATCC 31102, Rhodococcus rhodochrous Zopf Tsukamura emend. Rainey et al. ATCC 27, Bacillus cereus Frankland and Frankland ATCC 11778, Rhodococcus rhodochrous Zopf Tsukamura emend. Rainey et al. ATCC 999, Bacillus mycoides Flugge ATCC 6463, Bacillus mycoides Flugge ATCC 23258, Rhodococcus rhodochrous Zopf Tsukamura emend. Rainey et al. ATCC 4004, Bacillus mycoides Flugge ATCC 21929, or Bacillus pumilus Meyer and Gottheil ATCC 19646.

In some embodiments, the one or more microbial organisms of the microorganism consortium may include, but are not limited to, Bacillus pumilus Meyer and Gottheil ATCC 7061, Bacillus pumilus Meyer and Gottheil ATCC BAA-1434, Bacillus pumilus Meyer and Gottheil ATCC 700814, Bacillus pumilus Meyer and Gottheil ATCC 19646, Bacillus pumilus Meyer and Gottheil ATCC 14884, Bacillus pumilus Meyer and Gottheil ATCC 70, Bacillus pumilus Meyer and Gottheil ATCC 31650, Bacillus pumilus Meyer and Gottheil ATCC 98, Bacillus pumilus Meyer and Gottheil ATCC 71, Bacillus pumilus Meyer and Gottheil ATCC 19164, Bacillus pumilus Meyer and Gottheil ATCC 31095, Bacillus pumilus Meyer and Gottheil ATCC 4522, Bacillus pumilus Meyer and Gottheil ATCC 945, Bacillus pumilus Meyer and Gottheil ATCC 31093, Bacillus pumilus Meyer and Gottheil ATCC 21143, Bacillus pumilus Meyer and Gottheil ATCC 27142, Bacillus pumilus Meyer and Gottheil ATCC 6632, Bacillus pumilus Meyer and Gottheil ATCC 19878, Bacillus pumilus Meyer and Gottheil ATCC 31340, Bacillus pumilus Meyer and Gottheil ATCC 19546, Bacillus pumilus Meyer and Gottheil ATCC 7065, Bacillus pumilus Meyer and Gottheil ATCC 53206, Bacillus pumilus Meyer and Gottheil ATCC 4510, Bacillus pumilus Meyer and Gottheil ATCC 19548, Bacillus pumilus Meyer and Gottheil ATCC BAA-1434, Bacillus pumilus Meyer and Gottheil ATCC 31132, Bacillus pumilus Meyer and Gottheil ATCC 15716, Bacillus pumilus Meyer and Gottheil ATCC 19646, Bacillus pumilus Meyer and Gottheil ATCC 18, Bacillus pumilus Meyer and Gottheil ATCC 4520, Bacillus pumilus Meyer and Gottheil ATCC 6631, Bacillus pumilus Meyer and Gottheil ATCC 31177, Bacillus pumilus Meyer and Gottheil ATCC 1 Strain Designations: AMC [NRS 309], Bacillus pumilus 19547,

In embodiments wherein Bacillus subtilis comprises one or more microbial organisms of the microorganism consortium, illustrative strains may include, but are not limited to, Bacillus subtilis Ehrenberg Cohn ATCC 15477 Strain Designations: M-24-1, Bacillus subtilis Ehrenberg Cohn ATCC 31098, Bacillus subtilis Ehrenberg Cohn ATCC 21951, Bacillus subtilis Ehrenberg Cohn ATCC 21008, Bacillus pumilus Meyer and Gottheil ATCC 19182, Bacillus pumilus Meyer and Gottheil ATCC 72, Bacillus subtilis 21007, Bacillus subtilis 21358, Bacillus subtilis 21005, Bacillus subtilis 21006, Bacillus subtilis 21356, Bacillus subtilis 19220, 53683, Bacillus subtilis 19219, B. subtilis 53685, Bacillus subtilis 21357, B. subtilis 21398, B. subtilis 53689, Bacillus subtilis Ehrenberg Cohn ATCC 21770, or Bacillus subtilis 19217. Bacillus subtilis Ehrenberg Cohn ATCC 31098, Bacillus subtilis Ehrenberg Cohn ATCC 21951, Bacillus subtilis Ehrenberg Cohn ATCC 21008, Bacillus subtilis 21007, Bacillus subtilis 21358, Bacillus subtilis 21005, Bacillus subtilis 21006, Bacillus subtilis 21356, Bacillus subtilis 19220, 53683, Bacillus subtilis 19219, B. subtilis 53685, Bacillus subtilis 21357, B. subtilis 21398, B. subtilis 53689, Bacillus subtilis Ehrenberg Cohn ATCC 21770, Bacillus subtilis natto, and Bacillus subtilis 19217. Bacillus subtilis Ehrenberg Cohn ATCC 15245 Strain Designations: 3349 [IAM 1-3].

In some embodiments, the one or more microbial organisms of the microorganism consortium may include, but are not limited to, Bacillus thuringiensis Berliner ATCC 10792 Strain Designations: [CCUG 7429, CIP 53.137, DSM 2046, HAMBI 478, LMG 7138, NCAIM B.01292, NCCB 70008, NRRL HD-735, VKM B-1544], Bacillus thuringiensis Berliner ATCC 19265, Bacillus thuringiensis Berliner ATCC 13367, Bacillus cereus Frankland and Frankland ATCC 21928, Bacillus thuringiensis Berliner ATCC 39152, or Bacillus thuringiensis Berliner ATCC 13366.

In some embodiments, the one or more microbial organisms of the microorganism consortium may include, but are not limited to, Bacillus weihenstephanensis Lechner et al. ATCC 12826, Bacillus weihenstephanensis bacteriophage ATCC 12826-B2, 31293, 31429, 31292, or Bacillus sp. ATCC 13062, P7 ATCC 75237.

In some embodiments wherein Enterococcus lactis comprises one or more microbial organisms of the microorganism consortium, illustrative strains may include, but are not limited to, Enterococcus lactis BT159 T, Enterococcus lactis CCM 8412, Enterococcus lactis DSM 23655 Enterococcus lactis LMG 25958, Enterococcus lactis Morandi BT159, or any other species of Enterococcus lactis.

In some embodiments wherein Enterococcus thermophilus comprises one or more microbial organisms of the microorganism consortium, illustrative strains may include, but are not limited to, Streptococcus salivarius subsp. thermophilus (Orla-Jensen) Farrow and Collins (ATCC BAA-491D-5), Streptococcus salivarius subsp. thermophilus (Orla-Jensen) Farrow and Collins (ATCC 14485), Streptococcus salivarius subsp. thermophilus (Orla-Jensen) Farrow and Collins (ATCC 19258), Streptococcus salivarius subsp. thermophilus (Orla-Jensen) Farrow and Collins (ATCC BAA-491), Streptococcus salivarius subsp. thermophilus (Orla-Jensen) Farrow and Collins (ATCC BAA-250), Streptococcus salivarius subsp. thermophilus (Orla-Jensen) Farrow and Collins (ATCC BAA-250D-5), Enterococcus faecium (Orla-Jensen) Schleifer and Kilpper-Balz (ATCC 51836, deposited as Streptococcus thermophilus Orla-Jensen), Streptococcus thermophilus NCIMB 10387, Streptococcus salivarius subsp. thermophilus NCIMB 702393, Streptococcus thermophilus NCIMB 702557, Streptococcus salivarius subsp. thermophilus NCIMB 702641, or any other related strain of Enterococcus thermophilus.

In embodiments wherein Lactobacillus acetotolerans comprises one or more microbes of the microorganism consortium, illustrative strains may include, but are not limited to, Lactobacillus acetotolerans Entani et al. ATCC 43578, Lactobacillus acetotolerans Entani et al. ATCC 27742, Lactobacillus acidophilus (Moro) Hansen and Mocquot ATCC 43121, Lactobacillus rhamnosus (Hansen) Collins et al. ATCC 21052D-5, Lactobacillus rhamnosus (Hansen) Collins et al. ATCC 7469, Lactobacillus brevis (Orla-Jensen) Bergey et al. ATCC 14869, Lactobacillus acidophilus (Moro) Hansen and Mocquot ATCC BAA-2832, Lactobacillus acetotolerans Entani et al. ATCC 43578, and Lactobacillus acetotolerans Entani et al. ATCC 27742.

In some embodiments wherein Lactobacillus acidophilus comprises one or more microbial organisms of the microorganism consortium, illustrative strains may include, but are not limited to, Lactobacillus acidophilus Moro Hansen and Mocquot ATCC 4356, Lactobacillus acidophilus Moro Hansen and Mocquot ATCC 4355, Lactobacillus acidophilus Moro Hansen and Mocquot ATCC 4796, Lactobacillus acidophilus Moro Hansen and Mocquot ATCC 4357, Lactobacillus acidophilus Moro Hansen and Mocquot ATCC BAA-2832, Lactobacillus acidophilus Moro Hansen and Mocquot ATCC 53546, Lactobacillus acidophilus Moro Hansen and Mocquot ATCC 53544, Lactobacillus acidophilus Moro Hansen and Mocquot ATCC 11975, Lactobacillus acidophilus Moro Hansen and Mocquot ATCC 314, Lactobacillus acidophilus Moro Hansen and Mocquot ATCC 832, Lactobacillus acidophilus Moro Hansen and Mocquot ATCC 9224, Lactobacillus acidophilus Moro Hansen and Mocquot ATCC 43121, Lactobacillus acidophilus Moro Hansen and Mocquot ATCC 53671, Lactobacillus acidophilus: B6T7 PTA-4482, Lactobacillus acidophilus Moro Hansen and Mocquot ATCC BAA-2845, Lactobacillus acidophilus Moro Hansen and Mocquot ATCC 4357D-5, Lactobacillus animalis LA51 Deposited as Lactobacillus acidophilus PTA-6750, Lactobacillus acidophilus produced by bovine feed LA45 PTA-6749, Lactobacillus acidophilus M35 PTA-6751, Lactobacillus acidophilus L411 PTA-6820, Lactobacillus gallinarum Fujisawa et al. ATCC 33199, Lactobacillus amylovorus Nakamura ATCC 33198, Lactobacillus gasseri Lauer and Kandler ATCC 19992, Lactobacillus johnsonii Fujisawa et al. ATCC 11506, Lactobacillus johnsonii Fujisawa et al. ATCC 33200, Lactobacillus johnsonii Fujisawa et al. ATCC 332, Lactobacillus rhamnosus Hansen Collins et al. ATCC 53103, Lactobacillus crispatus Brygoo and Aladame Moore and Holdeman ATCC 33197, Lactobacillus crispatus Brygoo and Aladame Moore and Holdeman ATCC 53545, Lactobacillus rhamnosus Hansen Collins et al. ATCC 21052, Bacillus sp. ATCC 31283 (Lactobacillus acidophilus Moro Hansen and Mocquot), Lactobacillus casei Orla-Jensen Hansen and Lessel ATCC 4646 (Lactobacillus acidophilus Moro Hansen and Mocquot), Lactobacillus gasseri Lauer and Kandler ATCC 9857 (Lactobacillus acidophilus Moro Hansen and Mocquot), Lactobacillus fermentum Beijerinck ATCC 11976 (Lactobacillus acidophilus Moro Hansen and Mocquot), Lactobacillus gasseri Lauer and Kandler ATCC 29601 (Lactobacillus acidophilus Moro Hansen and Mocquot), Lactobacillus paracasei subsp. paracasei Collins et al. ATCC 11974 (Lactobacillus acidophilus Moro Hansen and Mocquot), Lactobacillus johnsonii Fujisawa et al. ATCC 53672 (Lactobacillus acidophilus Moro Hansen and Mocquot), or Lactobacillus crispatus Brygoo and Aladame Moore and Holdeman ATCC 55221 (Lactobacillus acidophilus Moro Hansen and Mocquot).

In some embodiments wherein Lactobacillus bulgaricus comprises one or more microbial organisms of the microorganism consortium, illustrative strains may include, but are not limited to, Lactobacillus bulgaricus (Lactobacillus delbrueckii subsp. bulgaricus) selected from Lactobacillus delbrueckii subsp. bulgaricus Orla-Jensen Weiss et al. ATCC 11842 (Lactobacillus bulgaricus Orla-Jensen Rogosa and Jensen), Lactobacillus delbrueckii subsp. bulgaricus (Orla-Jensen) Weiss et al. (ATCC BAA-365D), Lactobacillus delbrueckii subsp. bulgaricus (Orla-Jensen) Weiss et al. (ATCC 11842D-5), Lactobacillus delbrueckii subsp. bulgaricus (Orla-Jensen) Weiss et al. (ATCC BAA-365), Lactobacillus delbrueckii subsp. bulgaricus (Orla-Jensen) Weiss et al. (ATCC 11842), Lactobacillus salivarius subsp. salivarius Rogosa et al. (ATCC 11741), Lactobacillus helveticus (Orla-Jensen) Bergey et al. (ATCC 7995D deposited as Lactobacillus delbrueckii subsp. bulgaricus (Orla-Jensen) Weiss et al.), Lactobacillus leichmannii (Henneberg) Bergey et al. (ATCC 21815 deposited as Lactobacillus bulgaricus (Orla-Jensen) Rogosa and Jensen), Lactobacillus helveticus (Orla-Jensen) Bergey et al. (ATCC 55163 deposited as Lactobacillus delbrueckii subsp. bulgaricus (Orla-Jensen) Weiss et al.), Lactobacillus delbrueckii subsp. lactis NCIMB 7854, Lactobacillus delbrueckii subsp. lactis NCIMB 8117, Lactobacillus delbrueckii subsp. lactis NCIMB 8118, Lactobacillus delbrueckii subsp. delbrueckii NCIMB 8130, Lactobacillus delbrueckii subsp. delbrueckii NCIMB 8183, Lactobacillus delbrueckii subsp. lactis NCIMB 8183, Lactobacillus delbrueckii subsp. bulgaricus NCIMB 11778, or Lactobacillus delbrueckii subsp. bulgaricus NCIMB 701438.

In some embodiments, the one or more microbial organisms of the microorganism consortium may include, but are not limited to, Lactobacillus buchneri KKP/907/p, Lactobacillus buchneri (DSM 22963), Lactobacillus buchneri (DSM 12856), Lactobacillus buchneri (DSM 13573), Lactobacillus buchneri CCM 1819, Lactobacillus buchneri (DSM 16774), Lactobacillus buchneri DSM 22501, Lactobacillus buchneri LN 40177, Lactobacillus buchneri LN4637, Lactobacillus buchneri LN 40177, Lactobacillus buchneri NCIMB 40788, Lactobacillus rhamnosus (NCIMB 41640), Lactobacillus rhamnosus (NCIMB 30121), Lactobacillus rhamnosus DSM 29226, Lactobacillus rhamnosus DSM 7133, Lactobacillus rhamnosus (CNCM-I-3698), Lactobacillus rhamnosus ATCC 7469, Lactobacillus fermentum (NCIMB 41636), Lactobacillus brevis (DSM 12835), Lactobacillus brevis (DSM 21982), Lactobacillus brevis (DSM 12835), Lactobacillus brevis DSMZ 16680, Lactococcus chungangensis, Lactococcus formosensis, Lactococcus fujiensis, Lactococcus garvieae, Lactococcus hircilactis, Lactococcus lactis, Lactococcus laudensis, Lactococcus nasutitermitis, Lactococcus piscium, Lactococcus plantarum, Lactococcus raffinolactis, and Lactococcus taiwanensis, Lactococcus lactis PCM B/00039, Lactococcus lactis (DSM 11037), Lactococcus lactis (NCIMB 30117), Lactococcus lactis (NCIMB 30160), Bacillus licheniformis, Bacillus amyloliquefaciens, Bacillus licheniformis DSM 28710, Bacillus licheniformis (DSM 19670), Bacillus licheniformis (DSM 21564), Bacillus licheniformis ATCC 53757, Bacillus amyloliquefaciens CECT 5940, Bacillus amyloliquefaciens (DSM 9553), Bacillus amyloliquefaciens (DSM 9554), Bacillus amyloliquefaciens (PTA-6507), Bacillus amyloliquefaciens (NRRL B-50013), Bacillus amyloliquefaciens (NRRL B-50104), Bacillus amyloliquefaciens SD80, Bacillus amyloliquefaciens (ATCC 3978), Carnobacterium alterfunditum, Carnobacterium divergens, Carnobacterium funditium, Carnobacterium gallinarum, Carnobacterium iners, Carnobacterium inhibens, Carnobacterium jeotgali, Carnobacterium maltaromaticum, Carnobacterium mobile, Carnobacterium piscicola, Carnobacterium pleistocenium, and Carnobacterium viridans, Carnobacterium divergens PCM KKP 2012p, Streptococcus thermophilus, Streptococcus thermophilus NBIMCC 8253, Streptococcus thermophilus CNRZ1066, Streptococcus thermophilus LMG13811, Enterococcus faecium, Enterococcus faecalis, Enterococcus faecium CECT 4515, Enterococcus faecium CCM 6226, Enterococcus faecium CNCM I-3236, Enterococcus faecium DSM 22502, Enterococcus faecium NCIB 10415, Enterococcus faecium SF202, Enterococcus faecium SF301, Enterococcus faecium DSM 7134, Enterococcus faecium DSM 10663, Enterococcus faecium NCIB 11181, Enterococcus faecium DSM 21913, and/or Enterococcus faecium NBIMCC 8270.

In some embodiments wherein Lactobacillus casei comprises one or more microbial organisms of the microorganism consortium, illustrative strains may include, but are not limited to, Lactobacillus casei DSM 28872, Lactobacillus casei PCM B/00080, Lactobacillus casei DSM 28872, Lactobacillus casei (Orla-Jensen) Hansen and Lessel (ATCC 39539), Lactobacillus casei (Orla-Jensen) Hansen and Lessel (ATCC 39392), Lactobacillus casei (Orla-Jensen) Hansen and Lessel (ATCC 4940), Lactobacillus casei (Orla-Jensen) Hansen and Lessel (ATCC 393), Lactobacillus casei (Orla-Jensen) Hansen and Lessel (ATCC 334), Lactobacillus casei (Orla-Jensen) Hansen and Lessel (ATCC 27139), Lactobacillus casei (Orla-Jensen) Hansen and Lessel (ATCC BAA-2843), Lactobacillus casei (Orla-Jensen) Hansen and Lessel (ATCC 4646), Lactobacillus rhamnosus (Hansen) Collins et al. (ATCC 7469), Lactobacillus casei (Orla-Jensen) Hansen and Lessel (ATCC 4007), Lactobacillus paracasei subsp. paracasei Collins et al. (ATCC 11578), Lactobacillus rhamnosus (Hansen) Collins et al. (ATCC 14957 deposited as Lactobacillus casei (Orla-Jensen) Hansen and Lessel), Lactobacillus sp. (ATCC 14435 deposited as Lactobacillus casei (Orla-Jensen) Hansen and Lessel), Lactobacillus rhamnosus (Hansen) Collins et al. (ATCC 13075 deposited as Lactobacillus casei subsp. rhamnosus Hansen), Lactobacillus rhamnosus (Hansen) Collins et al. (ATCC 12116 deposited as Lactobacillus casei (Orla-Jensen) Hansen and Lessel), Lactobacillus rhamnosus (Hansen) Collins et al. (ATCC 11981 deposited as Lactobacillus casei subsp. rhamnosus Hansen), Lactobacillus paracasei subsp. paracasei Collins et al. (ATCC 11582 deposited as Lactobacillus casei (Orla-Jensen) Hansen and Lessel), Lactobacillus rhamnosus (Hansen) Collins et al. (ATCC 9595 deposited as Lactobacillus casei (Orla-Jensen) Hansen and Lessel), Lactobacillus rhamnosus (Hansen) Collins et al. (ATCC 8530 deposited as Lactobacillus casei subsp. rhamnosus Hansen), Lactobacillus rhamnosus (Hansen) Collins et al. (ATCC 7469a deposited as Lactobacillus casei (Orla-Jensen) Hansen and Lessel), Lactobacillus paracasei subsp. paracasei Collins et al. (ATCC 29599 deposited as Lactobacillus casei (Orla-Jensen) Hansen and Lessel, Lactobacillus rhamnosus (Hansen) Collins et al. (ATCC 27773 deposited as Lactobacillus casei (Orla-Jensen) Hansen and Lessel, Lactobacillus paracasei subsp. tolerans Collins et al. (ATCC 25599 deposited as Lactobacillus casei subsp. tolerans Abo-Elnaga and Kandler), Lactobacillus paracasei subsp. paracasei Collins et al. (ATCC 25598 deposited as Lactobacillus casei subsp. pseudoplantarum Abo-Elnaga and Kandler), Lactobacillus paracasei subsp. paracasei Collins et al. (ATCC 25303 deposited as Lactobacillus casei (Orla-Jensen) Hansen and Lessel), Lactobacillus paracasei subsp. paracasei Collins et al. (ATCC 25302, deposited as Lactobacillus casei (Orla-Jensen) Hansen and Lessel), Actinomyces naeslundii Thompson and Lovestedt (ATCC 19039 deposited as Actinomyces naeslundii Thompson and Lovestedt), Lactobacillus casei (Orla-Jensen) Hansen and Lessel (ATCC 4913 deposited as Lactobacillus delbrueckii (Leichmann) Beijerinck), Lactobacillus casei (Orla-Jensen) Hansen and Lessel (ATCC 15008 deposited as Lactobacillus casei subsp. casei (Orla-Jensen) Hansen and Lessel), Lactobacillus rhamnosus (Hansen) Collins et al. (ATCC 39595) deposited as Lactobacillus casei subsp. rhamnosus Hansen), Lactobacillus sp. (ATCC 49178 deposited as Lactobacillus casei (Orla-Jensen) Hansen and Lessel), Lactobacillus paracasei subsp. paracasei Collins et al. (ATCC 25180, deposited as Lactobacillus casei subsp. alacotosus Mills and Lessel), Lactobacillus rhamnosus (Hansen) Collins et al. (ATCC 11982 deposited as Lactobacillus casei subsp. rhamnosus Hansen), Lactobacillus paracasei subsp. paracasei Collins et al. (ATCC 27216 deposited as Lactobacillus casei subsp. alacotosus Mills and Lessel), Lactobacillus paracasei subsp. paracasei Collins et al. (ATCC 335 deposited as Lactobacillus casei (Orla-Jensen) Hansen and Lessel), or Lactobacillus paracasei subsp. paracasei Collins et al. (ATCC 27092 deposited as Lactobacillus casei (Orla-Jensen) Hansen and Lessel).

In some embodiments wherein Lactobacillus fermentum comprises one or more microbial organisms of the microorganism consortium, illustrative strains may include, but are not limited to, Lactobacillus fermentum Beijerinck ATCC 14932, Lactobacillus fermentum Beijerinck ATCC 14931, Lactobacillus fermentum Beijerinck ATCC 11739, Lactobacillus fermentum Beijerinck ATCC 9338, Lactobacillus fermentum Beijerinck ATCC 11976, Lactobacillus fermentum Beijerinck ATCC 23271, Lactobacillus fermentum Beijerinck ATCC 11740, Lactobacillus fermentum Beijerinck ATCC 8289, Lactobacillus fermentum B-54 55884, Lactobacillus reuteri Kandler et al. ATCC 23272 (Lactobacillus fermentum Beijerinck), Lactobacillus fermentum Beijerinck ATCC BAA-2842, Lactobacillus fermentum NCIMB 2797, Lactobacillus fermentum NCIMB 5220, Lactobacillus fermentum NCIMB 5221, Lactobacillus fermentum NCIMB 6991, Lactobacillus fermentum NCIMB 7230, Lactobacillus fermentum NCIMB 8028, Lactobacillus fermentum NCIMB 8828, Lactobacillus fermentum NCIMB 8829, Lactobacillus fermentum NCIMB 8830, Lactobacillus fermentum NCIMB 8961, Lactobacillus fermentum NCIMB 8962, Lactobacillus fermentum NCIMB 11840, Lactobacillus fermentum NCIMB 12116, Lactobacillus fermentum NCIMB 12117, Lactobacillus fermentum NCIMB 12118, Lactobacillus fermentum NCIMB 12119, Lactobacillus fermentum NCIMB 700335, Lactobacillus fermentum NCIMB 700479, Lactobacillus fermentum NCIMB 700927, Lactobacillus fermentum NCIMB 700928, Lactobacillus fermentum NCIMB 701052, Lactobacillus fermentum NCIMB 701068, Lactobacillus fermentum NCIMB 701751, Lactobacillus fermentum NCIMB 702341, or Lactobacillus fermentum NCIMB 702342.

In some embodiments wherein Lactobacillus parafarraginis comprises one or more microbial organisms of the microorganism consortium, illustrative strains may include, but are not limited to, Lactobacillus parafarraginis NCIMB 15108 or Lactobacillus parafarraginis NCIMB 702943.

In some embodiments wherein Lactobacillus plantarum comprises one or more microbial organisms of the microorganism consortium, illustrative strains may include, but are not limited to, Lactobacillus plantarum KKP/593/p, Lactobacillus plantarum KKP/788/p, Lactobacillus plantarum PCM B/00081, Lactobacillus plantarum (NCIMB 41638), Lactobacillus plantarum DSM 29024, Lactobacillus plantarum (ATCC 55943), Lactobacillus plantarum (ATCC 55944), Lactobacillus plantarum (ATCC PTSA-6139), Lactobacillus plantarum (CNCM I-3235), Lactobacillus plantarum DSM 11672, Lactobacillus plantarum (DSM 12836), Lactobacillus plantarum (DSM 12837), Lactobacillus plantarum (DSM 16565), Lactobacillus plantarum (DSM 16568), Lactobacillus plantarum (DSM 18112), Lactobacillus plantarum (DSM 18113), Lactobacillus plantarum (DSM 18114), Lactobacillus plantarum (DSM 19457), Lactobacillus plantarum (DSM 21762), Lactobacillus plantarum (DSM 23375), Lactobacillus plantarum (DSM 29025), Lactobacillus plantarum (DSM 3676), Lactobacillus plantarum (DSM 3677), Lactobacillus plantarum (DSM 8862), Lactobacillus plantarum (DSM 8866), Lactobacillus plantarum (LMG-21295), Lactobacillus plantarum (NCIMB 30083), Lactobacillus plantarum (NCIMB 30084), Lactobacillus plantarum (NCIMB 30084), Lactobacillus plantarum (NCIMB 30084), Lactobacillus plantarum (NCIMB 30236), Lactobacillus plantarum (NCIMB 41028), Lactobacillus plantarum (NCIMB 42150), Lactobacillus plantarum (VTT E-78076), Lactobacillus plantarum C KKP/788/p, Lactobacillus plantarum CECT 4528, Lactobacillus plantarum CECT 4528, Lactobacillus plantarum K KKP/593/p, Lactobacillus plantarum LP287, Lactobacillus plantarum LP329, Lactobacillus plantarum LP329, or Lactobacillus plantarum NCIMB 30238.

In some embodiments, the one or more microbial organisms of the microorganism consortium may include, but are not limited to, Lactobacillus rapi DSM-19907, Lactobacillus rapi Type Strain JCM 15042 NRIC 0743, Leuconostoc rapi DSM-27776, or Leuconostoc rapi Type Strain LMG 27676.

In some embodiments, the one or more microbial organisms of the microorganism consortium may include, but are not limited to, Rhodopseudomonas palustris Molisch van Niel ATCC 17001, Rhodopseudomonas palustris Molisch van Niel ATCC 33872, Rhodopseudomonas palustris Molisch van Niel ATCC 17005, Rhodopseudomonas palustris Molisch van Niel ATCC 17000, Rhodopseudomonas palustris Molisch van Niel ATCC BAA-1122, Rhodopseudomonas palustris Molisch van Niel ATCC 17010, Rhodopseudomonas palustris Molisch van Niel ATCC 17002, Rhodopseudomonas palustris Molisch van Niel ATCC 49781, Rhodopseudomonas palustris Molisch van Niel ATCC 17003, Rhodopseudomonas palustris Molisch van Niel ATCC 17004, Rhodopseudomonas palustris Molisch van Niel ATCC 51186, Rhodopseudomonas palustris Molisch van Niel ATCC 17006, Rhodopseudomonas palustris Molisch van Niel ATCC BAA-37, Rhodopseudomonas palustris Molisch van Niel ATCC 17008, Rhodopseudomonas palustris Molisch van Niel ATCC 17009, Rhodopseudomonas palustris Molisch van Niel ATCC BAA-98D-5, Rhodopseudomonas palustris Molisch van Niel ATCC BAA-1122D-5, Rhodopseudomonas palustris Molisch van Niel ATCC BAA-1123D-5, Rhodopseudomonas palustris Molisch van Niel ATCC BAA-98, Rhodopseudomonas palustris Molisch van Niel ATCC BAA-1123, Rhodopseudomonas palustris Molisch van Niel ATCC BAA-1125, Rhodopseudomonas palustris Molisch van Niel ATCC 17007, Rhodopseudomonas palustris Molisch van Niel ATCC BAA-1124, or Rhodospirillum rubrum Esmarch Molisch ATCC 25852.

In some embodiments, the one or more microbial organisms of the microorganism consortium may include, but are not limited to, Rhodobacter sphaeroides van Niel Imhoff et al. ATCC 17023, Rhodobacter sphaeroides van Niel Imhoff et al. ATCC 49419, Rhodobacter sphaeroides van Niel Imhoff et al. ATCC 17024, Rhodobacter sphaeroides van Niel Imhoff et al. ATCC 17026, Rhodobacter sphaeroides van Niel Imhoff et al. ATCC 21455, Rhodobacter sphaeroides van Niel Imhoff et al. ATCC BAA-808, Rhodobacter sphaeroides van Niel Imhoff et al. ATCC 35055, Rhodobacter sphaeroides van Niel Imhoff et al. ATCC 35053, Rhodobacter sphaeroides van Niel Imhoff et al. ATCC 35054, Rhodobacter sphaeroides van Niel Imhoff et al. ATCC 17023D-5, Rhodobacter sphaeroides van Niel Imhoff et al. ATCC BAA-808D-5, Rhodobacter sphaeroides van Niel Imhoff et al. ATCC 17025D-5, Rhodobacter sphaeroides van Niel Imhoff et al. ATCC 17029D-5, Rubrivivax sp. ATCC 55304, Rhodobacter sphaeroides van Niel Imhoff et al. ATC 17028, Rhodobacter sphaeroides van Niel Imhoff et al. ATCC 17029, Rhodobacter sphaeroides van Niel Imhoff et al. ATCC 17027, Rhodobacter sphaeroides van Niel Imhoff et al. ATCC 21286, Rhodobacter sphaeroides van Niel Imhoff et al. ATCC 33575, Paracoccus denitrificans Beijerinck and Minkman Davis emend. Rainey et al. ATCC 17741 Strain Designations: 381 [CIP 106306, CIP 106400, DSM 413, IAM 12479, ICPB 3979, IFO 16712, JCM 6892, LMD 22.21, LMG 4218, NCCB 22021, NCIB 11627, VKM B-1324], or Rhodobacter azotoformans ATCC 17025.

In some embodiments, the one or more microbial organisms of the microorganism consortium may include, but are not limited to, Paenibacillus polymyxa Prazmowski Ash et al. ATCC 21830, Paenibacillus polymyxa Prazmowski Ash et al. ATCC 842, Paenibacillus polymyxa Prazmowski Ash et al. ATCC 7070, Paenibacillus polymyxa Prazmowski Ash et al. ATCC 43865, Paenibacillus polymyxa Prazmowski Ash et al. ATCC 12060 Strain Designations: CN 2222, Paenibacillus polymyxa Prazmowski Ash et al. ATCC 8525 Strain Designations: [NRS 813], Paenibacillus polymyxa Prazmowski Ash et al. ATCC 12321 Strain Designations: NRRL B-510 RHG, Paenibacillus polymyxa Prazmowski Ash et al. ATCC 8524 Strain Designations: [NRS 280; 8278], Paenibacillus polymyxa Prazmowski Ash et al. ATCC 7047 Strain Designations: NRS 251, Bacillus circulans Jordan ATCC 31228 Strain Designations: SC 10275, Paenibacillus polymyxa Prazmowski Ash et al. ATCC 8519 Strain Designations: [ATCC 9825, NRS 812], Paenibacillus polymyxa Prazmowski Ash et al. ATCC 8523 Strain Designations: [NRS 354], Paenibacillus polymyxa Prazmowski Ash et al. ATCC 39564 Strain Designations: 9A, Paenibacillus polymyxa Prazmowski Ash et al. ATCC 25901 Strain Designations: 63, Paenibacillus polymyxa Prazmowski Ash et al. ATCC 8526 Strain Designations: [NRS 297], Paenibacillus polymyxa Prazmowski Ash et al. ATCC 7070 Strain Designations: [Difco Labs. 8277, N.R. Smith NRS 279, Vitek #200115], Paenibacillus polymyxa Prazmowski Ash et al. ATCC 10401 Strain Designations: [BUCSAV 163, Boots 163, CCM 1460, CCM 1461, CCM 1465, NCDO 731, NCIB 8094, NCTC 1380, NRS 2010], Paenibacillus polymyxa Prazmowski Ash et al. ATCC 27955 Strain Designations: M4, Paenibacillus polymyxa Prazmowski Ash et al. ATCC 21551 Strain Designations: FH-K 890/3, Paenibacillus polymyxa Prazmowski Ash et al. ATCC 31037 Strain Designations: BN-109 [FERM-P 2129], Paenibacillus polymyxa Prazmowski Ash et al. ATCC 12712 Strain Designations: PRL B505, Paenibacillus polymyxa Prazmowski Ash et al. ATCC 21993 Strain Designations: 3-8 [FERM-P 412].

In some embodiments, the one or more microbial organisms of the microorganism consortium may include, but are not limited to, Paenibacillus chitinolyticus NRRL B-23119, Paenibacillus macerans Schardinger Ash et al. ATCC 8244 Strain Designations: NRS 888 [NCIB 9368, NCTC 6355], Paenibacillus macerans Schardinger Ash et al. ATCC 8509 Strain Designations: 18 [NRS 1095, Vitek #200237], Paenibacillus macerans Schardinger Ash et al. ATCC 7069 Strain Designations: NRS 277 [8275], Paenibacillus macerans Schardinger Ash et al. ATCC 8510 Strain Designations: 2037 [NRS 1096], Paenibacillus macerans Schardinger Ash et al. ATCC 8517 Strain Designations: 583 [NRS 1101], Paenibacillus macerans Schardinger Ash et al. ATCC 843 Strain Designations: [NRS 1093], Paenibacillus macerans Schardinger Ash et al. ATCC 8514 Strain Designations: 588 [NRS 1098], Paenibacillus macerans Schardinger Ash et al. ATCC 7048 Strain Designations: NRS 649 [ATCC 8512], Paenibacillus macerans Schardinger Ash et al. ATCC 8513 Strain Designations: 577 [NRS 1097], Paenibacillus macerans Schardinger Ash et al. ATCC 8509 Strain Designations: 18 [NRS 1095, Vitek #200237], Paenibacillus macerans Schardinger Ash et al. ATCC 8516 Strain Designations: 585 [NRS 1100], Paenibacillus macerans Schardinger Ash et al. ATCC 7068 Strain Designations: NRS 278 [8276], Paenibacillus macerans Schardinger Ash et al. ATCC 8518 Strain Designations: [NRS 646], Paenibacillus macerans Schardinger Ash et al. ATCC 8515 Strain Designations: 573 [NRS 1099], Paenibacillus macerans Pma 007 BR-97 202152, or Paenibacillus graminis Berge et al. ATCC 49035 Strain Designations: NRRL B-390 [NRS 373].

In some embodiments, the biodegradable cleaning composition includes a total number of microorganisms of about 1 to about 1 million colony forming units (CFU) per milliliter. Preferably, the biodegradable cleaning composition includes a total number of microorganisms of about 100,000 to about 800,000 CFU per milliliter. More preferably, the biodegradable cleaning composition includes a total number of microorganisms of about 250,000 to about 600,000 CFU per milliliter. Most preferably, the biodegradable cleaning composition includes a total number of microorganisms of about 300,000 CFU per milliliter.

In some embodiments, the present composition contains a first mixture of live microorganisms in the at least one microorganism consortium in culture medium, wherein the live microorganisms are present at a collective “low titer”, and one or more additional non-pathogenic gram-positive bacteria of the Bacilli family that are capable of fermentation at a “high titer” for each additional individual species/strain of bacteria. By collective titer, what is meant is the individual titers of each of the first live microorganism adds up to the collective titer. To use an example of live lactic acid bacteria (LAB), if the (LAB) consists of 15,000 cfu/mL of a Bacillus sp. 12,000 cfu/mL of a Lactobacillus sp. and 10,000 cfu/mL of a Streptococcus sp. then the collective titer is 37,000 cfu/mL of LAB. In some embodiments, “low titer” is <300,000 cfu/mL, about 0.001-299,999 cfu/mL, about 1,000-250,000 cfu/mL, 5,000-200,000 cfu/mL, 10,000-150,000 cfu/mL, 15,000-100,000 cfu/mL, 20,000-75,000 cfu/mL, 25,000-60,000 cfu/mL, 30,000-55,000 cfu/mL, about 10,000 cfu/mL, about 11,000 cfu/mL, about 12,000 cfu/mL, about 13,000 cfu/mL, about 14,000 cfu/mL, about 15,000 cfu/mL, about 16,000 cfu/mL, about 17,000 cfu/mL, about 18,000 cfu/mL, about 19,000 cfu/mL, about 20,000 cfu/mL, about 21,000 cfu/mL, about 22,000 cfu/mL, about 23,000 cfu/mL, about 24,000 cfu/mL, about 25,000 cfu/mL, about 30,000 cfu/mL, about 35,000 cfu/mL, about 40,000 cfu/mL, about 45,000 cfu/mL, about 50,000 cfu/mL, about 55,000 cfu/mL, about 60,000 cfu/mL, about 65,000 cfu/mL, about 70,000 cfu/mL, about 75,000 cfu/mL, about 80,000 cfu/mL, about 85,000 cfu/mL, about 90,000 cfu/mL, about 95,000 cfu/mL, about 100,000 cfu/mL, about 105,000 cfu/mL, about 110,000 cfu/mL, about 115,000 cfu/mL, about 120,000 cfu/mL, about 125,000 cfu/mL, about 150,000 cfu/mL, about 175,000 cfu/mL, about 200,000 cfu/mL, about 225,000 cfu/mL, about 250,000 cfu/mL, about 275,000 cfu/mL, or about 299,000 cfu/mL.

In some embodiments, “high titer” is ≥300,000 cfu/mL, 300,000-10,000,000 cfu/mL, 500,000-1,000,000 cfu/mL, about 300,000 cfu/mL, about 325,000 cfu/mL, about 350,000 cfu/mL, about 375,000 cfu/mL, about 400,000 cfu/mL, about 425,000 cfu/mL, about 450,000 cfu/mL, about 475,000 cfu/mL, about 500,000 cfu/mL, about 525,000 cfu/mL, about 550,000 cfu/mL, about 575,000 cfu/mL, about 600,000 cfu/mL, about 625,000 cfu/mL, about 650,000 cfu/mL, about 675,000 cfu/mL, about 700,000 cfu/mL, about 725,000 cfu/mL, about 750,000 cfu/mL, about 775,000 cfu/mL, about 800,000 cfu/mL, about 825,000 cfu/mL, about 850,000 cfu/mL, about 875,000 cfu/mL, about 900,000 cfu/mL, about 925,000 cfu/mL, about 950,000 cfu/mL, about 975,000 cfu/mL, about 1,000,000 cfu/mL, about 1,250,000 cfu/mL, about 1,500,000 cfu/mL, about 1,750,000 cfu/mL, about 2,000,000 cfu/mL, about 2,500,000 cfu/mL, about 3,000,000 cfu/mL, about 3,500,000 cfu/mL, about 4,000,000 cfu/mL, about 4,500,000 cfu/mL, about 5,000,000 cfu/mL, about 5,500,000 cfu/mL, about 6,000,000 cfu/mL, about 6,500,000 cfu/mL, about 7,000,000 cfu/mL, about 7,500,000 cfu/mL, about 8,000,000 cfu/mL, about 8,500,000 cfu/mL, about 9,000,000 cfu/mL, about 9,500,000 cfu/mL, about 10,000,000 cfu/mL, about 1.5E+7, about 2E+7, about 2.5+7, about 3E+7, about 3.5E+7, about 4E+7, about 4.5E+7, about 5E+7, about 5.5E+7, about 6E+7, about 6.52E+7, about 7E+7, about 7.5E+7, about 8E+7, about 8.5E+7, about 9E+7, about 9.5E+7, about 1E+8, about 2E+8, about 3E+8, about 4E+8, about 5E+8, about 6E+8, about 7E+8, about 8E+8, about 9E+8, about 1E+9, about 3E+9, about 4E+9, about 5E+9, about 6E+9, about 7E+9, about 8E+9, about 9E+9, about 1E+10, about 2E+10, about 3E+10, about 4E+10, about 5E+10, about 6E+10, about 7E+10, about 8E+10, about 9E+10, or 1E+11 cfu/mL.

In those embodiments in which the present composition is in a dry form, the liquid present compositions described herein are dried. “Dry form” refers to a composition containing ≤15% water by weight, ≤14% water by weight, ≤13% water by weight, ≤12% water by weight, ≤11% water by weight, ≤10% water by weight, ≤9% water by weight, ≤8% water by weight, ≤7% water by weight, ≤6% water by weight, ≤5% water by weight, ≤4% water by weight, ≤3% water by weight, ≤2% water by weight, ≤1% water by weight, 1%-5% water by weight, 2%-6% water by weight, about 3% water by weight, about 4% water by weight, about 5% water by weight, about 6% water by weight, about 7% water by weight, or about 8% water by weight.

The biodegradable cleaning compositions of the invention may be in liquid or dry form. The biodegradable cleaning composition may comprise an aqueous suspension. This aqueous suspension may be provided as a concentrated stock solution which is diluted prior to application or as a diluted solution ready-to-use.

Also, the biodegradable cleaning composition may be a wettable powder, granules, dust, pellet, or colloidal concentrate. Such dry forms may be formulated to dissolve immediately upon wetting with water or suitable solvent system, or dissolve in a controlled-release, sustained-release, or other time-dependent manner. Also, the biodegradable cleaning composition may be in a dry form that does not depend upon wetting or dissolving to be effective.

The biodegradable cleaning compositions may additionally be provided in a formulation capable of spray. Spray compositions may include surfactants or biodetergents, emulsifiers, and wetting agents. The spray may be a liquid or an aerosol. The biodegradable cleaning compositions of the present invention are stable under various conditions as a liquid or dry form. Preferably, the biodegradable cleaning compositions of the present invention are stable at room temperature.

In some embodiments, the dry form of the present composition is produced by evaporation, spray-drying, lyophilization, or the like. In some embodiments, the dry present composition is encapsulated to promote the stability and viability of the microbes over time and under varying temperature conditions. In some embodiments, the dry present composition is divided into micron scale particles that are subsequently coated with biocompatible polymers, such as polyethylene glycol (PEG), chitin, dextrin, polylactic glycolic acid copolymer (PLGA), polylactic acid (PLA), polyglycolic acid (PGA), or the like.

Further examples of useful microorganisms are presented in detail below and elsewhere herein. It is contemplated that the present disclosure is not limited to any one combination, but may instead comprise any combination of any microorganism articulated or described herein, and in any amounts or titer. Examples of phototrophic, lactic acid, biofertilizer, Bacilli family, and sulfide-utilizing microorganisms are found, for example, in Bergey's Manual of Determinative Bacteriology and Bergey's Manual of Systematic Bacteriology. For example, sulfide-utilizing microorganisms include species of Purple Non-sulfur Bacteria, Chromatianeae, Green Sulfur Bacteria, Colorless Sulfur Bacteria, and Filamentous Green Bacteria. Biofertilizer microorganisms may include Lactobacillus genus, Enterococcus genus, Bifidobacterium genus, Bacillus genus, Pseudomonas genus, Sporolactobacillus genus, Micromonospora genus, Micrococcus genus, Rhodococcus genus, and E. coli. Phototrophic microorganisms may include Rhodopseudomonas, Rodobactor, and combinations thereof. For example, phototrophic microorganisms may include Rhodopseudomonas palustris, R. sphaeroides, Rhodospirillum centenum, R. photometricum, R. rubrum, Rhodopila globiformis, Rhodobacter sphaeroides, and combinations thereof. Lactic acid microorganisms may include Lactobacillus, Lactococcus and combinations thereof. For example, lactic acid microorganisms may include Lactobacillus casei, L. plantarum, L. acidophilus, L. fermentum, L. brevis, L. lactis, L. reuteri, L. bulgaricus, L. cellobiosus, L. curvatus, L. delbrukil, L. helbeticus, L. euterii, L. salivarius, L. rhamnosus, L. gaserli, L. jensenii, L. sporogenes, Lactococcus lactis, Streptococcus (Enterococcus) faecium, S. faecalis, S. cremoris, S. diacetylactis, S. intermedius, S. lactis, S. thermophilus, Pediococuss acidilactici, P. cerevisiae (damnosus), P. pentosaceus, P. acidilacticii, Leuconostoc mesenteroides, and combinations thereof. Bacilli microorganisms may include Bacillus genus and combinations thereof. For example, Bacilli microorganisms may include Bacillus licheniformis, B. subtilus, B. toyoi, B. amyloliquefaciens, B. megateriu, B. pumilus, B. coagulans, B. lentus, B. thermophilus, B. laterosporus, B. cereus, B. circulans, and combinations thereof. Bifidobacterium microorganisms may include Bifidobacterium genus and combinations thereof. For example, Bifidobacterium microorganisms may include Bifidobacterium bifidum, B. pseudolongum, B. thermophilus, B. adolescentis, B. animalis, B. infantis, B. longum, and combinations thereof. Pseudomonas microorganism may include Pseudomonas aeruginosa, P. putida, P. cepacia, P. fluorescens, and combinations thereof.

In still another embodiment, the excipient may comprise a buffering agent. Representative examples of suitable buffering agents include, but are not limited to, MOPS, HEPES, TAPS, Bicine, Tricine, TES, PIPES, MES, Tris buffers or buffered saline salts (e.g., Tris buffered saline or phosphate buffered saline).

In yet another embodiment, the excipient may include a dispersion enhancer. Suitable dispersants may include, but are not limited to, starch, alginic acid, polyvinylpyrrolidones, guar gum, kaolin, bentonite, purified wood cellulose, sodium starch glycolate, isomorphous silicate, and microcrystalline cellulose.

In a further embodiment, the excipient may include a lubricant. Non-limiting examples of suitable lubricants include minerals such as talc or silica; and fats such as vegetable stearin, magnesium stearate, or stearic acid.

In still another embodiment, it may be desirable to provide a coloring agent. Suitable color additives include, but are not limited to, food, drug and cosmetic colors (FD&C), drug and cosmetic colors (D&C), or external drug and cosmetic colors (Ext. D&C). Such colors may include but not be limited to red, yellow, green, blue, white, black, brown, purple, orange, any shade thereof, and any other color produced according to the above-named color formats.

The weight fraction of the excipient(s) in the combination may be about 98% or less, about 95% or less, about 90% or less, about 85% or less, about 80% or less, about 75% or less, about 70% or less, about 65% or less, about 60% or less, about 55% or less, about 50% or less, about 45% or less, about 40% or less, about 35% or less, about 30% or less, about 25% or less, about 20% or less, about 15% or less, about 10% or less, about 5% or less, about 2%, or about 1% or less of the total weight of the combination.

The biodegradable cleaning compositions of the present disclosure are stable under various conditions as a liquid or dry form. Preferably, the biodegradable cleaning compositions of the present disclosure are stable at room temperature.

### Methods of Manufacture

In some embodiments, the biodegradable cleaning composition may be manufactured by at least one method, in some embodiments comprising one or more steps of: (a) obtaining a starting composition comprising at least one species of microbe selected from the group consisting of at least one species of lactic acid bacteria and at least one Bacillus species; at least one organic acid; at least one carbon source; and dechlorinated water; (b) beginning a fermentation period, wherein the probiotic starting culture is fermented in at least one fermentation tank for at least one fermentation period; (c) adding at least one additional element to the probiotic starting culture, wherein, in some embodiments the at least one additional element may comprise an essential oil; (d) allowing the probiotic starting culture and the at least one additional element to ferment into a fermented product; (e) ending the fermentation period; and (f) decanting the fermented product using a centrifuge into a biodegradable cleaning composition.

In one or more embodiments of the present disclosure, the biodegradable cleaning composition may be prepared partly or entirely within one or more fermentation tanks, or bioreactor as provided in more detail below. In some embodiments, less than ten fermentation tanks may be provided. In some embodiments, less than twenty fermentation tanks may be provided. In some embodiments, more than twenty fermentation tanks may be provided. In some embodiments, one or more fermentation tank may be a primary fermentation tank. In one or more embodiments, one or more fermentation tanks may be a horizontal fermentation tank. In one or more embodiments, one or more fermentation tanks may be a vertical fermentation tank.

In some embodiments, one or more primary fermentation tanks may provide for a maximum capacity of at least 500 liters. In some embodiments, one or more primary fermentation tanks may provide for a maximum capacity of at least 5000 liters. In some embodiments, one or more primary fermentation tanks may hold at least 2006.40 liters. In some embodiments, one or more primary fermentation tanks may hold at least 5639.65 liters. In some embodiments, one or more primary fermentation tanks may hold at least 5678.00 liters. In some embodiments, one or more primary fermentation tanks may hold at least 11440.00 liters.

In some embodiments, one or more horizontal fermentation tanks may provide for a maximum capacity of at least 500 liters. In some embodiments, one or more horizontal fermentation tanks may hold at least 2006.40 liters. In some embodiments, one or more horizontal fermentation tanks may provide for a maximum capacity of at least 5000 liters. In some embodiments, one or more horizontal fermentation tanks may hold at least 5639.65 liters. In some embodiments, one or more horizontal fermentation tanks may hold at least 5678.00 liters. In some embodiments, one or more horizontal fermentation tanks may hold at least 11440.00 liters.

In some embodiments, one or more vertical fermentation tanks may provide for a maximum capacity of at least 500 liters. In some embodiments, one or more vertical fermentation tanks may hold at least 2006.40 liters. In some embodiments, one or more vertical fermentation tanks may provide for a maximum capacity of at least 5000 liters. In some embodiments, one or more vertical fermentation tanks may hold at least 5639.65 liters. In some embodiments, one or more vertical fermentation tanks may hold at least 5678.00 liters. In some embodiments, one or more vertical fermentation tanks may hold at least 11440.00 liters.

In one or more embodiments, the present disclosure may comprise five primary fermentation tanks having capacities of at least 5639.65 liters, two primary fermentation tanks having capacities of at least 11440.00 liters, three horizontal fermentation tanks having capacities of at least 5678.00 liters, and three vertical fermentation tanks having capacities of at least 2006.40 liters.

The present disclosure may provide that a co-cultured microorganism consortium according to any embodiment disclosed or suggested herein may be first provided. Such microorganism consortiums may comprise, without limitation, combinations of one or more species of Lactobacillus acetotolerans, Lactobacillus acidifarinae, Lactobacillus acidipiscis, Lactobacillus acidophilus, Lactobacillus agilis, Lactobacillus algidus, Lactobacillus alimentarius, Lactobacillus amylolyticus, Lactobacillus amylophilus, Lactobacillus amylotrophicus, Lactobacillus amylovorus, Lactobacillus animalis, Lactobacillus antri, Lactobacillus apodemi, Lactobacillus aviarius, Lactobacillus bifermentans, Lactobacillus brevis, Lactobacillus buchneri, Lactobacillus camelliae, Lactobacillus casei, Lactobacillus catenaformis, Lactobacillus ceti, Lactobacillus coleohominis, Lactobacillus collinoides, Lactobacillus composti, Lactobacillus concavus, Lactobacillus coryniformis, Lactobacillus crispatus, Lactobacillus crustorum, Lactobacillus curvatus, Lactobacillus delbrueckii subsp. bulgaricus, Lactobacillus delbrueckii subsp. delbrueckii, Lactobacillus delbrueckii subsp. lactis, Lactobacillus dextrinicus, Lactobacillus diolivorans, Lactobacillus equi, Lactobacillus equigenerosi, Lactobacillus farraginis, Lactobacillus farciminis, Lactobacillus fermentum, Lactobacillus fornicalis, Lactobacillus fructivorans, Lactobacillus frumenti, Lactobacillus fuchuensis, Lactobacillus gallinarum, Lactobacillus gasseri, Lactobacillus gastricus, Lactobacillus ghanensis, Lactobacillus graminis, Lactobacillus hammesii, Lactobacillus hamsteri, Lactobacillus harbinensis, Lactobacillus hayakitensis, Lactobacillus helveticus, Lactobacillus hilgardii, Lactobacillus homohiochii, Lactobacillus iners, Lactobacillus ingluviei, Lactobacillus intestinalis, Lactobacillus jensenii, Lactobacillus johnsonii, Lactobacillus kalixensis, Lactobacillus kefiranofaciens, Lactobacillus kefiri, Lactobacillus kimchii, Lactobacillus kitasatonis, Lactobacillus kunkeei, Lactobacillus leichmannii, Lactobacillus lindneri, Lactobacillus malefermentans, Lactobacillus mali, Lactobacillus manihotivorans, Lactobacillus mindensis, Lactobacillus mucosae, Lactobacillus murinus, Lactobacillus nagelii, Lactobacillus namurensis, Lactobacillus nantensis, Lactobacillus oligofermentans, Lactobacillus oris, Lactobacillus panis, Lactobacillus pantheris, Lactobacillus parabrevis, Lactobacillus parabuchneri, Lactobacillus paracasei, Lactobacillus paracollinoides, Lactobacillus parafarraginis, Lactobacillus parakefiri, Lactobacillus paralimentarius, Lactobacillus paraplantarum, Lactobacillus pentosus, Lactobacillus perolens, Lactobacillus plantarum, Lactobacillus pontis, Lactobacillus protectus, Lactobacillus psittaci, Lactobacillus rennini, Lactobacillus reuteri, Lactobacillus rhamnosus, Lactobacillus rimae, Lactobacillus rogosae, Lactobacillus rossiae, Lactobacillus ruminis, Lactobacillus saerimneri, Lactobacillus sakei, Lactobacillus salivarius, Lactobacillus sanfranciscensis, Lactobacillus satsumensis, Lactobacillus secaliphilus, Lactobacillus sharpeae, Lactobacillus siliginis, Lactobacillus spicheri, Lactobacillus suebicus, Lactobacillus thailandensis, Lactobacillus ultunensis, Lactobacillus vaccinostercus, Lactobacillus vaginalis, Lactobacillus versmoldensis, Lactobacillus vini, Lactobacillus vitulinus, Lactobacillus zeae, Lactobacillus zymae, Bacillus licheniformis, Bacillus pumilus, Bacillus mycoides, Bacillus coagulans, Bacillus megaterium, Bacillus subtilis, Bacillus thuringiensis, Bacillus weihenstephanensis, Enterococcus lactis, Enterococcus thermophilus, Rhodopseudomonas palustris, Rhodobacter sphaeroides, Paenibacillus polymyxa, Paenibacillus chitinolyticus, Carnobacterium sp. Enterococcus sp. Lactobacillus sp. Lactococcus sp. Leuconostoc sp. Oenococcus sp. Streptococcus sp. Tetragenococcus sp. Vagococcus sp. and Weissella sp. Bacillus cereus, Bacillus thuringiensis, and Bacillus weihenstephanensis,

The microorganism consortium may, as provided elsewhere herein, be co-cultured partly or entirely, co-cultured prior to addition to a fermentation tank, co-cultured partly before and partly after addition to a fermentation tank, or co-cultured within a fermentation tank.

In some embodiments, the fermentation tank may comprise a bioreactor. Any and all details applicable to fermentation tanks may apply to one or more bioreactors.

The bioreactor of the present disclosure may, in some embodiments, comprise a batch reactor, a semi-batch reactor, a fed batch reactor, a photobioreactor, a continuous reactor, or another type of bioreactor. The bioreactor's exterior and/or interior may be comprised of stainless steel, copper, plastic, or equivalent material(s). The bioreactor may provide for one or more temperature control elements, one or more aeration elements, one or more agitation elements, one or more baffles, one or more spargers, one or more jackets, one or more scrubbers, and at least one inflow/outflow portal. The bioreactors may comprise an immobilized cell bioreactor, such as a large-scale immobilized cell bioreactor. The bioreactor(s) may be adiabatic or non-adiabatic. The bioreactor may comprise a gas-phase bioreactor, which may be a one-step, two-step, or three- or more step gas-phase bioreactor. The bioreactor may comprise a chemostat or may support chemostatic activity or usage. The bioreactor may comprise a continuous stirred tank reactor. The bioreactor may comprise a plug flow reactor. The bioreactor may be pressurized. When two or more bioreactors are used, the bioreactors may be connected in series, in parallel, or both in series and in parallel. The bioreactor may be used in a fed-batch manner or for semi-continuous fermenter operation. The bioreactor may comprise a moving bed biofilm reactor, packed-bed, a fibrous-bed, or a membrane bioreactor.

In some embodiments, the temperature control element comprises a water jacket inside the bioreactor through which water may flow changing the temperature of the tank and thereby reducing or increasing the temperature of the bioreactor's contents. The temperature control element may comprise one or more coils that may surround the bioreactor's tank, be placed underneath the tank's base, around the top of the tank, or at one or more location.

The bioreactor agitation elements may, in some embodiments, comprise a mixer mounted to a bioreactor top element, a circulation system wherein the contents of the bioreactor are siphoned off from the bottom of the bioreactor and reintroduced at the top of the bioreactor's interior, shaking the bioreactor, shaking the contents of the bioreactor on a platform within the bioreactor, or other known methods of agitation. The agitation element may comprise a gas dispersing agitator.

Additionally, in some embodiments, the agitation element may comprise, in some embodiments, one or more anchor agitator, propeller agitator, radial propeller agitator, turbine agitator, umbrella agitator, paddle(s) agitator, flat blade agitator, ruvastar cyclo agitator, spiral propeller blade agitator, high shear homogenizer, open blade agitator, or other agitation element located inside a bioreactor. In some embodiments, agitation may comprise cycling the fermented product inside a bioreactor, or by passing air upwards through a fermented product inside a bioreactor.

The bioreactor's scrubber may comprise a wet scrubbing system, a dry scrubbing system, or both. The present disclosure's outgassing apparatus may comprise a scrubber or scrubbing system.

In some embodiments, the probiotic starting culture, fermented product, or other element of the present disclosure having a microorganism consortium (each a “fermentable element”) may be fermented for a time prior to its insertion into a bioreactor or before its combination with one or more elements.

In some embodiments, the probiotic starting culture may be fermented for about 1, 2, 3, 4, 5, 6, 7, 8, 9, 10, 11, 12, 13, 14, 15, 16, 17, 18, 19, 20, 21, 22, 23, 24, 25, or more days. Preferably, the probiotic starting culture is fermented for at least about 15 to about 23 days. More preferably, the probiotic starting culture is fermented for at least 21 days. In some embodiments, the fermentation time for the probiotic starting culture prior to its insertion into a tank or combination with one or more elements is at least 15 days. The fermentation may take place in a tank, a bioreactor, or any other vessel.

In some embodiments, another fermentable element may be fermented for about 1, 2, 3, 4, 5, 6, 7, 8, 9, 10, 11, 12, 13, 14, 15, 16, 17, 18, 19, 20, 21, 22, 23, 24, 25, or more days. Preferably, the other fermentable element is fermented for at least about 15 to about 23 days. More preferably, the other fermentable element is fermented for at least 21 days. In some embodiments, the fermentation time for the other fermentable element prior to its insertion into a tank or combination with one or more elements is at least 15 days. The fermentation may take place in a tank, a bioreactor, or any other vessel.

The present disclosure may provide that one or more volumes of the probiotic starting culture be added to one or more primary fermentation tanks. Without limitation, less than 10 liters, less than 500 liters, less than 1000 liters, or more than 1000 liters of the probiotic starting culture may be added to one or more primary tanks. In some embodiments, at least 625.2 liters of the probiotic starting culture may be added to one or more primary tanks. Relatedly, and without limitation, less than 10 gallons, less than 500 gallons, less than 1000 gallons, or more than 1000 gallons of the probiotic starting culture may be added to one or more primary tanks. In some embodiments, at least 165.2 gallons of the probiotic starting culture may be added to one or more primary tanks. Moreover, and without limitation, less than 10 kg, less than 500 kg, less than 1000 kg, or more than 1000 kg of the probiotic starting culture may be added to one or more primary tanks. In some embodiments, at least 625.2 kg of the probiotic starting culture may be added to one or more primary tanks. The probiotic starting culture may comprise less than 10%, less than 25%, less than 50%, less than 75%, less than 95%, or less than 99.9% of the total in-tank solution. In some embodiments, the probiotic starting culture comprises 60% of the total in-tank solution.

Next, one or more volumes of one or more additional elements may be added to the probiotic starting culture in one or more primary fermentation tanks. The additional element(s) may be added to the probiotic starting culture at an amount less than 10 liters, less than 500 liters, less than 1000 liters, or more than 1000 liters in the one or more primary tanks. In some embodiments, at least 104.2 liters of the additional element(s) may be added to the probiotic starting culture in the one or more primary tanks. Relatedly, and without limitation, less than 10 gallons, less than 500 gallons, less than 1000 gallons, or more than 1000 gallons of the additional element(s) may be added to the probiotic starting culture in the one or more primary tanks. In some embodiments, at least 27.5 gallons of the additional element(s) may be added to the probiotic starting culture in the one or more primary tanks. Moreover, and without limitation, less than 10 kg, less than 500 kg, less than 1000 kg, or more than 1000 kg of the additional element(s) may be added to the probiotic starting culture in the one or more primary tanks. In some embodiments, at least 104.2 kg of the additional element(s) may be added to the probiotic starting culture in the one or more primary tanks. The additional element(s) may comprise less than 10%, less than 25%, less than 50%, less than 75%, less than 95%, or less than 99.9% of the total in-tank solution. In some embodiments, the additional element(s) comprises 10% of the total in-tank solution. The product of the probiotic starting culture and the additional element(s) may comprise one or more fermented product(s).

In some embodiments, the probiotic starting culture, the probiotic starting culture plus additional element(s), and/or the fermented product may be agitated. In some embodiments, the agitation may be constant. In some embodiments, the agitation may be constant and may last for one minute, less than thirty minutes, less than 1 hour, less than 12 hours, less than 24 hours, or more than 24 hours. In some embodiments, the fermented product may be constantly agitated for at least 1 hour.

Following fermentation, the fermented product may be extracted or decanted.

Following agitation, in some embodiments, the biodegradable cleaning composition may be extracted or decanted.

The extraction and/or decanting step may comprise passing the fermented product through a 30-micron filter, feeding the fermented product into a centrifuge at a feed rate of 150 cc/minute, then centrifuging the fermented product at 22,000-23,000 revolutions per minute.

In some embodiments, the fermented product may be concentrated. In some embodiments, the fermented product may be concentrated before being extracted. In some embodiments, the fermented product may be concentrated after being extracted.

In some embodiments, the step of concentrating the fermented product or the biodegradable cleaning composition product may comprise decanting the fermented product or biodegradable cleaning composition. The decanting step may utilize any techniques or decanting equipment known in the art. In some embodiments, the decanting step may be performed until a suitable product is formed and collected. At any step in the method, including but not limited to one or more fermentation steps, some of all of the probiotic starting culture, the fermented product, or any form of the biodegradable cleaning composition, as applicable, may be held within a primary fermentation tank, a horizontal fermentation tank, a vertical fermentation tank, or any combination of tanks.

In other embodiments, the step of concentrating the fermented product or biodegradable cleaning composition may comprise passing the fermented product through a gravity filtration apparatus, evaporating the fermented product or biofertilizer via an evaporator, evaporating the fermented product or biofertilizer via passive evaporation, or concentration by pervaporative separation of the fermented product or biofertilizer via a pervaporation system.

At any point or step of the method, any mixture, composition, or product of the present disclosure may undergo a fermentation. For example, the probiotic starting culture (previously or concurrently with its presence in one or more fermentation tanks), the first modified composition, the second modified composition, or the fermented product, as applicable, may undergo one or more additional or alternate fermentations. Each of the one or more fermentations may comprise any amount of time known or anticipated to be useful, such as but not limited to about 1, 2, 3, 4, 5, 6, 7, 8, 9, 10, 11, 12, 13, 14, 15, 16, 17, 18, 19, 20, 21, 22, 23, 24, 25, or more days. Preferably, the composition is fermented for at least about 15 to about 23 days. More preferably, the probiotic starting culture, the first modified composition, the second modified composition, or the fermented product, as applicable, may be fermented for at least 21 days. More preferably, the probiotic starting culture, the first modified composition, the second modified composition, or the fermented product, as applicable, may be fermented for at least 15 days.

The decanted product of the fermented product, in some embodiments, may be the biodegradable cleaning composition, which generally is present in liquid form.

In some embodiments, the method further comprises the step of removing water from the biodegradable cleaning composition to form a solid biodegradable cleaning composition. In some embodiments, the solid biodegradable cleaning composition may comprise ≤10% water (w/w).

### EXAMPLES

### Example 1

Report Date: Aug. 23, 2019

Report #: Updated GSP-08-23-2019

Test Method: ASTM D4488-A5 Particulate and Oily Soil/Vinyl Tiles Test Method

Samples:

| Sample Name | Test Dilution |
|---|---|
| Z1 - GR | 5% dilution |
| Z1 - LG | 5% dilution |
| Z1 - LV | 5% dilution |
| Z1 - GR | 10% dilution |
| Z1 - LG | 10% dilution |
| Z1 - LV | 10% dilution |

Procedure: A synthetic particulate soil is prepared according to ASTM D4488-95 (2001) A5. An amount of 50 mg of this particulate soil is placed on a white vinyl tile over an area of 2×4 in. as defined with a template. The soil mound is covered with a piece of paper towel and 5 drops of an oil blend is applied to the soil. The soil is rubbed over the 2×4 in area in a circular motion. The soiled tile is allowed to air dry for 24 hours. Reflectance readings are recorded from the clean tile, the soiled tile, and the cleaned tile. Cleaning is performed by adding 50 ml of the cleaning solution to a sponge. The soiled area is covered with 20 ml of the cleaning solution for 60 seconds and then scrubbed with the sponge for 10 cycles with a gardner Straight-line Washability Apparatus.

Calculation of Cleaning Efficiency:Cleaning efficiency (%)=(R1−R2)/(R3−R2)

Where: R1=reflectance of soiled tile after cleaning
R2=reflectance of soiled tile before cleaning
R3=reflectance of tile before soiling

Results:

| Sample | Cleaning Efficiency (%) | Standard Deviation |
|---|---|---|
| 5% Z1- GR | 85.51 | 0.04 |
| 5% Z1- LG | 86.66 | 0.01 |
| 5% Z1- LV | 87.95 | 0.01 |
| 10% Z1- GR | 87.90 | 0.02 |
| 10% Z1- LG | 87.63 | 0.02 |
| 10% Z1- LV | 90.01 | 0.01 |

*2 replicates of tiles were tested.

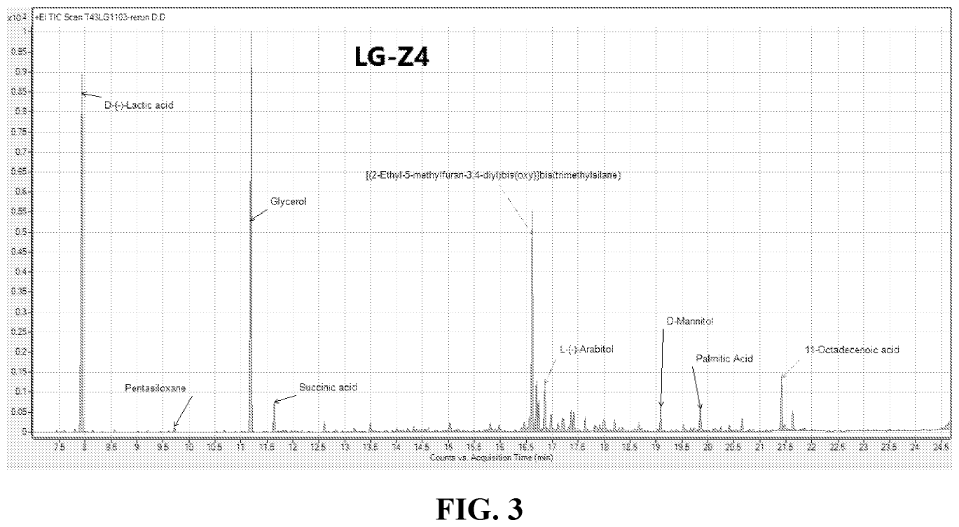

As may be seen in FIG. 3, the below images illustrate some aspects of Experiment 1:

These results improved on previous results, here reproduced per the table below:

Summary of Cleaning Efficiency Per ASTM 4499-95 (A5)

| Sample Number | [Con. %] | % Cleaning Efficiency |
|---|---|---|
| Z1_GR-1 | 5 | 44.02 ± 5.22 |
| Z1_GR-2 | 10 | 62.41 ± 6.95 |
| Z1_GR-3 | 15 | 66.58 ± 7.20 |
| Z1_GR-4 | 20 | 75.47 ± 2.79 |
| Z1_GR-5 | 25 | 74.25 ± 2.77 |
| Z1_GR-6 | 30 | 74.41 ± 2.42 |
| Z1_GR-7 | 35 | 74.89 ± 1.36 |
| Z1_LG-1 | 5 | 56.27 ± 3.62 |
| Z1_LG-2 | 10 | 57.27 ± 5.53 |
| Z1_LG-3 | 15 | 62.13 ± 7.73 |
| Z1_LG-4 | 20 | 71.58 ± 2.73 |
| Z1_LG-5 | 25 | 70.14 ± 1.51 |
| Z1_LG-6 | 30 | 70.3 ± 2.27 |
| Z1_LG-7 | 35 | 72.68 ± 3.29 |

### Example 2

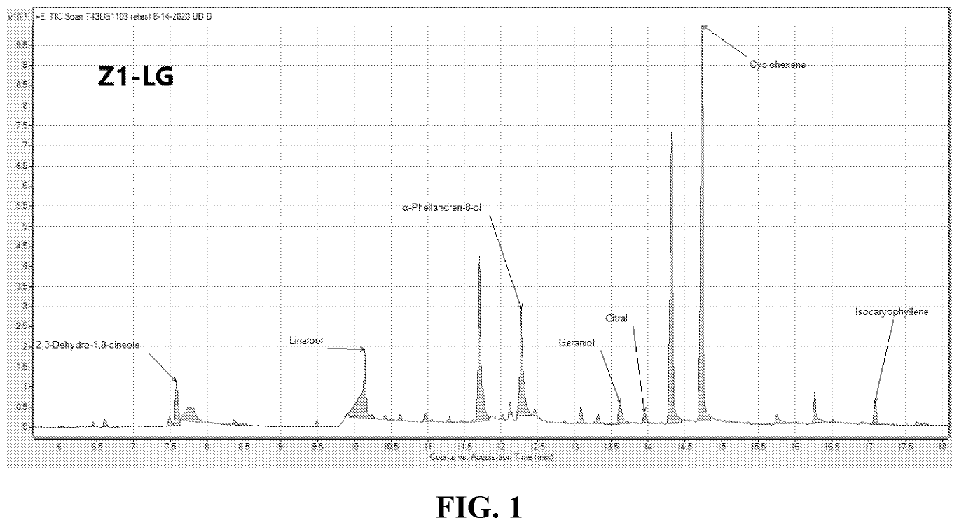

As can be seen in FIGS. 1-18, untargeted metabolomics analysis was conducted on or around Sep. 1, 2020 on two samples of the biogradable cleaning composition. The results indicated:

| | | Eucalyptol | Linalool | Alcanfor | Linderol | a-Terpineol |
|---|---|---|---|---|---|---|
| Initial UTM Run | T43LG2301-Jun. 24, 2020 D | — | — | — | — | — |
| Sep. 30, 2020 | T43LG2301-Jun. 24, 2020 UD | — | — | — | — | — |
| | T43LG1103-Aug. 13, 2020 D | — | — | — | — | — |
| | T43LG1103-Aug. 13, 2020 UD | — | — | — | — | — |
| | T43LG2902-Aug. 14, 2020 D | — | — | — | — | — |
| | T43LG2902-Aug. 14, 2020 UD | — | — | — | — | — |
| | T43LG1103-Aug. 14, 2020 D | — | — | — | — | — |
| | T43LG1103-Aug. 14, 2020 UD | — | — | — | — | — |
| | T43LV2303-Jun. 24, 2020 D | — | — | — | — | — |
| | T43LV2303-Jun. 24, 2020 UD | 1.06E+06 | 4.97E+06 | 1.78E+06 | 9.39E+05 | 3.49E+06 |
| | T43LV0705-Aug. 11, 2020 D | — | — | — | — | — |
| | T43LV0705-Aug. 11, 2020 UD | 9.96E+05 | 6.27E+06 | 1.76E+06 | 9.51E+05 | 2.83E+06 |
| | T43LV2904-Aug. 14, 2020 D | — | — | — | — | — |
| | T43LV2904-Aug. 14, 2020 UD | 1.04E+06 | 6.60E+06 | 1.78E+06 | 9.77E+05 | 2.99E+06 |
| | T43LV0705-Aug. 14, 2020 D | — | — | — | — | — |
| | T43LV0705-Aug. 14, 2020 UD | 1.04E+06 | 6.73E+06 | 1.80E+06 | 9.94E+05 | 3.06E+06 |

| | | 6,7-Dihydro-7-hydroxylinaloo | Neryl alcohol | Lavandulol Acetate |
|---|---|---|---|---|
| Initial UTM Run | T43LG2301-Jun. 24, 2020 D | — | — | — |
| Sep. 30, 2020 | T43LG2301-Jun. 24, 2020 UD | — | — | — |
| | T43LG1103-Aug. 13, 2020 D | — | — | — |
| | T43LG1103-Aug. 13, 2020 UD | — | — | — |
| | T43LG2902-Aug. 14, 2020 D | — | — | — |
| | T43LG2902-Aug. 14, 2020 UD | — | — | — |
| | T43LG1103-Aug. 14, 2020 D | — | — | — |
| | T43LG1103-Aug. 14, 2020 UD | — | — | — |
| | T43LV2303-Jun. 24, 2020 D | — | — | — |
| | T43LV2303-Jun. 24, 2020 UD | 2.17E+06 | 3.25E+05 | 3.67E+05 |
| | T43LV0705-Aug. 11, 2020 D | — | — | — |
| | T43LV0705-Aug. 11, 2020 UD | 1.19E+06 | 3.80E+05 | 3.39E+05 |
| | T43LV2904-Aug. 14, 2020 D | — | — | — |
| | T43LV2904-Aug. 14, 2020 UD | 1.31E+06 | 3.67E+05 | 3.49E+05 |
| | T43LV0705-Aug. 14, 2020 D | — | — | — |
| | T43LV0705-Aug. 14, 2020 UD | 1.17E+06 | 4.10E+05 | 3.54E+05 |

| | | 2,3-Dehydro-1,8-cineole | Linalool | a-Phellandrene-8-ol |
|---|---|---|---|---|
| Initial UTM Run | T43LG2301-Jun. 24, 2020 D | | | |
| Sep. 30, 2020 | T43LG2301-Jun. 24, 2020 UD | 3.63E+05 | 5.60E+05 | 1.14E+06 |
| | T43LG1103-Aug. 13, 2020 D | | | |
| | T43LG1103-Aug. 13, 2020 UD | 4.16E+05 | 5.66E+05 | 1.51E+06 |
| | T43LG2902-Aug. 14, 2020 D | | | |
| | T43LG2902-Aug. 14, 2020 UD | 3.23E+05 | 7.05E+05 | 1.79E+06 |
| | T43LG1103-Aug. 14, 2020 D | | | |
| | T43LG1103-Aug. 14, 2020 UD | 4.88E+05 | 1.44E+06 | 1.47E+06 |
| | T43LV2303-Jun. 24, 2020 D | — | — | — |
| | T43LV2303-Jun. 24, 2020 UD | — | — | — |
| | T43LV0705-Aug. 11, 2020 D | | | |
| | T43LV0705-Aug. 11, 2020 UD | — | — | — |
| | T43LV2904-Aug. 14, 2020 D | | | |
| | T43LV2904-Aug. 14, 2020 UD | — | — | — |
| | T43LV0705-Aug. 14, 2020 D | | | |
| | T43LV0705-Aug. 14, 2020 UD | — | — | — |

| | | Geraniol | Citral | Cyclohexene | socaryophyllene |
|---|---|---|---|---|---|
| Initial UTM Run | T43LG2301-Jun. 24, 2020 D | | | | |
| Sep. 30, 2020 | T43LG2301-Jun. 24, 2020 UD | 1.81E+05 | 1.56E+04 | 3.13E+06 | 2.13E+05 |
| | T43LG1103-Aug. 13, 2020 D | | | | |
| | T43LG1103-Aug. 13, 2020 UD | 3.07E+05 | 1.30E+05 | 3.77E+06 | 2.04E+05 |
| | T43LG2902-Aug. 14, 2020 D | | | | |
| | T43LG2902-Aug. 14, 2020 UD | 1.67E+05 | 1.86E+04 | 3.57E+06 | 1.79E+05 |
| | T43LG1103-Aug. 14, 2020 D | | | | |
| | T43LG1103-Aug. 14, 2020 UD | 3.26E+05 | 1.39E+05 | 4.18E+06 | 1.97E+05 |
| | T43LV2303-Jun. 24, 2020 D | — | — | — | — |
| | T43LV2303-Jun. 24, 2020 UD | — | — | — | — |
| | T43LV0705-Aug. 11, 2020 D | | | | |
| | T43LV0705-Aug. 11, 2020 UD | — | — | — | — |
| | T43LV2904-Aug. 14, 2020 D | | | | |
| | T43LV2904-Aug. 14, 2020 UD | — | — | — | — |
| | T43LV0705-Aug. 14, 2020 D | | | | |
| | T43LV0705-Aug. 14, 2020 UD | — | — | — | — |

| | | Lactic Acid | Sorbic Acid | Glycerol | Succinic Acid |
|---|---|---|---|---|---|
| Initial UTM Run | T43LG2301-Jun. 24, 2020 D | 3.69E+06 | — | 3.55E+06 | 4.66E+05 |
| Sep. 30, 2020 | T43LG2301-Jun. 24, 2020 UD | | — | — | — |
| | T43LG1103-Aug. 13, 2020 D | 3.69E+06 | — | 3.34E+06 | — |
| | T43LG1103-Aug. 13, 2020 UD | | — | — | — |
| | T43LG2902-Aug. 14, 2020 D | 2.83E+06 | — | 3.60E+06 | 3.78E+05 |
| | T43LG2902-Aug. 14, 2020 UD | | — | — | — |
| | T43LG1103-Aug. 14, 2020 D | 2.15E+06 | — | 3.83E+06 | 2.87E+05 |
| | T43LG1103-Aug. 14, 2020 UD | — | — | — | — |
| | T43LV2303-Jun. 24, 2020 D | 3.70E+06 | 5.92E+05 | 2.86E+06 | 3.18E+05 |
| | T43LV2303-Jun. 24, 2020 UD | — | — | — | — |
| | T43LV0705-Aug. 11, 2020 D | 3.27E+06 | 7.04E+05 | 2.61E+06 | 2.88E+05 |
| | T43LV0705-Aug. 11, 2020 UD | — | — | — | — |
| | T43LV2904-Aug. 14, 2020 D | 2.98E+06 | 3.46E+05 | 3.01E+06 | 2.84E+05 |
| | T43LV2904-Aug. 14, 2020 UD | — | — | — | — |
| | T43LV0705-Aug. 14, 2020 D | 2.86E+06 | 3.98E+05 | 2.98E+06 | 2.83E+05 |
| | T43LV0705-Aug. 14, 2020 UD | — | — | — | — |

| | | | Methylmaleic | | | Palmitic | |
|---|---|---|---|---|---|---|---|
| | | Terpin | Acid | Citric Acid | D-Mannitol | Acid | Stearic Acid |
| Initial UTM Run | T43LG2301-Jun. 24, 2020 D | — | 4.85E+04 | 1.28E+08 | — | 1.33E+06 | 1.71E+06 |
| Sep. 30, 2020 | T43LG2301-Jun. 24, 2020 UD | — | — | | — | | |
| | T43LG1103-Aug. 13, 2020 D | — | — | 1.26E+08 | — | 1.23E+06 | 1.52E+06 |
| | T43LG1103-Aug. 13, 2020 UD | — | — | | — | | |
| | T43LG2902-Aug. 14, 2020 D | — | 1.41E+05 | 1.28E+08 | — | 1.73E+06 | 2.09E+06 |
| | T43LG2902-Aug. 14, 2020 UD | — | — | | — | | |
| | T43LG1103-Aug. 14, 2020 D | — | — | 1.26E+08 | — | 1.63E+06 | 2.17E+06 |
| | T43LG1103-Aug. 14, 2020 UD | — | — | — | — | — | — |
| | T43LV2303-Jun. 24, 2020 D | 5.36E+05 | — | 1.24E+08 | — | 1.21E+06 | 1.47E+06 |
| | T43LV2303-Jun. 24, 2020 UD | 4.90E+05 | — | | — | | |
| | T43LV0705-Aug. 11, 2020 D | 2.83E+05 | — | 1.29E+08 | — | 1.18E+06 | 1.62E+06 |
| | T43LV0705-Aug. 11, 2020 UD | 2.27E+05 | — | | — | | |
| | T43LV2904-Aug. 14, 2020 D | 2.31E+05 | — | 1.26E+08 | — | 1.63E+06 | 2.06E+06 |
| | T43LV2904-Aug. 14, 2020 UD | 2.64E+05 | — | | — | | |
| | T43LV0705-Aug. 14, 2020 D | 2.65E+05 | — | 1.29E+08 | — | 1.62E+06 | 2.15E+06 |
| | T43LV0705-Aug. 14, 2020 UD | 2.58E+05 | — | — | — | — | — |

| | Intensity (Area) | | | |
|---|---|---|---|---|
| | Initial Time point | | | |
| Compound | LV0205 D | LV0206 D | LG3005 D | LG3006 D |
| Lactic Acid | 8.36E+07 | 9.83E+07 | — | — |
| Glycerol | 7.35E+07 | 7.83E+07 | — | — |
| Succinic Acid | 9.63E+06 | 9.61E+06 | — | — |
| D-(+)-Arabitol | 3.53E+07 | 3.29E+07 | — | — |
| D-(−)-Fructofuranose | 1.62E+08 | 1.63E+08 | — | — |
| D-Fructose | 8.50E+07 | 2.26E+08 | — | — |
| D-Glucitol | 6.38E+07 | 5.80E+07 | — | — |
| b-D-Glucopyranose | 1.33E+08 | 1.21E+08 | — | — |
| Oleic Acid | 3.42E+07 | 3.64E+07 | — | — |
| Benzene | — | — | 2.99E+06 | 2.22E+06 |
| 2-Furaldehyde | — | — | 3.57E+07 | 2.64E+07 |
| 5-(1-Hydroxy-1-methylethyl)-2-methyl-2-cyclohexene-1,4-diol # | — | — | 3.80E+06 | 2.74E+06 |
| methyl 13,16-octadecadiynoate # | — | — | 5.51E+06 | 3.06E+06 |
| [symbol] imethylsilyl (3E)-3-methyl-5-[(trimethylsilyl)oxy]-3,5-hexadienoate # | — | — | 2.87E+06 | 1.08E+07 |
| D-(−)-Fructopyranose | — | — | 1.72E+06 | 1.25E+06 |
| cis-Vaccenic Acid | — | — | 8.91E+06 | 1.33E+07 |

[symbol]

indicates data missing or illegible when filed

| | Intensity (Area) | |
|---|---|---|
| | Initial time point | |
| Compound | T43LG1103 UD | T43LG1103 D |
| Glycerol Trilaurate | 2.89E+07 | — |
| D-(−)-Lactic Acid | — | 4.52E+07 |
| Glycerol | — | 4.57E+07 |
| Succinic Acid | — | 2.63E+06 |
| D-Mannitol | — | 2.41E+06 |
| Palmitic Acid | — | 2.61E+06 |
| Sulcatone | 1.09E+06 | — |
| 2,3-Dehydro-1,8-cineole | 1.15E+06 | — |
| 4-Nonanone | 1.31E+06 | — |
| Linalool | 2.86E+06 | — |
| a-Phellandren-8-ol | 7.51E+06 | — |
| b-Citral | 2.07E+07 | — |
| Geraniol | 9.66E+06 | — |
| a-Citral | 4.35E+07 | — |
| Cyclohexene, 3-acetoxy-4-(1-hydroxy-1-methylethyl)-1-methyl | 1.18E+07 | — |
| 2,6-Octadien-1-ol, 3,7-dimethyl-,acetate | 6.68E+06 | — |
| Caryophyllene | 2.46E+06 | — |
| y-Cadinese | 2.51E+06 | — |
| Cadina-1(10),4-diene | 8.82E+05 | — |
| Caryphyllene oxide | 8.88E+05 | — |
| Pentasiloxane | — | 4.91E+05 |
| [(2-Ethyl-5-methylfuran-3,4-diyl)bis(oxy)]bis(trimethylsilane) | — | 2.07E+07 |
| L-(−)-Arabitol | — | 4.53E+06 |
| 11-Octadecenoic Acid | — | 5.40E+06 |

### Example 3

On or around Sep. 1, 2020, experiments were run on at least one biodegradable cleaning composition described herein per the following testing methodologies:

Lactic Acid Bacteria testing: Serial dilutions of the samples are performed using peptone water and the resulting dilutions are cultured on the Lactobacilli MRS agar media by pour plate method. The media plates are then incubated anaerobically at 37° C. for 3-5 days. The counts from the plate within the range of 25-250 colonies are counted and reported as CFU/mL.

Bacillus testing: Serial dilutions of the samples are performed using peptone water and the resulting dilutions are cultured on the Tryptic soy agar media by spread plate method. The media plates are incubated aerobically at 35° C. upto 3 days. The counts from the plate within the range of 25-250 colonies are counted and reported as CFU/mL

Yeast and Mold testing: The samples are cultured on Potato dextrose agar media and the plates are incubated in the incubator at 32° C. for 3 days for yeast counts and 5 days for the mold testing.

Coliform/E coli testing: The samples are cultured on the freshly made Violet Red Bile Agar media by pour plated method. The plates are incubated in the incubator for 18-24 hrs. at 35-37° C. 3M™ Petrifilm™ E. coli/Coliform Count Plate can be used as an alternative to Violet red bile agar and same incubation procedures are followed. Red or blue colonies with associated gas colonies are counted as coliform colonies.

Pathogen testing/challenge: The time-kill test involves inoculating the sample with a known concentration of pathogenic microorganisms and sampling them immediately after inoculation and 1 hour, 3 hours, 7 hours, 24 hours, and 48 hours after inoculation. The purpose of this test is to determine how rapidly the sample can eradicate pathogenic microorganisms.

The challenge test involves inoculating a sample with a known concentration of the microorganisms to test, such as Candida albicans, Staphylococcus aureus, Aspergillus brasieliensis, etc. The sample is tested for the presence of the microorganisms immediately after inoculation, as well as 7, 14, and 28 days after inoculation. The concentration is determined at each timepoint and compared to the initial recovery to determine the percent reduction. The purpose of this test is to determine whether the product is sufficiently capable of killing any undesirable microorganisms that may be present.

% TA testing: % Titratable Acidity is the measure of the amount of acid present in a substance. It is determined by the amount of strong base required to neutralize the acid. Lactic acid is formed as a result of fermentation process as secondary metabolite and the % of lactic acid is determined by amount of 1N sodium hydroxide used to neutralize the acid. % lactic acid=((mL NaOH×N NaOH×milliequivalent weight of lactic acid*)×100)/(volume of Product Sample in mL)

Surface Tension testing: Surface tension is measured are made using the Force tensiometer by Du Noüy ring method. The values are reported as N/m (Newton/meter) or dyn/cm (dyne per centimeter)

Spore Germination testing: This test is done to demonstrate Bacillus spore germination on surface for competitive exclusion. The sample is inoculated on 2 sets of 10 cm×10 cm surface and they are incubated at ambient temperature. One set of hard surface is washed with PBS buffer and the eluted samples in divided into two parts. One part of sample is plated at T0 and another sample incubated at 72° C. for 30 min and then plated on TSA media and incubated up to 24-72 hrs. The microbial colony counts are recorded. At 24 hrs. another set of prepped hard surface is tested and processed as T24 samples.

Surface Cleaning of Pathogens testing: This test is done to demonstrate the cleaning product's ability to remove undesirable microorganisms from surface and to inhibit re-contamination. A cell suspension containing S. aureus, E. coli, Salmonella sp. and P. aeruginosa, A. fumigatus is seeded on a sterile 10 cm×10 cm surface (100 cm2) at ambient temperature. The surface is treated with the cleaning product and wiped off. The resulting surface is washed off with PBST buffer and the samples are plated on MacConkey media for E. coli, XLD media for Salmonella sp. Cetrimide media for P. aeruginosa, Baird-Parker media for S. aureus, and PDA for A. fumigatus. at T0, and the same steps are repeated at T7, T24, and T48. The inoculated plates are then incubated at 35±2 0 C for 24-72 hrs. and at 25±2 0 C for 72-140 hrs. for fungal samples. The resulting colonies counts are recorded as CFU/mL

Microbial counts for samples Z1 and Z2

| | TSA (Bacillus | MRS (LAB) |
|---|---|---|
| Samples | sp.) (cfu/ml) | (cfu/ml) |
| Z1 (6.5%) | 1.1 × 10⁶ | 2.0 × 10⁰ |
| Z2 (9.5%) | 2.3 × 10⁶ | 7.0 × 10⁰ |

### Surface

### Testing

### Z1 Sample

| | TSA | YM | MRS |
|---|---|---|---|
| Time | (CFU/cm2) | (CFU/cm2) | (CFU/cm2) |
| T0 | 1.31 × 10\hat{ }3 | 8.15 × 10\hat{ }1 | <10 |
| T6 | 1.04 × 10\hat{ }3 | 5.87 × 10\hat{ }1 | <10 |
| T24 | 1.69 × 10\hat{ }3 | 4.71 × 10\hat{ }1 | <10 |
| T48 | 1.52 × 10\hat{ }3 | 7.08 × 10\hat{ }1 | <10 |
| T72 | 1.19 × 10\hat{ }3 | 3.16 × 10\hat{ }1 | <10 |
| T96 | 1.91 × 10\hat{ }3 | 6.48 × 10\hat{ }1 | <10 |
| T164 | 1.82 × 10\hat{ }3 | 8.55 × 10\hat{ }1 | <10 |
| T192 | 1.44 × 10\hat{ }3 | 6.98 × 10\hat{ }1 | <10 |

### Z2 Sample

| | TSA | YM | MRS |
|---|---|---|---|
| Time | (CFU/cm2) | (CFU/cm2) | (CFU/cm2) |
| T0 | 4.39 × 10\hat{ }3 | 1.92 × 10\hat{ }2 | <10 |
| T6 | 3.64 × 10\hat{ }3 | 1.29 × 10\hat{ }2 | <10 |
| T24 | 3.97 × 10\hat{ }3 | 1.05 × 10\hat{ }2 | <10 |
| T48 | 1.64 × 10\hat{ }3 | 1.24 × 10\hat{ }2 | <10 |
| T72 | 2.20 × 10\hat{ }3 | 7.0 × 10\hat{ }1 | <10 |
| T96 | 2.85 × 10\hat{ }3 | 1.22 × 10\hat{ }2 | <10 |
| T164 | 4.25 × 10\hat{ }3 | 3.02 × 10\hat{ }2 | <10 |
| T192 | 1.64 × 10\hat{ }3 | 7.6 × 10\hat{ }1 | <10 |

### Spore Germination

### Z1 Sample 6.5% Dilution)

| | | Bacillus | | | Average |
|---|---|---|---|---|---|
| Rep- | Time | spp. (total) | Bacillus spp. | Germination | germination |
| licate | (hrs) | (cfu/cm²) | (spores)(cfu/cm²) | rate (%) | rate (%) |
| 1 | T0 | 6.5 × 10\hat{ }3 | 4.3 × 10\hat{ }3 | | |
| | T24 | 4.5 × 10\hat{ }3 | 3.5 × 10\hat{ }3 | 53.85% | |
| 2 | T0 | 8.4 × 10\hat{ }3 | 5.8 × 10\hat{ }3 | | |
| | T24 | 3.6 × 10\hat{ }3 | 3.5 × 10\hat{ }3 | 41.67% | 47.76% |

### Spore Germination

### Z2 Sample 9.5% Dilution)

| | | Bacillus | | | Average |
|---|---|---|---|---|---|
| Rep- | Time | spp. (total) | Bacillus spp. | Germination | germination |
| licate | (hrs) | (cfu/cm²) | (spores)(cfu/cm²) | rate (%) | rate (%) |
| 1 | T0 | 7.5 × 10\hat{ }3 | 4.6 × 10\hat{ }3 | | |
| | T24 | 7.3 × 10\hat{ }3 | 6.0 × 10\hat{ }3 | 80% | |
| 2 | T0 | 6.6 × 10\hat{ }3 | 4.1 × 10\hat{ }3 | | |
| | T24 | 5.3 × 10\hat{ }3 | 5.2 × 10\hat{ }3 | 78.79% | 79.39% |

### Stability of Z1

Z1 - LV

| Analysis | initital test | 3 months |
|---|---|---|
| LAB CFU/mL | 7.3 × 10\hat{ }4-1.99 × 10\hat{ }5 | 7.8 × 10\hat{ }4-1.42 × 10\hat{ }5 |
| Bacillus CFU/mL | 2.5 × 10\hat{ }5-1.92 × 10\hat{ }5 | 2.5 × 10\hat{ }5-1.96 × 10\hat{ }5 |
| yeast CFU/mL | 3.5 × 10\hat{ }1-2.8 × 10\hat{ }3 | <2.5 × 10\hat{ }19 (14)-1.20 × |
| | | 10\hat{ }2 |
| Mold CFU/mL | <10(0) | <10(0) |
| Coliform/E. coli | <10(0) | <10(0) |
| CFU/mL | | |
| % TA | 0.03-0.04 | 0.05-0.10 |
| pH | 3.18-3.23 | 3.14-3.29 |
| Surface tension | 28.90-30.52 | 29.37-34.04 |

| Pathogen testing (GR and LG) | Effective (test period 48 hrs) |
|---|---|
| S. typhimurium | Yes |
| Pseudomonas aeruginosa | Yes |
| Staphylococcus aureus | Yes |

### Stability of Z-2

Z2 - LG

| Analysis | initital test | 3 months |
|---|---|---|
| LAB CFU/mL | 2.6 × 10\hat{ }5-2.53 × 10\hat{ }5 | 3.2 × 10\hat{ }5-1.41 × 10\hat{ }5 |
| Bacillus CFU/mL | 2.5 × 10\hat{ }5-1.88 × 10\hat{ }5 | 2.9 × 10\hat{ }5-4.5 × 10\hat{ }5 |
| yeast CFU/mL | <10(0) | <10(0) |
| Mold CFU/mL | <10(0) | <10(0) |
| Coliform/E. coli CFU/mL | <10(0) | <10(0) |

| Pathogen testing | Effective (test period 48 hrs) |
|---|---|
| Escherichia coli | Yes |
| S. typhimurium | Yes |
| Pseudomonas aeruginosa | Yes |
| Staphylococcus aureus | Yes |

Z2 - GR

| Analysis | initital test | 3 months |
|---|---|---|
| LAB CFU/mL | 2.6 × 10\hat{ }5-2.53 × 10\hat{ }5 | 9.9 × 10\hat{ }4-1.89 × 10\hat{ }5 |
| Bacillus CFU/mL | 2.5 × 10\hat{ }5-3.7 × 10\hat{ }5 | 3.0 × 10\hat{ }5-4.8 × 10\hat{ }5 |
| yeast CFU/mL | <10(0)-<100(5) | <10(0) |
| Mold CFU/mL | <10(0) | <10(0) |
| Coliform/E. coli CFU/mL | <10(0) | <10(0) |

| Pathogen testing | Effective (test period 48 hrs) |
|---|---|
| Escherichia coli | Yes |
| S. typhimurium | Yes |
| Pseudomonas aeruginosa | Yes |
| Staphylococcus aureus | Yes |

| Analysis | initital test | 3 months |
|---|---|---|
| LAB CFU/mL | 7.7 × 10\hat{ }4-2.14 × 10\hat{ }5 | 2.9 × 10\hat{ }5-1.84 × 10\hat{ }5 |
| Bacillus CFU/mL | 3.4 × 10\hat{ }5-5.1 × 10\hat{ }5 | 4.6 × 10\hat{ }5-6.3 × 10\hat{ }5 |
| yeast CFU/mL | <10(0)-1.00 × 10\hat{ }2 | <10(0)-<100(3) |
| Mold CFU/ml | <10(0) | <10(0) |
| Coliform/E. coli CFU/mL | <10(0) | <10(0) |
| % TA | 0.04-0.07 | 0.07-0.10 |
| pH | 3.03-3.14 | 3.04-3.21 |
| Surface tension | 27.47-36.13 | 28.03-34.95 |

### Z-1 Cleaning Efficiency:

| Sample | Cleaning Efficiency (%) |
|---|---|
| 5% Z1- GR | 85.51 |
| 5% Z1- LG | 86.66 |
| 5% Z1- LV | 87.95 |

### Z-2 Cleaning Efficiency:

| Sample | Cleaning Efficiency (%) |
|---|---|
| 10% Z2- GR | 87.9 |
| 10% Z2- LG | 87.63 |
| 10% Z2- LV | 90.01 |

Stability of Z3

| | | | | | |
|---|---|---|---|---|---|
| Analysis | initital test | 3 months | 6 months | 9 months | 12 months |

Z3 -LG

| | | | | | |
|---|---|---|---|---|---|
| LAB CFU/mL | 2.6 × 10\hat{ }6- | 1.49 × 10\hat{ }6- | 8.9 × 10\hat{ }4- | <100(2)- | to be tested |
| | 3.7 × 10\hat{ }6 | 1.95 × 10\hat{ }6 | 7.5 × 10\hat{ }5 | 2.6 × 10\hat{ }1 | in October |
| Bacillus CFU/mL | 5.1 × 10\hat{ }6- | 2.5 × 10\hat{ }6- | 3.2 × 10\hat{ }4- | <10(0)- | |
| | 6.5 × 10\hat{ }6 | 4.5 × 10\hat{ }6 | 1.16 × 10\hat{ }6 | <2.5 × 10\hat{ }1 (11) | |
| yeast CFU/mL | <10(0) | <10(0) | <10(0) | <10(0) | |
| Mold CFU/mL | <10(0) | <10(0) | <10(0) | <10(0) | |
| Coliform/E. coli | <10(0) | <10(0) | <10(0) | <10(0) | |
| CFU/mL | | | | | |

Z3 - GR

| | | | | | |
|---|---|---|---|---|---|
| LAB CFU/mL | 2.6 × 10\hat{ }6- | 6.7 × 10\hat{ }5- | 4.0 × 10\hat{ }5- | 4.1 × 10\hat{ }4- | <10(0)- |
| | 1.57 × 10\hat{ }6 | 1.71 × 10\hat{ }6 | 6.8 × 10\hat{ }5 | 8.7 × 10\hat{ }4 | <2.5 × 101 (14) |
| Bacillus CFU/ml | 3.6 × 10\hat{ }6 | 1.17 × 10\hat{ }6- | 3.1 × 10\hat{ }5- | 6.9 × 10\hat{ }4- | 4.1 × 10\hat{ }1- |
| | 6.8 × 10\hat{ }6 | 1.70 × 10\hat{ }6 | 9.5 × 10\hat{ }5 | 1.41 × 10\hat{ }5 | 1.01 × 10\hat{ }2 |
| yeast CFU/mL | <10(0) | <10(0) | <10(0) | <10(0) | <10(0) |
| Mold CFU/mL | <10(0) | <10(0) | <10(0) | <10(0) | <10(0) |
| Coliform/E. coli | <10(0) | <10(0) | <10(0) | <10(0) | <10(0) |
| CFU/mL | | | | | |

Z3 - LV

| | | | | | |
|---|---|---|---|---|---|
| LAB CFU/mL | 2.6 × 10\hat{ }6- | 7.6 × 10\hat{ }5- | 4.8 × 10\hat{ }5- | 9.1 × 10\hat{ }1- | to be tested |
| | 2.15 × 10\hat{ }6 | 1.14 × 10\hat{ }6 | 1.18 × 10\hat{ }6 | 6.5 × 10\hat{ }4 | in October |
| Bacillus CFU/ml | 4.5 × 10\hat{ }6- | 2.5 × 10\hat{ }6- | 8.4 × 10\hat{ }5- | 1.37 × 10\hat{ }2- | |
| | 9.2 × 10\hat{ }6 | 4.4 × 10\hat{ }6 | 1.26 × 10\hat{ }6 | 4.3 × 10\hat{ }4 | |
| yeast CFU/mL | <10(0) | <10(0) | <10(0) | <10(0) | |
| Mold CFU/mL | <10(0) | <10(0) | <10(0) | <10(0) | |
| Coliform/E. coli | <10(0) | <10(0) | <10(0) | <10(0) | |
| CFU/mL | | | | | |
| % TA | 0.49-0.63 | 0.53-0.65 | 0.52-0.85 | 0.50-0.92 | 2.99-3.10 |
| pH | 2.89-2.98 | 2.81-3.00 | 2.98-3.14 | 3.05-3.10 | 0.50-0.74 |
| Surface tension | 32.05-34.59 | 32.271-34.29 | 32.35-32.44 | — | — |

Surface Testing
Z1- sample

| Time (hour) | Bacillus counts (CFU/cm2) |
|---|---|
| T0 | 1.31 × 10\hat{ }3 |
| T6 | 1.04 × 10\hat{ }3 |
| T24 | 1.69 × 10\hat{ }3 |
| T48 | 1.52 × 10\hat{ }3 |
| T72 | 1.19 × 10\hat{ }3 |
| T96 | 1.91 × 10\hat{ }3 |
| T164 | 1.82 × 10\hat{ }3 |
| T192 | 1.44 × 10\hat{ }3 |

Surface Testing
Z2 - sample

| Time (hours) | Bacillus counts (CFU/cm2) |
|---|---|
| T0 | 4.39 × 10\hat{ }3 |
| T6 | 3.64 × 10\hat{ }3 |
| T24 | 3.97 × 10\hat{ }3 |
| T48 | 1.64 × 10\hat{ }3 |
| T72 | 2.20 × 10\hat{ }3 |
| T96 | 2.85 × 10\hat{ }3 |
| T164 | 4.25 × 10\hat{ }3 |
| T192 | 1.64 × 10\hat{ }3 |

### Germination Testing:

| Z1 - | Time | Germination rate | Average |
|---|---|---|---|
| Replicate | (hrs) | (%) | germination rate (%) |
| 1 | T0 | | |
| | T24 | 53.85% | |
| 2 | T0 | | |
| | T24 | 41.67% | 47.76% |

| Z-2 | Time | Germination rate | Average |
|---|---|---|---|
| Replicate | (hrs) | (%) | germination rate (%) |
| 1 | T0 | | |
| | T24 | 80.00% | |
| 2 | T0 | | |
| | T24 | 78.79% | 79.39% |

| Pathogen testing (Z1 GR and Z1 LG) | Effective (test period 48 hrs) |
|---|---|
| S. typhimurium | Yes |
| Pseudomonas aeruginosa | Yes |
| Staphylococcus aureus | Yes |

| Pathogen testing (Z2 GR and Z2 LG) | Effective (test period 48 hrs) |
|---|---|
| Escherichia coli | Yes |
| S. typhimurium | Yes |
| Pseudomonas aeruginosa | Yes |
| Staphylococcus aureus | Yes |

### Cleaning Efficacy Testing:

| Sample | Cleaning Efficiency (%) |
|---|---|
| Z1- GR | 85.51 |
| Z1- LG | 86.66 |
| Z1- LV | 87.95 |

| Sample | Cleaning Efficiency (%) |
|---|---|
| Z2- GR | 87.9 |
| Z2- LG | 87.63 |
| Z2- LV | 90.01 |

### Embodiments

In one or more embodiments, the biodegradable cleaning composition may comprise: a probiotic starting culture comprising at least one species of microbe selected from the group consisting of at least one species of lactic acid bacteria and at least one species of Bacillus; at least one carbon source, and dechlorinated water; and at least one added element selected from the group consisting of at least one essential oil, carbon source, biodetergent, organic acid, preservative, diol, polyol, polymyxin, polysaccharide-lipid complex, fatty acid, terpene, and preservative.

In one or more embodiments the at least one species of lactic acid bacteria may be selected from the group consisting of a species of Carnobacterium sp., Enterococcus sp., Lactobacillus sp., Lactococcus sp., Leuconostoc sp., Oenococcus sp. Streptococcus sp., Tetragenococcus sp., Vagococcus sp., and Weissella sp.

In one or more embodiments the at least one species of lactic acid bacteria may be selected from the group consisting of a species of Carnobacterium sp., Enterococcus sp., Lactobacillus sp., Lactococcus sp., and Streptococcus sp.

In one or more embodiments the at least one species of Bacillus may be selected from the group consisting of Bacillus licheniformis, Bacillus coagulans, and Bacillus subtilis.

In one or more embodiments the at least one species of Bacillus may be selected from the group consisting of Bacillus coagulans and Bacillus subtilis.

In one or more embodiments the at least one added element may comprise at least one essential oil selected from the group consisting of African lemon bush (Lippia javanica) oil, anise oil, bay oil, bergamot oil, boronia oil, canola oil, carrot oil, cassia oil, catnip oil, cedarwood oil, chamomile oil, cilantro oil, cinnamon oil, citronella oil, clary sage oil, clove oil, coriander oil, cypress oil, eucalyptus oil, galbanum oil, garlic oil, ginger oil, geranium oil, grapefruit oil, hazelnut oil, jasmine oil, jojoba oil, lavender oil, lavandin oil, lemon oil, lemongrass oil, lime oil, mandarin oil, nutmeg oil, orange oil, palma rosa oil, patchouli oil, pine oil, Peru balsams, peppermint oil, rosemary oil, rosewood oil, sage oil, sandalwood oil, spear mint oil, star anise oil, tea tree oil, tangerine oil, thyme oil, tolu balsam oil, verbena oil, white clover oil, and ylang ylang oil.

In one or more embodiments the at least one added element may comprise at least one essential oil selected from the group consisting of cedarwood oil, cilantro oil, cinnamon oil, citronella oil, clary sage oil, clove oil, coriander oil, cypress oil, eucalyptus oil, garlic oil, ginger oil, geranium oil, grapefruit oil, hazelnut oil, jasmine oil, lavender oil, lavandin oil, lemon oil, lemongrass oil, lime oil, mandarin oil, nutmeg oil, orange oil, palma rosa oil, patchouli oil, pine oil, peppermint oil, rosemary oil, rosewood oil, sage oil, sandalwood oil, spear mint oil, star anise oil, tea tree oil, tangerine oil, thyme oil, tolu balsam oil, verbena oil, and white clover oil.

In one or more embodiments the at least one carbon source may be selected from the group consisting of rum, molasses, glucose, starch, cellulose, fructose, sucrose, arabinose, mannose, glucosamine, maltose, silage, stover, chaff, grass, stalks, leaves, flour, syrup, protein, fat, fatty acids, acetic acid, fumaric acid, adipic acid, propionic acid, citric acid, gluconic acid, malic acid, methylmaleic acid, pyruvic acid, malonic acid, carbohydrates, peptone, yeast extract, amino acids, ethanol, glycerol, glycerol trilaurate, soybean oil, rice bran oil, olive oil, corn oil, and sesame oil.

In one or more embodiments the at least one carbon source may be selected from the group consisting of rum, molasses, glucose, starch, cellulose, fructose, sucrose, arabinose, mannose, and maltose.

In one or more embodiments the at least one added element may comprise at least one biodetergent selected from the group consisting of surfactin, iturin, fengycin, arthrofactin, emulsan.

In one or more embodiments the at least one added element may be a biodetergent produced by at least one species of microbe selected from the group consisting of Bacillus sp., Bacillus atrophaeus, Bacillus licheniformis, Bacillus subtilis, Bacillus siamensis, Bacillus thuringiensis, Bacillus pumilus, Bacillus cereus, Torulopsis sp., Pseudomonas sp., Rhodococcus sp., Candida sp., Candida bogoriensis, Acinetobacter sp., Corynebacterium lepus, Candida petrophilum, Candida tropicalis, Corynebacterium hydrocarboclastus, Flavobacterium sp., Achromobacter sp., Arthrobacter sp., Micrococcus sp., and Paenibacillus sp.

In one or more embodiments the at least one added element may comprise at least one organic acid selected from the group consisting of acetic acid, adipic acid, azelaic acid, carboxylic acid, dihydroxy benzoic acid, 2,3-dihydroxy benzoic acid, tricarboxylic acid(s), propane-1, 2, 3-tricarboxylic acid, citric acid, homo citric acid, isocitric acid, itaconic acid, gluconic acid, glycolic acid, lactic acid, malic acid, methylmaleic acid, propionic acid, pyruvic acid, succinic acid, sebacic acid, tartaric acid, and uric acid.

In one or more embodiments the at least one added element may comprise at least one organic acid selected from the group consisting of acetic acid, adipic acid, azelaic acid, carboxylic acid, benzoic acid, homo citric acid, isocitric acid, itaconic acid, gluconic acid, glycolic acid, lactic acid, malic acid, methylmaleic acid, propionic acid, pyruvic acid, succinic acid, sebacic acid, tartaric acid, and uric acid.

In one or more embodiments the at least one added element may comprise at least one diol selected from the group consisting of 1,2-propanediol (propylene glycol), 2,2-propanediol, 1,1-propanediol, 1,3-propanediol, butane diol(s), 1,4-butanediol, ethylene glycol, geminal diols, vicinal diols, 1,3-diols, 1,4-diols, 1,5-diols, longer than 1,5-diols, 5-(1-Hydroxy-1-methylethyl)-2-methyl-2-cyclohexene-1,4-diol, and aliphatic diols.

In one or more embodiments the at least one added element may comprise at least one polyol selected from the group consisting of polyethylene glycol, glycerol, glycerol trilaurate, erythritol, threitol, arabitol, D-(+)-arabitol, L-(−)-arabitol, xylitol, ribitol, mannitol, D-mannitol, sorbitol, glucitol, D-glucitol, galactitol, fucitol, iditol, inositol, volemitol, isomalt, maltitol, lactitol, maltotriitol, maltotetraitol, and polyglycitol.

In one or more embodiments the at least one added element may comprise at least one polymyxin may be selected from the group consisting of polymyxin A, polymyxin B, polymyxin B1, polymyxin B nonapeptide, polymyxin C, polymyxin D, and polymyxin E (colistin), and other cationic cyclic decapeptides.

In one or more embodiments the at least one added element may comprise at least one polysaccharide-lipid complex selected from the group consisting of a lipopolysaccharide, lipooligosaccharide, or endotoxins produced by a microbe of the group comprising but not limited to E. coli O26, E. coli EH-100, E. coli 0111, E. coli 055, E. coli 0127, E. coli 0128, E. coli F-583, E. coli J5, E. coli K-235, Pseudomonas aeroginosa 10, Salmonella, Salmonella enteritidis, Salmonella minnesota, Salmonella minnesota strain Re595, Salmonella typhimurium, Salmonella typhimurium strain SL1181, Salmonella typhimurium strain TV119, Salmonella typhosa, and Serratia marcescens.

In one or more embodiments the at least one added element may comprise at least one fatty acid selected from the group consisting of formic acid, acetic acid, propionic acid, butyric acid, isobutyric acid, valeric acid, isovaleric acid, caproic acid, enanthic acid, caprylic acid, pelargonic acid, capric acid, undecylic acid, lauric acid, tridecylic acid, myristic acid, pentadecanoic acid, palmitic acid, margaric acid, stearic acid, nonadecylic acid, arachidic acid, heneicosylic acid, behenic acid, tricosylic acid, lignoceric acid, pentacosylic acid, cerotic acid, heptacosylic acid, montanic acid, nonacosylic acid, melissic acid, hentriacontylic acid, lacceroic acid, psyllic acid, geddic acid, ceroplastic acid, hexatriacontylic acid, heptatriacontanoic acid, octatriacontanoic acid, nonatriacontanoic acid, tetracontanoic acid, octanoic acid, decanoic acid, decadienoic acid, eicosatrienoic acid, hexadecatrienoic acid, lauroleic acid, laurolinoleic acid, myristovaccenic acid, myristolinoleic acid, myristolinolenic acid, palmitolinolenic acid, palmitidonic acid, α-linolenic acid, stearidonic acid, dihomo-α-linolenic acid, eicosatrienoic acid, eicosatetraeonic acid, eicosapentaenoic acid, heneicosapentaenoic acid, clupanodonic acid, docosahexaenoic acid, docosapentaenoic acid tetracosapentaenoic acid, tetracosahexaenoic acid, myristoleic acid, palmitovaccenic acid, α-eleostearic acid, β-eleostearic acid, punicic acid, 7,10,13-octadecatrienoic acid, 9,12,15-eicosatrienoic acid, and β-eicosatetraenoic acid, 8-tetradecenoic acid, 12-octadecenoic acid, linoleic acid, linolelaidic acid, gamma-linolenic acid, calendic acid, eicosadienoic acid, pinolenic acid, dihomo-linoleic acid, dihomo-gamma-linolenic acid, docosadienoic acid, arachidonic acid, tetracosatetraenoic acid, tetracosapentaenoic acid, adrenic acid, and osbond acid, palmitoleic acid, vaccenic acid, 11-octadecanoic acid, cis-vaccenic acid, rumenic acid, paullinic acid, 5-dodecenoic acid, 7-tetradecenoic acid, 7,10,13-eicosatrienoic acid, 15-docosenoic acid, 17-tetracosenoic acid, oleic acid, elaidic acid, gondoic acid, erucic acid, nervonic acid, 8,11-eicosadienoic acid, ximenic acid, mead acid, sapienic acid, gadoleic acid, 4-hexadecenoic acid, petroselinic acid, and 8-eicosenoic acid.

In one or more embodiments the at least one added element may comprise at least one terpene selected from the group consisting of 3-carene, ascaridole, bornane, borneol, camphene, camphor, camphorquinone, carvacrol, carveol, carvone, carvonic acid, chrysanthemic acid, chrysanthenone, citral, a-citral, b-citral, citronellal, citronellol, cuminaldehyde, p-cymene, cymenes, epomediol, eucalyptol, 1,8-cineole (11, eucalyptol), 2,3-dehydro-1,8-cineole, fenchol, fenchone, geranic acid, geraniol, geranyl acetate, geranyl pyrophosphate, grandisol, grapefruit mercaptan, halomon, hinokitiol, hydroxycitronellal, 8-hydroxygeraniol, incarvillateine, (s)-ipsdienol, jasmolone, lavandulol, lavandulol acetate, lavandulyl acetate, levoverbenone, limonene, linalool, 6,7-dihydro-7-hydroxylinalool, linalyl acetate, lineatin, p-menthane-3,8-diol, menthofuran, menthol, menthone, menthoxypropanediol, menthyl acetate, 2,6-octadien-1-ol, 3,7-dimethyl-, acetate, 2-methylisoborneol, myrcene, myrcenol, nerol, neryl alcohol, nerol, neryl alcoholic acid, ocimene, 8-oxogeranial, paramenthane hydroperoxide, perilla ketone, perillaldehyde, perillartine, perillene, phellandrene, α-phellandrene, α-phellandrene-8-ol, β-phellandrene, picrocrocin, pinene, alpha-pinene, beta-pinene, piperitone, pulegone, rhodinol, rose oxide, sabinene, safranal, sobrerol, terpinen-4-ol, terpinene, terpineol or a-terpineol, thujaplicin, thujene, thujone, thymol, thymoquinone, umbellulone, verbenol, verbenone, wine lactone, abscisic acid, amorpha-4,11-diene, aristolochene, artemether, artemotil, artesunate, bergamotene, bisabolene, bisabolol, bisacurone, botrydial, cadalene, cadinene, y-cadinene, cadina-1,4 diene, cadina-1(10),4-diene, alpha-cadinol, delta-cadinol, capnellene, capsidiol, carotol, caryophyllene, b-caryophyllene, caryphyllene oxide, cedrene, cedrol, copaene, cubebene, cubebol, curdione, curzerene, curzerenone, dictyophorine, drimane, elemene, farnesene, farnesol, farnesyl pyrophosphate, germacrene, germacrone, guaiazulene, guaiene, guaiol, gyrinal, hernandulcin, humulene, indometacin farnesyl, ionone, isocomene, juvabione, khusimol, koningic acid, ledol, longifolene, matricin, mutisianthol, nardosinone, nerol, neryl alcoholidol, nootkatone, norpatchoulenol, onchidal, patchoulol, periplanone b, petasin, phaseic acid, polygodial, rishitin, α-santalol, β-santalol, santonic acid, selinene, spathulenol, thujopsene, tripfordine, triptofordin c-2, valencene, velleral, verrucarin a, vetivazulene, α-vetivone, and zingiberene.

In one or more embodiments the at least one added element may comprise at least one preservative selected from the group consisting of potassium sorbate, calcium sorbate, calcium ascorbate, sodium sorbate, sodium ascorbate, sodium erythorbate, sodium benzoate, sodium sulfite, sodium bisulfite, sodium metabisulfite, sodium nitrite, sodium nitrate, sodium iso-ascorbate, potassium ascorbate, potassium acetate, potassium benzoate, potassium bisulphite, potassium nitrate, potassium nitrite, potassium bisulfite, potassium metabisulfite, potassium diacetate, potassium lactate, butylated hydroxyanisole (BHA), butylated hydroxytolu balsam oilene (BHT), disodium ethylenediaminetetraacetic acid (EDTA), citric acid, sulphur dioxide, propyl paraben, methyl paraben, benzene, acetic acid, tocopherol, ascorbic acid, erythorbic acid, iso-ascorbic acid, benzoic acid, wood smoke, ethyl lauroyl arginate, 4-hexylresorcinol, methyl-ρ-hydroxy benzoate, nisin, propionic acid, propyl-ρ-hydroxy benzoate, sorbic acid, natamycin, and dimethyl decarbonate.

In one or more embodiments the at least one preservative may be present in a ratio of from about 0.1-0.3 wt/wt %.

One or more embodiments of the biodegradable cleaning composition may further comprise at least one second additional element selected from the group consisting of cyclohexene, 3-acetoxy-4-(1-hydroxy-1-methylethyl)-1-methyl, cycloehexane, 2-furaldehyde (furfural), sulcatone, 4-nonanone, tagalose, D-(−)-tagalose, D-(+)-tagalose, mannopyranose, b-D-(+)-mannopyranose, b-D-(−)-mannopyranose, sulctone, 2,3-dehydro-1,8-cineole, a-phellandren-8-ol, 2,6-octadien-1-ol, 3,7-dimethyl-acetate, caryophyllene, g-cadinene, cadina-1(10),4-diene, carophyllene oxide, pentasiloxane, and [(2-Ethyl-5-methylfuran-3,4-diyl)bis(oxy)]bis(trimethylsilane).

In one or more embodiments the biodegradable cleaning composition may have a surface tension between about 20 dyne/cm and about 38 dyne/cm.

In one or more embodiments the biodegradable cleaning composition may comprise about 80 to about 85 wt/wt % dechlorinated water.

In one or more embodiments the biodegradable cleaning composition may comprise about 90 to about 95 wt/wt % dechlorinated water.

An embodiment comprising a kit comprising a textile treated with an application of the biodegradable cleaning composition of any one of claims 1-16, wherein the application may be performed according to a ratio, and wherein said textile may be contained within an openable container.

An embodiment comprising a kit wherein the ratio may be from about 5 ml per textile sheet to about 15 ml per textile sheet.

An embodiment comprising a kit wherein the textile may be selected from the group consisting of lyocell, rayon, cotton polyester, and polypropylene.

An embodiment comprising a method of manufacturing a biodegradable cleaning composition comprising the steps of:
obtaining a probiotic starting culture comprising at least one species of microbe selected from the group consisting of at least one species of lactic acid bacteria and at least one Bacillus species; at least one organic acid; at least one carbon source; and dechlorinated water;
beginning a fermentation period, wherein the probiotic starting culture may be fermented in at least one fermentation tank for at least one fermentation period;
adding at least one additional element selected from the group consisting of at least one essential oil, carbon source, biodetergent, organic acid, preservative, diol, polyol, polymyxin, polysaccharide-lipid complex, fatty acid, terpene, and preservative.
allowing the probiotic starting culture and the at least one additional element to ferment into a fermented product;
ending the fermentation period;
decanting the fermented product; and
extracting the biodegradable cleaning composition.

An embodiment comprising a method, wherein a decanting step may be performed using a solid-liquid separation centrifuge operating at 22,000-23,000 revolutions per minute.

An embodiment comprising a method, wherein a decanting step further comprises passing the fermented product into the centrifuge at a material feed rate of 150 cc/minute.

An embodiment comprising a method, wherein the decanting step further comprises passing the fermented product through a 30-micron filter one or more times.

An embodiment of the biodegradable cleaning composition produced by an embodiment comprising a method, including any modifications thereof, such as but not limited to modifications of said method comprising modifications to a decanting step.

One or more embodiments of the biodegradable cleaning composition may be comprised according to FIG. 1.

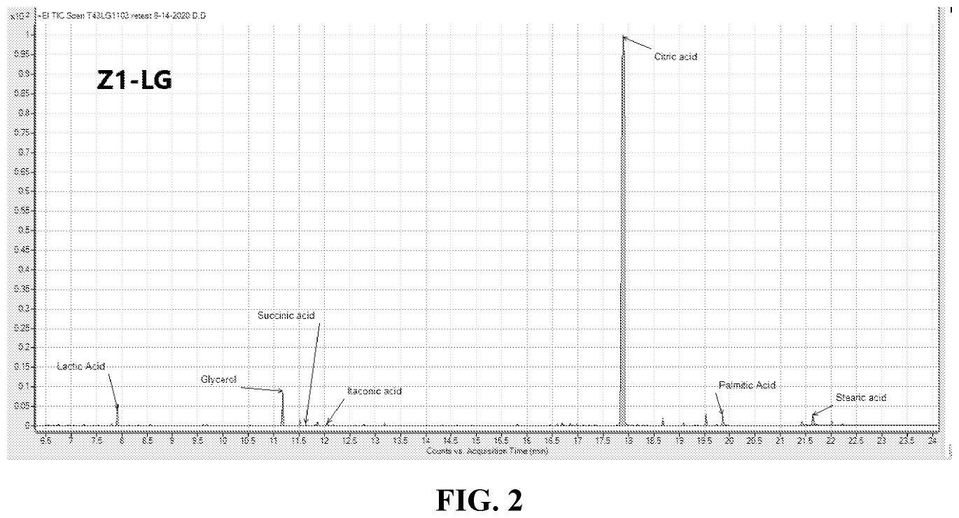

One or more embodiments of the biodegradable cleaning composition may be comprised according to FIG. 2.

One or more embodiments of the biodegradable cleaning composition may be comprised according to FIG. 3.

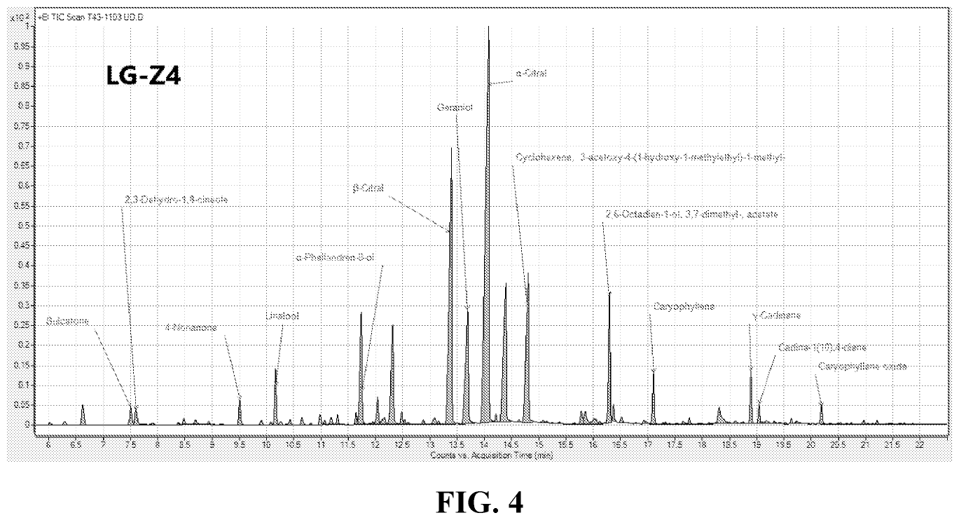

One or more embodiments of the biodegradable cleaning composition may be comprised according to FIG. 4.

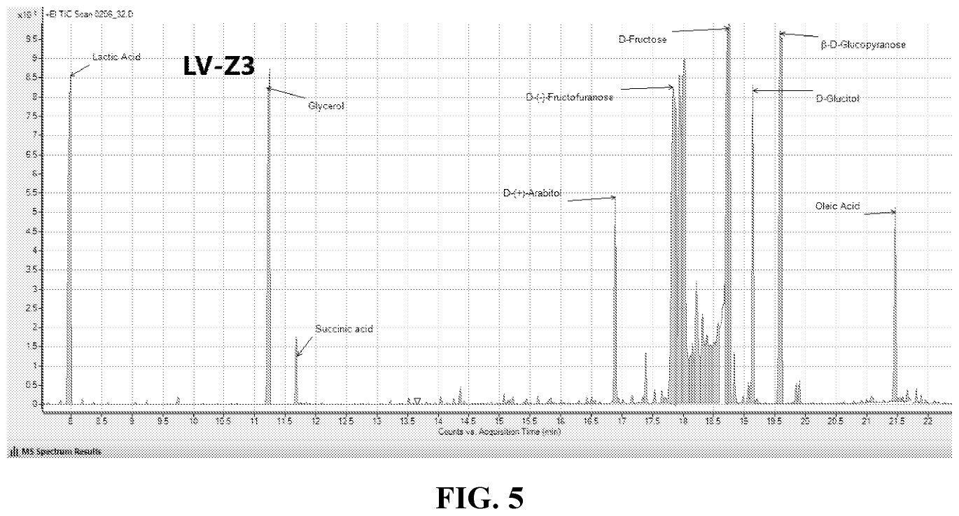

One or more embodiments of the biodegradable cleaning composition may be comprised according to FIG. 5.

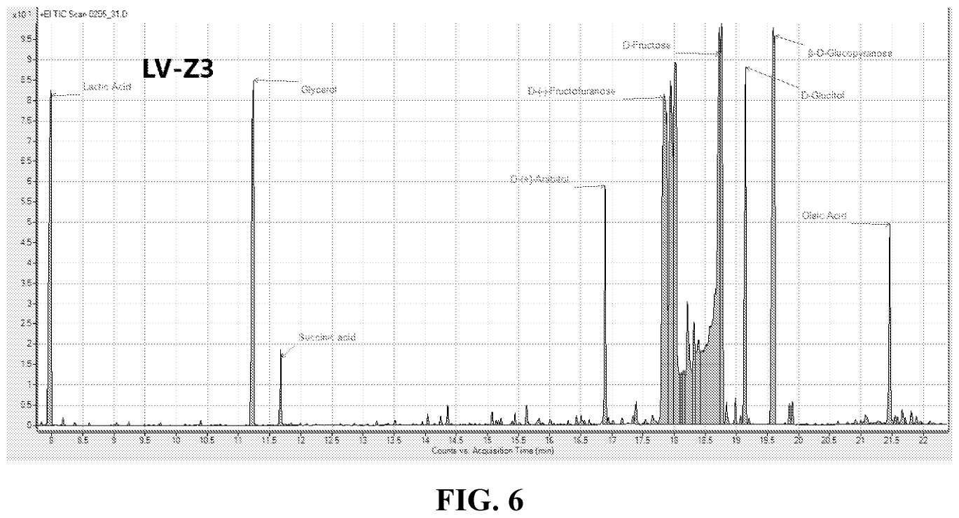

One or more embodiments of the biodegradable cleaning composition may be comprised according to FIG. 6.

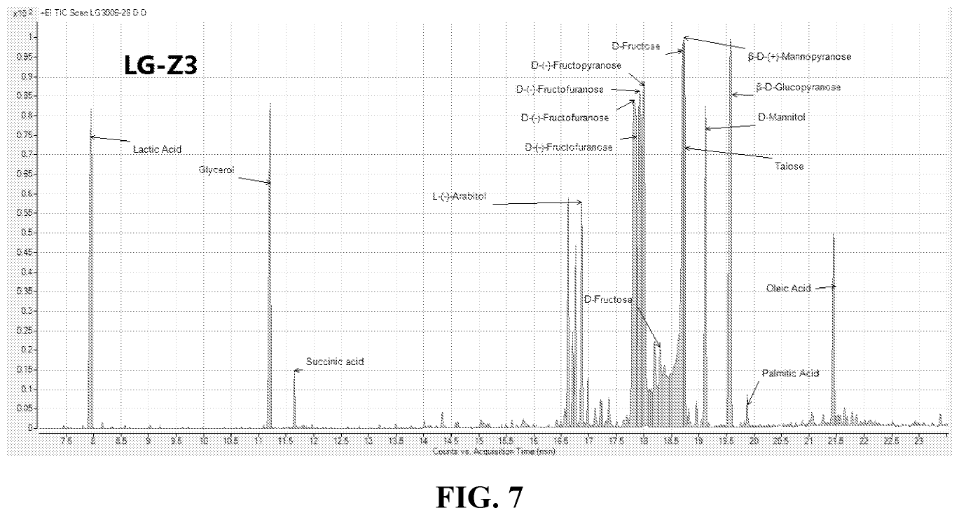

One or more embodiments of the biodegradable cleaning composition may be comprised according to FIG. 7.

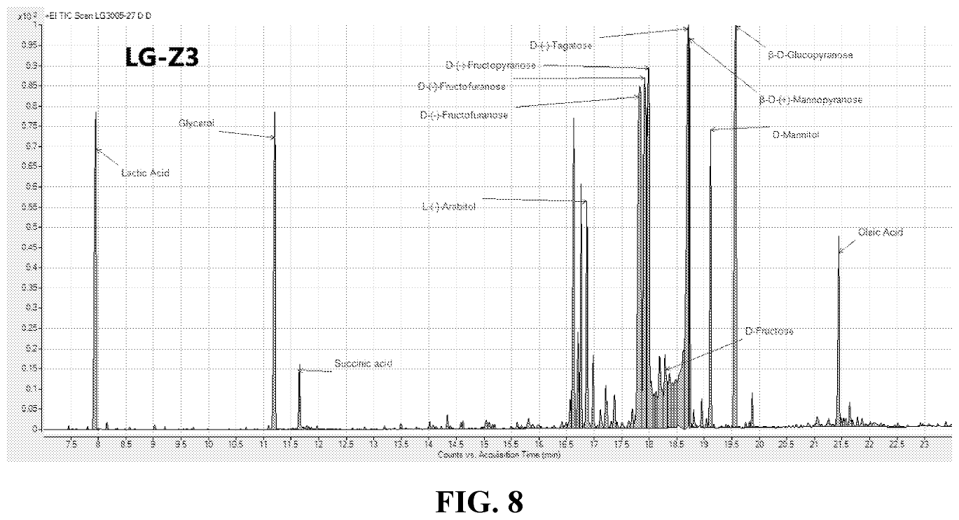

One or more embodiments of the biodegradable cleaning composition may be comprised according to FIG. 8.

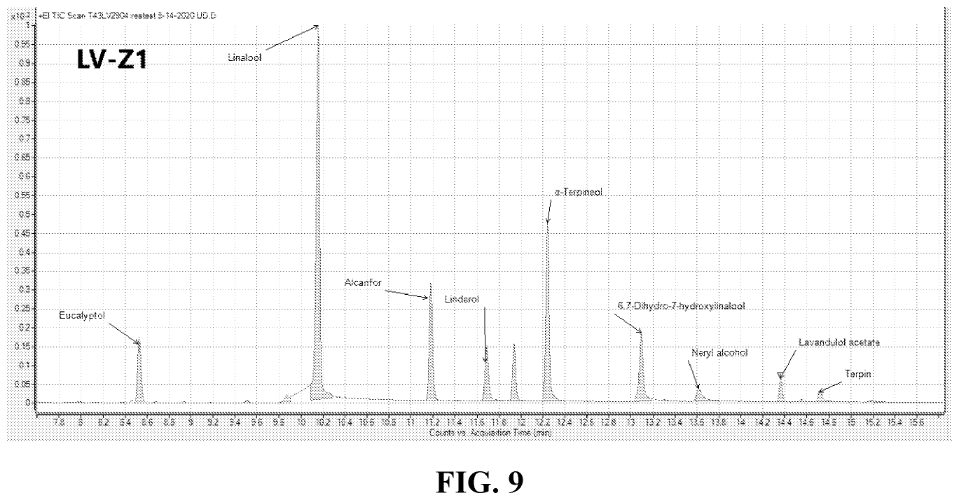

One or more embodiments of the biodegradable cleaning composition may be comprised according to FIG. 9.

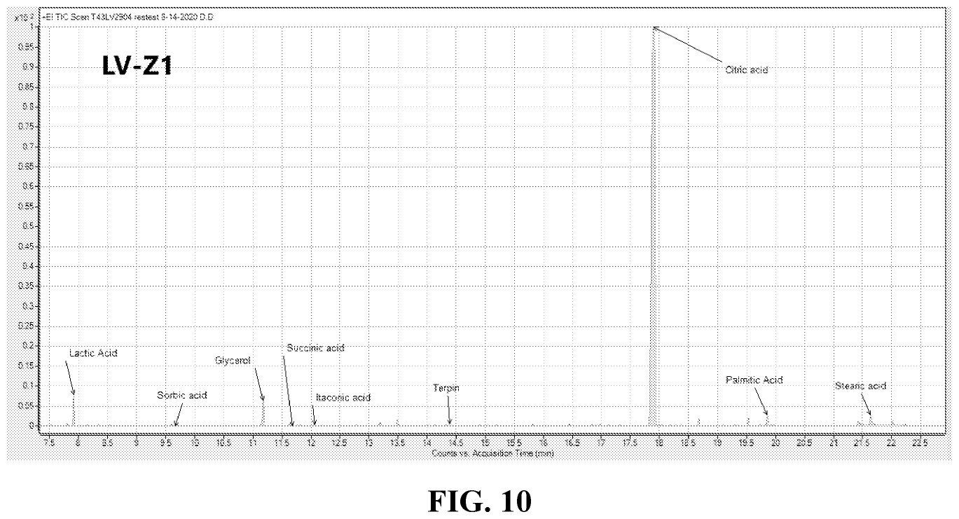

One or more embodiments of the biodegradable cleaning composition may be comprised according to FIG. 10.

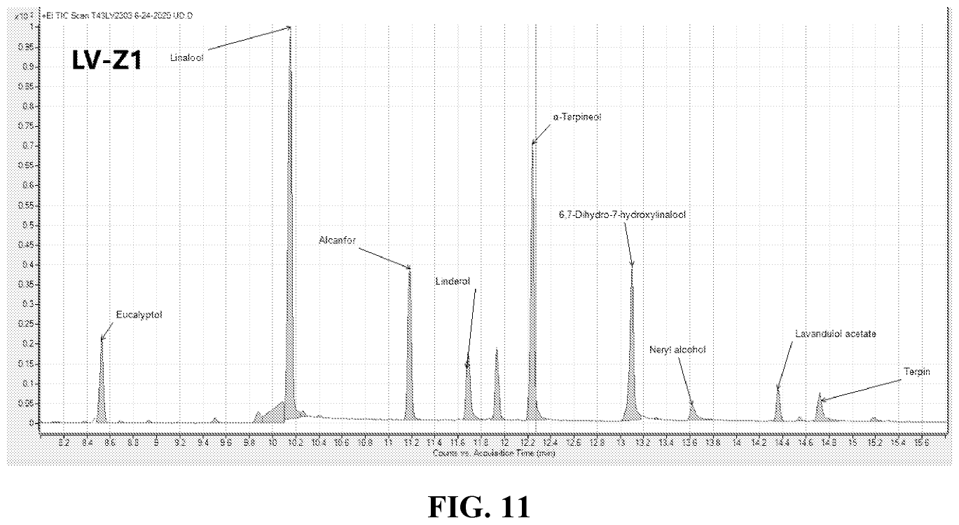

One or more embodiments of the biodegradable cleaning composition may be comprised according to FIG. 11.

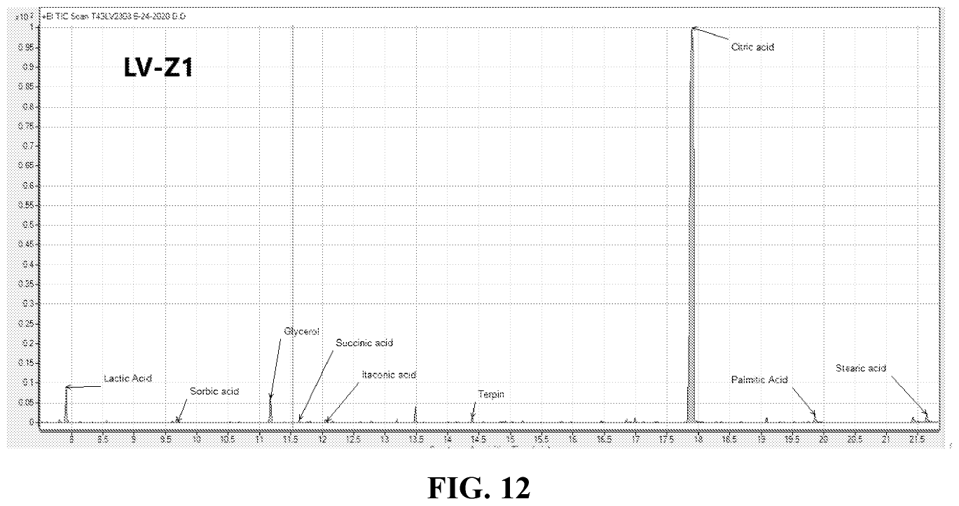

One or more embodiments of the biodegradable cleaning composition may be comprised according to FIG. 12.

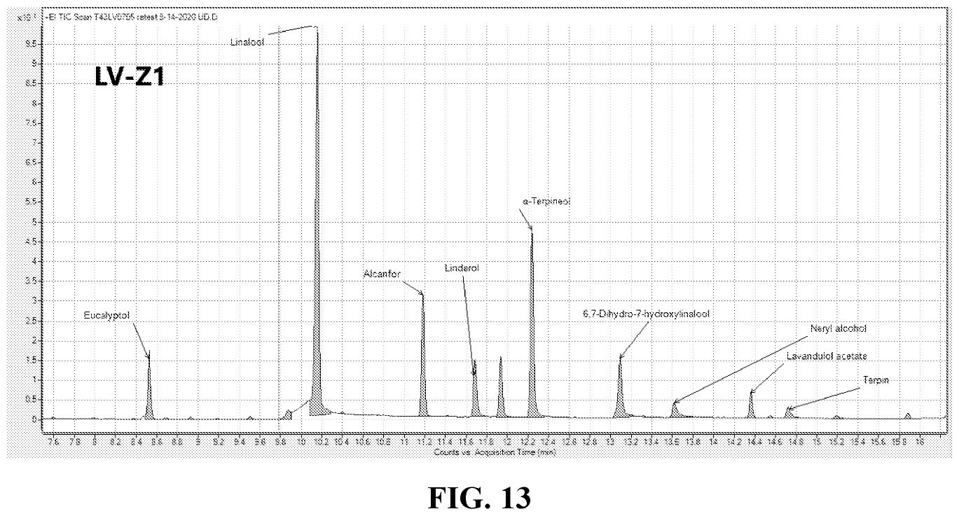

One or more embodiments of the biodegradable cleaning composition may be comprised according to FIG. 13.

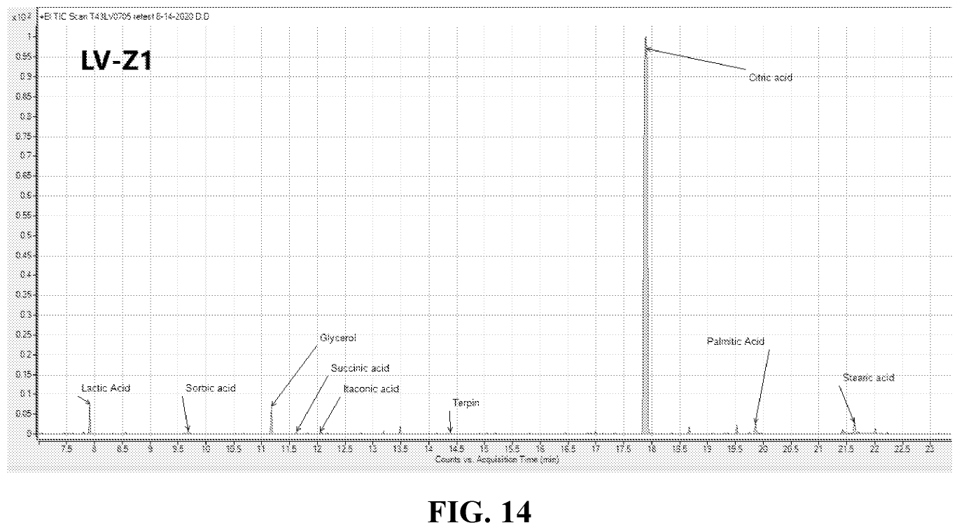

One or more embodiments of the biodegradable cleaning composition may be comprised according to FIG. 14.

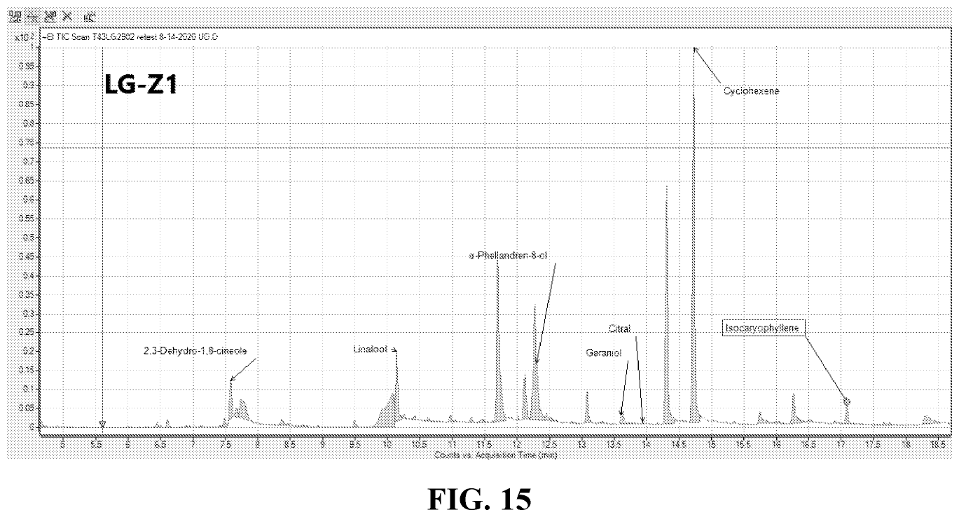

One or more embodiments of the biodegradable cleaning composition may be comprised according to FIG. 15.

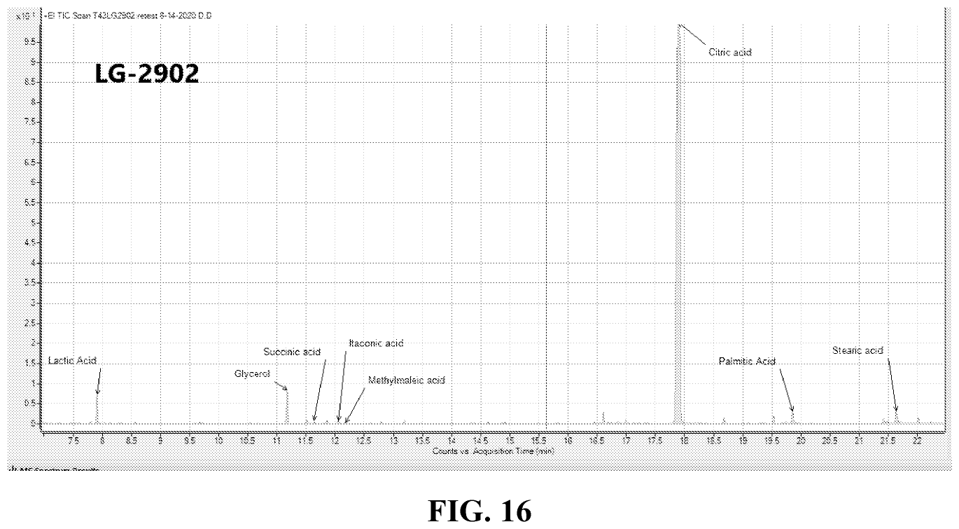

One or more embodiments of the biodegradable cleaning composition may be comprised according to FIG. 16.

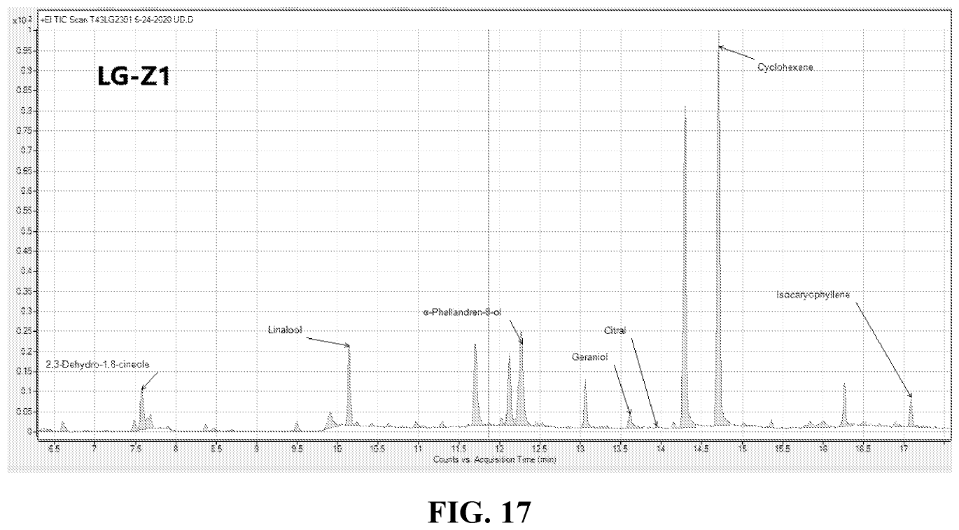

One or more embodiments of the biodegradable cleaning composition may be comprised according to FIG. 17.

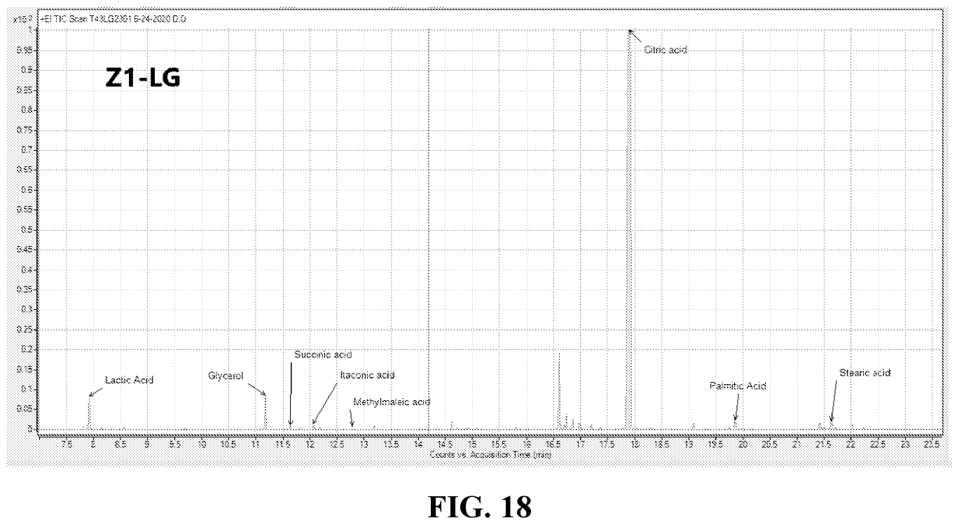

One or more embodiments of the biodegradable cleaning composition may be comprised according to FIG. 18.

In one or more embodiments, a biodegradable cleaning composition may comprise (i) purified water; (ii) a co-culture of lactic acid bacteria comprising two or more species of lactic acid bacteria; (iii) lactic acid; and (iv) at least one organic essential oil.

In one or more embodiments, a biodegradable cleaning composition may comprise (i) purified water; (ii) a co-culture comprising one or more species of lactic acid bacteria and one or more species of Bacillus; (iii) lactic acid; and (iv) at least one organic essential oil.

In one or more embodiments, the at least one organic essential oil may comprise geranium.

In one or more embodiments, the at least one organic essential oil may comprise lemongrass oil.

In one or more embodiments, the at least one organic essential oil may comprise lavender oil.

In one or more embodiments, the biodegradable cleaning composition may be formulated for use as an all-purpose cleaning solution.

In one or more embodiments, the biodegradable cleaning composition may be formulated for use as an air freshening solution.

In one or more embodiments, the biodegradable cleaning composition may be formulated for use as an air-and-fabric freshening solution.

In one or more embodiments, the biodegradable cleaning composition may be formulated for use as a floor cleaning solution.

In one or more embodiments, the biodegradable cleaning composition may be formulated for use as a floor cleaning concentrate solution.

In one or more embodiments, a biodegradable cleaning composition may comprise a co-culture comprising at least one species of microbe; at least one organic acid; at least one carbon source; and dechlorinated water.

In one or more embodiments, the biodegradable cleaning composition may be decanted prior to administration, wherein said decanting is performed using a solid-liquid separation centrifuge.

In one or more embodiments, the at least one species of microbe may be selected from the group consisting of one or more species of lactic acid bacteria and one or more species of Bacillus.

In one or more embodiments, the at least one organic acid may comprise at least one organic acid.

In one or more embodiments, the at least one organic acid may comprise at least one fatty acid.

In one or more embodiments, the at least one fatty acid may comprise an unsaturated fatty acid.

In one or more embodiments, the at least one fatty acid may comprise a saturated fatty acid.

In one or more embodiments, the biodegradable cleaning composition may further comprise at least one polyol.

In one or more embodiments, the biodegradable cleaning composition may further comprise at least one diol.

In one or more embodiments, the biodegradable cleaning composition may further comprise at least one polyethylene glycol.

In one or more embodiments, the biodegradable cleaning composition may further comprise at least one polysaccharide-lipid complex.

In one or more embodiments, the biodegradable cleaning composition may further comprise at least one monoterpene.

In one or more embodiments, the biodegradable cleaning composition may further comprise at least one sesquiterpene.

In one or more embodiments, the biodegradable cleaning composition may further comprise at least one essential oil.

In one or more embodiments, the biodegradable cleaning composition may further comprise at least one polymyxin;

In one or more embodiments, the biodegradable cleaning composition may further comprise at least one biodetergent.

In one or more embodiments, a biodegradable cleaning composition may comprise at least one species of microbe selected from the group consisting of lactic acid bacteria and Bacillus; at least one carboxylic acid; at least one carbon source; dechlorinated water; and one or more added element, wherein the added element is selected from the group comprising at least one polyol, at least one diol, at least one polyethylene glycol, at least one polysaccharide-lipid complex, at least one monoterpene, at least one sesquiterpene, at least one essential oil, at least one polymyxin, and at least one biodetergent.

In one or more embodiments, a biodegradable cleaning composition may comprise at least one species of microbe selected from the group consisting of lactic acid bacteria and Bacillus; at least one carboxylic acid; at least one carbon source; dechlorinated water; at least one polyol, at least one diol, at least one polyethylene glycol, at least one polysaccharide-lipid complex, at least one monoterpene, at least one sesquiterpene, at least one essential oil, at least one polymyxin, and at least one biodetergent.

In one or more embodiments, a biodegradable cleaning composition may comprise

In one or more embodiments, the at least one species of lactic acid bacteria is selected from the group consisting of a species of Carnobacterium sp. Enterococcus sp. Lactobacillus sp. Lactococcus sp. Leuconostoc sp. Oenococcus sp. Streptococcus sp. Tetragenococcus sp. Vagococcus sp. and Weissella sp.

In one or more embodiments, the at least one species of Bacillus is selected from the group consisting of Bacillus cereus, Bacillus thuringiensis, Bacillus weihenstephanensis, Bacillus licheniformis, Bacillus pumilus, Bacillus mycoides, Bacillus coagulans, Bacillus megaterium, and Bacillus subtilis.

In one or more embodiments, the at least one organic acid is selected from the group consisting of acetic acid, adipic acid, azelaic acid, carboxylic acid, benzoic acid, dihydroxy benzoic acid, 2,3-benzoic acid, dihydroxy benzoic acid, tricarboxylic acid(s), propane-1, 2, 3-tricarboxylic acid, citric acid, homo citric acid, isocitric acid, itaconic acid, gluconic acid, glycolic acid, lactic acid, malic acid, methylmaleic acid, propionic acid, pyruvic acid, succinic acid, sebacic acid, tartaric acid, and uric acid.

In some embodiments, the at least one unsaturated fatty acid may be present at a molar concentration of 0.1M to 1M.

In some embodiments, the at least one saturated fatty acid may be present at a molar concentration of 0.1M to 1M.

In some embodiments, the at least one unsaturated fatty acid is selected from the group consisting of (i) Omega-3 unsaturated fatty acids, including but not limited to octanoic acid, decanoic acid, decadienoic acid, eicosatrienoic acid, hexadecatrienoic acid, lauroleic acid, laurolinoleic acid, myristovaccenic acid, myristolinoleic acid, myristolinolenic acid, palmitolinolenic acid, palmitidonic acid, α-linolenic acid, stearidonic acid, dihomo-α-linolenic acid, eicosatrienoic acid, eicosatetraeonic acid, eicosapentaenoic acid, heneicosapentaenoic acid, clupanodonic acid, docosahexaenoic acid, docosapentaenoic acid tetracosapentaenoic acid, and tetracosahexaenoic acid; (ii) Omega-5 unsaturated fatty acids, including but not limited to myristoleic acid, palmitovaccenic acid, α-eleostearic acid, β-eleostearic acid, punicic acid, 7,10,13-octadecatrienoic acid, 9,12,15-eicosatrienoic acid, and β-eicosatetraenoic acid; (iii) Omega-6 unsaturated fatty acids, including but not limited to 8-tetradecenoic acid, 12-octadecenoic acid, linoleic acid, linolelaidic acid, gamma-linolenic acid, calendic acid, eicosadienoic acid, pinolenic acid, dihomo-linoleic acid, dihomo-gamma-linolenic acid, docosadienoic acid, arachidonic acid, tetracosatetraenoic acid, tetracosapentaenoic acid, adrenic acid, and osbond acid; (iv) Omega-7 unsaturated fatty acids, including but not limited to palmitoleic acid, vaccenic acid, 11-octadecanoic acid, cis-vaccenic acid, rumenic acid, paullinic acid, 5-dodecenoic acid, 7-tetradecenoic acid, 7,10,13-eicosatrienoic acid, 15-docosenoic acid, and 17-tetracosenoic acid; (v) Omega-9 unsaturated fatty acids, including but not limited to oleic acid, elaidic acid, gondoic acid, erucic acid, nervonic acid, 8,11-eicosadienoic acid, ximenic acid, and mead acid; (vi) Omega-10 unsaturated fatty acids, including but not limited to sapienic acid; (vii) Omega-11 unsaturated fatty acids, including but not limited to gadoleic acid; and (viii) Omega-12 unsaturated fatty acids, including but not limited to 4-hexadecenoic acid, petroselinic acid, and 8-eicosenoic acid.

In some embodiments, the saturated fatty acid is selected from the group consisting of formic acid, acetic acid, propionic acid, butyric acid, isobutyric acid, valeric acid, isovaleric acid, caproic acid, enanthic acid, caprylic acid, pelargonic acid, capric acid, undecylic acid, lauric acid, tridecylic acid, myristic acid, pentadecanoic acid, palmitic acid, margaric acid, stearic acid, nonadecylic acid, arachidic acid, heneicosylic acid, behenic acid, tricosylic acid, lignoceric acid, pentacosylic acid, cerotic acid, heptacosylic acid, montanic acid, nonacosylic acid, melissic acid, hentriacontylic acid, lacceroic acid, psyllic acid, geddic acid, ceroplastic acid, hexatriacontylic acid, heptatriacontanoic acid, octatriacontanoic acid, nonatriacontanoic acid, and tetracontanoic acid.

In one or more embodiments, the at least one polyol is selected from the group consisting of ethylene glycol, glycerol, glycerol trilaurate, erythritol, threitol, arabitol, D-(+)-arabitol, L-(−)-arabitol, xylitol, ribitol, mannitol, D-mannitol, sorbitol, glucitol, D-glucitol, galactitol, fucitol, iditol, inositol, volemitol, isomalt, maltitol, lactitol, maltotriitol, maltotetraitol, and polyglycitol.

In one or more embodiments, the at least one diol is selected from the group consisting of 1,2-propanediol (propylene glycol), 2,2-propanediol, 1,1-propanediol, 1,3-propanediol, butane diol(s), 1,4-butanediol, ethylene glycol, geminal diols, vicinal diols, 1,3-diols, 1,4-diols, 1,5-diols, longer than 1,5-diols, 5-(1-Hydroxy-1-methylethyl)-2-methyl-2-cyclohexene-1,4-diol, and aliphatic diols.

In one or more embodiments, the at least one polyethylene glycol is selected from the group consisting of monofunctional PEGs, homobifunctional PEGs, heterobifunctional PEGs, linear PEGs, multi-arm PEGs, Y-shaped PEGs, low molecular weight PEGs (less than 5 kDa), PEGs of less than 40 kDa, PEGs greater than 40 kDa, poly(ethylene glycol), polyethylene glycol 40, polyethylene glycol 200, polyethylene glycol 300, polyethylene glycol 400, polyethylene glycol 600, polyethylene glycol 1000, polyethylene glycol 1500, polyethylene glycol 3000, polyethylene glycol 3500, polyethylene glycol 4000, polyethylene glycol 6000, polyethylene glycol 8000, poly(ethylene glycol) bis(amine), poly(ethylene glycol) bisazide, poly(ethylene glycol) bis(carboxymethyl) ether, poly(ethylene glycol) diacrylate, poly(ethylene glycol) diamine, poly(ethylene glycol) dibenzoate, poly(ethylene glycol) diglycidyl ether, poly(ethylene glycol) dimethacrylate, poly(ethylene glycol) dimethyl ether, poly(ethylene glycol) dithiol, poly(ethylene glycol) methacrylate, poly(ethylene glycol) methyl ether, poly(ethylene glycol) methyl ether methacrylate, poly(ethylene glycol) monolaurate, poly(ethylene glycol) monooleate, poly(ethylene glycol) sorbitol, glucitol, D-glucitol hexaoleate, and poly(ethylene glycol) tetrahydrofurfuryl ether.

In one or more embodiments, the at least one polysaccharide-lipid complex may comprise lipopolysaccharides, lipooligosaccharides, and endotoxins produced by the group comprising but not limited to E. coli O26, E. coli EH-100, E. coli 0111, E. coli 055, E. coli 0127, E. coli 0128, E. coli F-583, E. coli J5, E. coli K-235, Pseudomonas aeroginosa 10, Salmonella, Salmonella enteritidis, Salmonella minnesota, Salmonella minnesota strain Re595, Salmonella typhimurium, Salmonella typhimurium strain SL1181, Salmonella typhimurium strain TV119, Salmonella typhosa, and Serratia marcescens.

In some embodiments, the biodegradable cleaning composition may further comprise at least one diterpenes, sesterterpenes triterpenes, sesquarterpenes, tetraterpenes, polyterpenes, norisoprenoids or ursane-type triterpenes.

In some embodiments, the biodegradable cleaning composition may further comprise at least one terpene may be selected from the group consisting of proisoprene, prenol, isovaleric acid, geraniol, terpineol or a-terpineol, limonene, myrcene, linalool, 6,7-dihydro-7-hydroxylinalool, pinene, iridoids, humulene, farnesenes, farnesol, cafestol, kahweol, cembrene, taxadiene, terpin, geranylfarnesol, lanosterol, cycloartenol, ferrugicadiol, tetraprenylcurcumene, lycopene, gamma-carotene, any alpha-carotene or beta-carotene, gutta-percha, 3-oxo-α-ionol, 7,8-dihydroionone, megastigmane-3,9-diol, 3-oxo-7,8-dihydro-α-ionol, citronellal, and alcanfor/camphor, or a terpene derivative such as linderol or borneol.

In some embodiments, the at least one monoterpene may be selected from the group consisting of 3-carene, ascaridole, bornane, borneol, camphene, camphor/alcanfor, camphorquinone, carvacrol, carveol, carvone, carvonic acid, chrysanthemic acid, chrysanthenone, citral, a-citral, b-citral, citronellal, citronellol, cuminaldehyde, p-cymene, cymenes, epomediol, eucalyptol, 1,8-cineole (11, eucalyptol), 2,3-dehydro-1,8-cineole, fenchol, fenchone, geranic acid, geraniol, geranyl acetate, geranyl pyrophosphate, grandisol, grapefruit mercaptan, halomon, hinokitiol, hydroxycitronellal, 8-hydroxygeraniol, incarvillateine, (s)-ipsdienol, jasmolone, lavandulol, lavandulol acetate, lavandulyl acetate, levoverbenone, limonene, linalool, 6,7-dihydro-7-hydroxylinalool, linalyl acetate, lineatin, p-menthane-3,8-diol, menthofuran, menthol, menthone, menthoxypropanediol, menthyl acetate, 2,6-octadien-1-ol, 3,7-dimethyl-, acetate, 2-methylisoborneol, myrcene, myrcenol, nerol, neryl alcohol, nerol, neryl alcoholic acid, ocimene, 8-oxogeranial, paramenthane hydroperoxide, perilla ketone, perillaldehyde, perillartine, perillene, phellandrene, α-phellandrene, α-phellandrene-8-ol, β-phellandrene, picrocrocin, pinene, alpha-pinene, beta-pinene, piperitone, pulegone, rhodinol, rose oxide, sabinene, safranal, sobrerol, terpinen-4-ol, terpinene, terpineol or a-terpineol, thujaplicin, thujene, thujone, thymol, thymoquinone, umbellulone, verbenol, verbenone, and wine lactone.

In some embodiments, the at least one sesquiterpene may be selected from the group consisting of abscisic acid, amorpha-4,11-diene, aristolochene, artemether, artemotil, artesunate, bergamotene, bisabolene, bisabolol, bisacurone, botrydial, cadalene, cadinene, y-cadinene, cadina-1,4 diene, cadina-1(10),4-diene, alpha-cadinol, delta-cadinol, capnellene, capsidiol, carotol, caryophyllene, b-caryophyllene, caryphyllene oxide, cedrene, cedrol, copaene, cubebene, cubebol, curdione, curzerene, curzerenone, dictyophorine, drimane, elemene, farnesene, farnesol, farnesyl pyrophosphate, germacrene, germacrone, guaiazulene, guaiene, guaiol, gyrinal, hernandulcin, humulene, indometacin farnesyl, ionone, isocaryophyllene, b-caryophyllene, caryphyllene oxide, isocomene, juvabione, khusimol, koningic acid, ledol, longifolene, matricin, mutisianthol, nardosinone, nerol, neryl alcoholidol, nootkatone, norpatchoulenol, onchidal, patchoulol, periplanone b, petasin, phaseic acid, polygodial, rishitin, α-santalol, β-santalol, santonic acid, selinene, spathulenol, thujopsene, tripfordine, triptofordin c-2, valencene, velleral, verrucarin a, vetivazulene, α-vetivone, and zingiberene.

In some embodiments, the at least one essential oil may be selected from the group consisting of African lemon bush (Lippia javanica) oil, anise oil, bay oil, bergamot oil, boronia oil, canola oil, carrot oil, cassia oil, catnip oil, cedarwood oil, chamomile oil, cinnamon oil, citronella oil, clary sage oil, clove oil, cypress oil, eucalyptus oil, galbanum oil, garlic oil, ginger oil, geranium oil, grapefruit oil, hazelnut oil, jasmine oil, jojoba oil, lavender oil, lavandin oil, lemon oil, lemongrass oil, lime oil, mandarin oil, nutmeg oil, orange oil, palma rosa oil, patchouli oil, Peru balsams, peppermint oil, rosemary oil, rosewood oil, sage oil, sandalwood oil, spear mint oil, star anise oil, tea tree oil, tangerine oil, thyme oil, tolu balsam oil, verbena oil, white clover oil, ylang ylang oil, and combinations thereof.

In some embodiments, the at least one polymyxin may be selected from the group consisting of polymyxin A, polymyxin B, polymyxin B1, polymyxin B nonapeptide, polymyxin C, polymyxin D, and polymyxin E (colistin), and other cationic cyclic decapeptides.

In some embodiments, the at least one added element may comprise a hydrocarbon, such as but not limited to cyclohexane, cyclohexene, 3-acetoxy-4-(1-hydroxy-1-methylethyl)-1-methyl, cycloehexane, an aldehyde such as but not limited to 2-furaldehyde (furfural), a ketone such as but not limited to sulcatone, nonanone, or 4-nonanone, tagalose, D-(−)-tagalose, D-(+)-tagalose, mannopyranose, b-D-(+)-mannopyranose, b-D-(−)-mannopyranose, sulctone, 2,3-dehydro-1,8-cineole, a-phellandren-8-ol, 2,6-octadien-1-ol, 3,7-dimethyl-acetate, caryophyllene, g-cadinene, cadina-1(10),4-diene, carophyllene oxide, [(2-ethyl-5-methylfuran-3,4-diyl)bis(oxy)]bis(trimethylsilane), a polymer such as siloxane or pentasiloxane, or a gas such as silane or [(2-Ethyl-5-methylfuran-3,4-diyl)bis(oxy)]bis(trimethylsilane).

In some embodiments, the at least one biodetergent may comprise one or more glycolipid biodetergents, phospholipid biodetergents, polymeric biodetergents, lipopeptide biodetergents, cyclic lipopeptides, crude cyclic lipopeptides, lipopeptide detergents, sophorolipids, rhamnolipids, trehalose lipids, sucrose lipids, fructose lipids, mycolates, mannosyl erythritol lipids, corynemycolic acids, lichenysins, peptidolipids, mannan-fatty acid complex, and proteo-lipid-carbohydrate complexes.

In some embodiments, the at least one biodetergent may comprise one or more of surfactin, iturin, fengycin, arthrofactin, emulsan, or another biodetergent known to be applicable in leather tanning processes.

In some embodiments, the at least one biodetergent may comprise one or more biodetergent produced by Bacillus sp. Bacillus atrophaeus, Bacillus licheniformis, Bacillus subtilis, Bacillus siamensis, Bacillus thuringiensis, Bacillus pumilus, Bacillus cereus, Torulopsis sp. Pseudomonas sp. Rhodococcus sp. Candida sp. Candida bogoriensis, Acinetobacter sp. Corynebacterium lepus, Candida petrophilum, Candida tropicalis, Corynebacterium hydrocarboclastus, Flavobacterium sp. Achromobacter sp. Arthrobacter sp. Micrococcus sp. Paenibacillus sp. or any other microbial species named herein or known to produce biodetergents.

In some embodiments, the at least one biodetergent may comprise docusate (dioctyl sodium sulfosuccinate), lithium dodecyl sulfate (LDS), sodium laureth sulfate (sodium dodecyl sulfate or SDS), sodium myreth sulfate, ammonium lauryl sulfate, perfluorooctanesulfonate (PFOS), perfluorobutanesulfonate, sodium cholate, sodium deoxycholate, sodium glycholate, sodium taurocholate, sodium tauro-deoxycholate, sodium lauroyl sarcosinate (N-laurylsarcosine), hexadecyltrimethylammonium bromide, tetradecyltrimethylammonium bromide, dodecyltrimethylammonium bromide, alkyl polyglycoside, cetomacrogol 1000, cetostearyl alcohol, cetyl alcohol, cocamide DEA, cocamide MEA, decyl glucoside, decyl polyglucose, Eusapon BW, Eusapon EM, Eusapon FB-WT, Eusapon OC, Eusapon OD, Eusapon OE, Eusapon W, glycerol, glycerol trilaurate, glycerol monostearate, IGEPAL CA-630, isoceteth-20, lauryl glucoside, maltosides, monolaurin, mycosubtilin, narrow-range ethoxylate, nonidet P-40, nonoxynol-9, nonoxynols, nonyl phenoxypolyethoxylethanol, octaethylene glycol monododecyl ether, n-octyl-β-D-glucoside, n-octyl beta-D-thioglucopyranoside, n-octyl-β-D-gluco-pyranoside, genapol C-100, genapol X-100, octyl glucoside, oleyl alcohol, PEG-10 sunflower glycerides, pentaethylene glycol monododecyl ether, polidocanol, poloxamer, poloxamer 407, polyethoxylated tallow amine, polyglycerol polyricinoleate, polysorbate, polysorbate 20, polysorbate 40, polysorbate 60, polysorbate 65, polysorbate 80, sorbitan, sorbitan monolaurate, sorbitan monostearate, sorbitan tristearate, stearyl alcohol, surfactin, digitonin, n-Dodecyl β-D-maltoside (DDM), triton X-100, triton X-114, tween 20, tween 40, tween 60, tween 80, n-dodecyl tetra (ethylene oxide), n-octyl β-D-thioglucopyranoside (octylthioglucoside, OTG), dimethyl dodecyl phosphine oxide, dimethyldecylphosphine oxide, n-decyl-β-D-maltopyranoside, n-dodecyl-β-D-maltopyranoside, 6-cyclohexyl-1-hexyl-β-D-maltopyranoside n-octyl glucoside, n-nonanoyl-n-methylglucamine, n-octanoyl-n-methylglucamine, n-decanoyl-n-methylglucamine, any acyl-n-methylglucamide (MEGA) detergent, amidosulfobetaine-14, amidosulfobetaine-16, 3-[(3-cholamidopropyl)dimethylammonio]-1-propanesulfonate (CHAPS), 3-[(3-Cholamidopropyl)dimethylammonio]-2-hydroxy-1-propanesulfonate (CHAPSO), 3-(4-Heptyl)phenyl-3-hydroxypropyl)dimethylammoniopropanesulfonate (C7BzO), 3-(N,N-dimethyloctylammonio)propanesulfonate, 3-(dimethyl-octylazaniumyl)propane-1-sulfonate, cocamidopropyl hydroxysultaine, cocamidopropyl betaine, or 3-(1-pyridinio)-1-propanesulfonate.

In some embodiments, the at least one biodetergent is surfactin.

In one or more embodiments, the at least one carbon source is selected from the group consisting of rum, molasses, glucose, starch, cellulose, fructose, sucrose, arabinose, mannose, glucosamine, maltose, silage, stover, chaff, grass, stalks, leaves, flour, syrup, protein, fat, fatty acids, acetic acid, fumaric acid, adipic acid, propionic acid, citric acid, gluconic acid, malic acid, methylmaleic acid, pyruvic acid, malonic acid, carbohydrates, peptone, yeast extract, amino acids, ethanol, glycerol, glycerol trilaurate, soybean oil, rice bran oil, olive oil, corn oil, and sesame oil.

In one or more embodiments, the biodegradable cleaning composition may be decanted prior to extraction from a fermentation tank.

In one or more embodiments, the biodegradable cleaning composition may be decanted using a solid-liquid separation centrifuge prior to extraction from a fermentation tank.

In one or more embodiments, the biodegradable cleaning composition has a surface tension between about 20 dyne/cm and about 38 dyne/cm.

In one or more embodiments, a biodegradable cleaning composition may comprise:
a. a co-culture comprising at least one species of microbe selected from the group consisting of at least one species of lactic acid bacteria, at least one species of Bacillus, and at least one yeast;
b. at least one carboxylic acid;
c. at least one carbon source;
d. dechlorinated water; and
e. at least one added element, wherein the added element is selected from the group comprising at least one polyol, at least one diol, at least one polyethylene glycol, at least one polysaccharide-lipid complex, at least one monoterpene, at least one sesquiterpene, at least one essential oil, at least one polymyxin, and at least one biodetergent.

In one or more embodiments, the at least one species of lactic acid bacteria is selected from the group consisting of a species of Carnobacterium sp. Enterococcus sp. Lactobacillus sp. Lactococcus sp. Leuconostoc sp. Oenococcus sp. Streptococcus sp. Tetragenococcus sp. Vagococcus sp. and Weissella sp.

In one or more embodiments, the at least one species of Bacillus is selected from the group consisting of Bacillus cereus, Bacillus thuringiensis, Bacillus weihenstephanensis, Bacillus licheniformis, Bacillus pumilus, Bacillus mycoides, Bacillus coagulans, Bacillus megaterium, and Bacillus subtilis.

In one or more embodiments, the at least one organic acid is selected from the group consisting of acetic acid, adipic acid, azelaic acid, carboxylic acid, benzoic acid, dihydroxy benzoic acid, 2,3-benzoic acid, dihydroxy benzoic acid, tricarboxylic acid(s), propane-1, 2, 3-tricarboxylic acid, citric acid, homo citric acid, isocitric acid, itaconic acid, gluconic acid, glycolic acid, lactic acid, malic acid, methylmaleic acid, propionic acid, pyruvic acid, succinic acid, sebacic acid, tartaric acid, and uric acid.

In one or more embodiments, the at least one unsaturated fatty acid is present at a molar concentration of 0.1M to 1M.

In one or more embodiments, the at least one saturated fatty acid is present at a molar concentration of 0.1M to 1M.

In one or more embodiments, the at least one polyol is selected from the group consisting of ethylene glycol, glycerol, glycerol trilaurate, erythritol, threitol, arabitol, D-(+)-arabitol, L-(−)-arabitol, xylitol, ribitol, mannitol, D-mannitol, sorbitol, glucitol, D-glucitol, galactitol, fucitol, iditol, inositol, volemitol, isomalt, maltitol, lactitol, maltotriitol, maltotetraitol, and polyglycitol.

In one or more embodiments, the at least one diol is selected from the group consisting of 1,2-propanediol (propylene glycol), 2,2-propanediol, 1,1-propanediol, 1,3-propanediol, butane diol(s), 1,4-butanediol, ethylene glycol, geminal diols, vicinal diols, 1,3-diols, 1,4-diols, 1,5-diols, longer than 1,5-diols, 5-(1-Hydroxy-1-methylethyl)-2-methyl-2-cyclohexene-1,4-diol, and aliphatic diols.

In one or more embodiments, the at least one polyethylene glycol is selected from the group consisting of monofunctional PEGs, homobifunctional PEGs, heterobifunctional PEGs, linear PEGs, multi-arm PEGs, Y-shaped PEGs, low molecular weight PEGs (less than 5 kDa), PEGs of less than 40 kDa, PEGs greater than 40 kDa, poly(ethylene glycol), polyethylene glycol 40, polyethylene glycol 200, polyethylene glycol 300, polyethylene glycol 400, polyethylene glycol 600, polyethylene glycol 1000, polyethylene glycol 1500, polyethylene glycol 3000, polyethylene glycol 3500, polyethylene glycol 4000, polyethylene glycol 6000, polyethylene glycol 8000, poly(ethylene glycol) bis(amine), poly(ethylene glycol) bisazide, poly(ethylene glycol) bis(carboxymethyl) ether, poly(ethylene glycol) diacrylate, poly(ethylene glycol) diamine, poly(ethylene glycol) dibenzoate, poly(ethylene glycol) diglycidyl ether, poly(ethylene glycol) dimethacrylate, poly(ethylene glycol) dimethyl ether, poly(ethylene glycol) dithiol, poly(ethylene glycol) methacrylate, poly(ethylene glycol) methyl ether, poly(ethylene glycol) methyl ether methacrylate, poly(ethylene glycol) monolaurate, poly(ethylene glycol) monooleate, poly(ethylene glycol) sorbitol, glucitol, D-glucitol hexaoleate, poly(ethylene glycol) tetrahydrofurfuryl ether.

In one or more embodiments, the at least one polysaccharide-lipid complex is selected from the group consisting of a lipopolysaccharide, lipooligosaccharide, or endotoxins produced by a microbe of the group comprising but not limited to E. coli O26, E. coli EH-100, E. coli 0111, E. coli 055, E. coli 0127, E. coli 0128, E. coli F-583, E. coli J5, E. coli K-235, Pseudomonas aeroginosa 10, Salmonella, Salmonella enteritidis, Salmonella minnesota, Salmonella minnesota strain Re595, Salmonella typhimurium, Salmonella typhimurium strain SL1181, Salmonella typhimurium strain TV119, Salmonella typhosa, and Serratia marcescens.

In one or more embodiments, the at least one monoterpene is selected from the group consisting of 3-carene, ascaridole, bornane, borneol, camphene, camphor, camphorquinone, carvacrol, carveol, carvone, carvonic acid, chrysanthemic acid, chrysanthenone, citral, a-citral, b-citral, citronellal, citronellol, cuminaldehyde, p-cymene, cymenes, epomediol, eucalyptol, 1,8-cineole (11, eucalyptol), 2,3-dehydro-1,8-cineole, fenchol, fenchone, geranic acid, geraniol, geranyl acetate, geranyl pyrophosphate, grandisol, grapefruit mercaptan, halomon, hinokitiol, hydroxycitronellal, 8-hydroxygeraniol, incarvillateine, (s)-ipsdienol, jasmolone, lavandulol, lavandulol acetate, lavandulyl acetate, levoverbenone, limonene, linalool, 6,7-dihydro-7-hydroxylinalool, linalyl acetate, lineatin, p-menthane-3,8-diol, menthofuran, menthol, menthone, menthoxypropanediol, menthyl acetate, 2,6-octadien-1-ol, 3,7-dimethyl-, acetate, 2-methylisoborneol, myrcene, myrcenol, nerol, neryl alcohol, nerol, neryl alcoholic acid, ocimene, 8-oxogeranial, paramenthane hydroperoxide, perilla ketone, perillaldehyde, perillartine, perillene, phellandrene, α-phellandrene, α-phellandrene-8-ol, β-phellandrene, picrocrocin, pinene, alpha-pinene, beta-pinene, piperitone, pulegone, rhodinol, rose oxide, sabinene, safranal, sobrerol, terpinen-4-ol, terpinene, terpineol or a-terpineol, thujaplicin, thujene, thujone, thymol, thymoquinone, umbellulone, verbenol, verbenone, and wine lactone.

In one or more embodiments, the at least one sesquiterpene is selected from the group consisting of abscisic acid, amorpha-4,11-diene, aristolochene, artemether, artemotil, artesunate, bergamotene, bisabolene, bisabolol, bisacurone, botrydial, cadalene, cadinene, y-cadinene, cadina-1,4 diene, cadina-1(10),4-diene, alpha-cadinol, delta-cadinol, capnellene, capsidiol, carotol, caryophyllene, b-caryophyllene, caryphyllene oxide, cedrene, cedrol, copaene, cubebene, cubebol, curdione, curzerene, curzerenone, dictyophorine, drimane, elemene, farnesene, farnesol, farnesyl pyrophosphate, germacrene, germacrone, guaiazulene, guaiene, guaiol, gyrinal, hernandulcin, humulene, indometacin farnesyl, ionone, isocomene, juvabione, khusimol, koningic acid, ledol, longifolene, matricin, mutisianthol, nardosinone, nerol, neryl alcoholidol, nootkatone, norpatchoulenol, onchidal, patchoulol, periplanone b, petasin, phaseic acid, polygodial, rishitin, α-santalol, β-santalol, santonic acid, selinene, spathulenol, thujopsene, tripfordine, triptofordin c-2, valencene, velleral, verrucarin a, vetivazulene, α-vetivone, and zingiberene.

In one or more embodiments, the at least one essential oil is an organic essential oil selected from the group consisting of African lemon bush (Lippia javanica) oil, anise oil, bay oil, bergamot oil, boronia oil, canola oil, carrot oil, cassia oil, catnip oil, cedarwood oil, chamomile oil, cinnamon oil, citronella oil, clary sage oil, clove oil, cypress oil, eucalyptus oil, galbanum oil, garlic oil, ginger oil, geranium oil, grapefruit oil, hazelnut oil, jasmine oil, jojoba oil, lavender oil, lavandin oil, lemon oil, lemongrass oil, lime oil, mandarin oil, nutmeg oil, orange oil, palma rosa oil, patchouli oil, Peru balsams, peppermint oil, rosemary oil, rosewood oil, sage oil, sandalwood oil, spear mint oil, star anise oil, tea tree oil, tangerine oil, thyme oil, tolu balsam oil, verbena oil, white clover oil, and ylang ylang oil.

In one or more embodiments, the at least one polymyxin is selected from the group consisting of polymyxin A, polymyxin B, polymyxin B1, polymyxin B nonapeptide, polymyxin C, polymyxin D, and polymyxin E (colistin), and other cationic cyclic decapeptides.

In one or more embodiments, the at least one biodetergent is selected from the group consisting of surfactin, iturin, fengycin, arthrofactin, emulsan.

In one or more embodiments, the at least one biodetergent is a biodetergent produced by at least one species of microbe selected from the group consisting of Bacillus sp. Bacillus atrophaeus, Bacillus licheniformis, Bacillus subtilis, Bacillus siamensis, Bacillus thuringiensis, Bacillus pumilus, Bacillus cereus, Torulopsis sp. Pseudomonas sp. Rhodococcus sp. Candida sp. Candida bogoriensis, Acinetobacter sp. Corynebacterium lepus, Candida petrophilum, Candida tropicalis, Corynebacterium hydrocarboclastus, Flavobacterium sp. Achromobacter sp. Arthrobacter sp. Micrococcus sp. and Paenibacillus sp.

In one or more embodiments, the at least one carbon source is selected from the group consisting of rum, molasses, glucose, starch, cellulose, fructose, sucrose, arabinose, mannose, glucosamine, maltose, silage, stover, chaff, grass, stalks, leaves, flour, syrup, protein, fat, fatty acids, acetic acid, fumaric acid, adipic acid, propionic acid, citric acid, gluconic acid, malic acid, methylmaleic acid, pyruvic acid, malonic acid, carbohydrates, peptone, yeast extract, amino acids, ethanol, glycerol, glycerol trilaurate, soybean oil, rice bran oil, olive oil, corn oil, and sesame oil.

In one or more embodiments, the biodegradable cleaning composition is decanted prior to extraction from a fermentation tank, and wherein said decanting is performed using a solid-liquid separation centrifuge.

In one or more embodiments, the biodegradable cleaning composition has a surface tension between about 20 dyne/cm and about 38 dyne/cm.

In one or more embodiments, a method of manufacturing one or more biodegradable cleaning compositions may comprise the steps of
a. obtaining a probiotic starting culture comprising at least one species of microbe selected from the group consisting of at least one species of lactic acid bacteria and at least one Bacillus species; at least one organic acid; at least one carbon source; and dechlorinated water;
b. beginning a fermentation period, wherein the probiotic starting culture is fermented in at least one fermentation tank for at least one fermentation period;
c. adding at least one additional element to the probiotic starting culture, wherein the at least one additional element comprises one or more of at least one essential oil; at least one monoterpene; at least one sesquiterpene; at least one essential oil, at least one carboxylic acid; at least one organic acid; at least one fatty acid; at least one polyol; at least one diol; at least one polyethylene glycol; at least one polysaccharide-lipid complex; at least one polymyxin; and at least one biodetergent;
d. allowing the probiotic starting culture and the at least one additional element to ferment into a fermented product;
e. ending the fermentation period; and
f. decanting the fermented product into a biodegradable cleaning composition.

In one or more embodiments, the fermentation period may last at least one day.

In one or more embodiments, the fermentation period may last 14 days.

In one or more embodiments, the fermentation period may last 14 days or more.

In one or more embodiments, the at least one additional element may comprise one or more stabilizer, microbial inoculant, antioxidant, or preservative.

In one or more embodiments, the decanting step may be performed using a solid-liquid separation centrifuge.

In one or more embodiments, the decanting step may be performed using a centrifuge operating at 22,000-23,000 revolutions per minute.

In one or more embodiments, the decanting step may further comprise passing the fermented product into the centrifuge at a material feed rate of 150 cc/minute.

In one or more embodiments, the step of decanting the fermented product may further comprise passing the fermented product through a micron filter one or more times.

In one or more embodiments, the micron filter may be a 30 micron filter.

In one or more embodiments, a biodegradable cleaning composition may be produced by any process described herein.

In one or more embodiments, a biodegradable cleaning composition may be produced by any method described herein.

### Definitions

Unless defined otherwise, all technical and scientific terms used herein have the same meaning as is commonly understood by one of ordinary skill in the art. All patents, applications, published applications and other publications are incorporated by reference in their entirety. In the event that there is a plurality of definitions for a term herein, those in this section prevail unless stated otherwise.

The term “about” means within the inclusive range of ±15% of the numerical value it modifies.

As used herein, “administering” is used in its broadest sense to mean contacting a subject, surface, liquid, or environment with a composition of the invention.

The term “culture” refers to a culture of microorganisms that includes at least two microorganisms of the present disclosure, described herein. The term “brew” may be used in place of “culture”. The terms “culture and “co-culture” may be used interchangeably.

The term “detectable” as used herein means at or above the limit of detection of a colony-forming unit of particular bacteria, yeast, or other microbes in a microorganism consortium, or at or above the limit of detection of a element or compound, either free or in solution. Any element, compound, or species detected by any known method constitutes “detected”.

Methods for determining the presence of (detecting) a particular species or strain of microbe include culture techniques and non-culture techniques. Culture techniques include the use of selective agar media and determination of colony morphology, such as e.g., LAMVAB and Rogosa agar for Lactobacilli ssp., liver-cysteine-lactose and raffinose for Bifidobacterium ssp., heterotrophic plate counting, and the like. Non-culture techniques include e.g., flow cytometry, direct epifluorescent counting, PCR and other DNA-based methods, such as quantitative PCR, and metabolic/chemical methods, such as propidium monoazide PCR or ethidium monoazide PCR. Methods of detection useful in the practice of this invention are described in Catherine Davis, “Enumeration of biofertilizer strains: Review of culture-dependent and alternative techniques to quantify viable bacteria,” Journal of Microbiological Methods, Volume 103, 2014, pp. 9-17; Jackson and Bird, “Comparison of two selective media for the detection and enumeration of Lactobacilli in human faeces,” Journal of Microbiological Methods 51 (2002) 313-321; Lu et al., “Fine Structure of Tibetan Kefir Grains and Their Yeast Distribution, Diversity, and Shift,” PLoS One. 2014; 9(6): e101387; Rachbid et al., “Assessment of the microbial diversity of Brazilian kefir grains by PCR-DGGE and pyrosequencing analysis,” Food Microbiology, Volume 31, Issue 2, September 2012, Pages 215-221; Furet et al., “Molecular quantification of lactic acid bacteria in fermented milk products using real-time quantitative PCR,” International Journal of Food Microbiology, Volume 97, Issue 2, 15 Dec. 2004, Pages 197-207; and Garcia-Cayuel et al., “Simultaneous detection and enumeration of viable lactic acid bacteria and bifidobacteria in fermented milk by using propidium monoazide and real-time PCR,” International Dairy Journal, Volume 19, Issues 6-7, June-July 2009, Pages 405-409.

The phrase “fermentation medium” may refer to a mixture including at least one microorganism, expression products of the microorganism(s), substances produced by the microorganisms, extracts of the microorganisms, and a culture medium or other elements of a culture medium. In some embodiments, the expression product or substance produced by a microorganism may comprise a gas or organic compound product of the fermentation of a carbohydrate, such as an organic acid like acetic acid, citric acid, gluconic acid, lactic acid, propionic acid, pyruvic acid, or succinic acid, a gas like carbon dioxide, or an alcohol like ethanol. In a preferred embodiment, the expression product or substance produced by a microorganism is lactic acid, ethanol, or a combination of lactic acid and ethanol.

“Fermentation product” refers to both or either organic chemical products of a fermentation reaction (e.g., carbon dioxide, ethanol, lactic acid, propionic acid), and/or the fermented carbon source (e.g., fermented sugar cane molasse, fermented rice bran).

The term “finished product” refers to a mixture including a fermentation product. The finished product may include additional additives.

The term “monoculture” refers to a culture having a single species of microorganism.

The phrase “non-pathogenic gram-positive Bacilli bacteria” refers to those bacteria that belong to the Bacilli taxonomic class of bacteria that contains two orders, Bacillales and Lactobacillales. The term “gram-positive” is used herein to distinguish the subject Bacilli from the group of gram-negative rod-shaped bacteria that are sometimes referred to as bacilli, including for example Escherichia coli and other coliform bacteria. The term “non-pathogenic” is used to refer to those Bacilli that do not cause disease or harm to a plant or animal, i.e., excluding pathogenic bacteria. For example, certain species of Bacillus (e.g., anthraces), Listeria, Staphylococcus, and Streptococcus are pathogenic and are excluded. Non-limiting examples of non-pathogenic gram-positive Bacilli bacteria include Bifidobacterium spp., Lactobacillus spp., Lactococcus spp., Carnobacterium spp., Streptococcus spp., and Bacillus spp.

The term “microorganism consortium” refers to a composition that contains a live beneficial or useful microorganism alone, in combination with another microorganism, and/or combined with other ingredients such as e.g., energy sources, pre-biotics, stabilizers, and the like, in culture media. Beneficial microorganisms are generally known in the art and include such bacteria as lactic acid fermenting (obligative and facultative) bacteria, phototrophic bacteria, and non-pathogenic bacilli, as well as fermenting yeast such as the Saccharomycetaceae. Microorganism consortiums are generally known to be useful in ameliorating gut flora, remediating wastewater, treating microbial imbalances in animals and plants, protecting animals, plants, and soil from harmful microbes, and improving food animal and food plant production and yield. Useful biofertilizer microorganisms can be found listed for example in Biofertilizer Bacteria: Fundamentals, Therapy, and Technological Aspects, edited by J. Paulo Sousa e Silva, Ana Cristina Freitas, CRC Press, Apr. 2, 2014; and The European Union Register of Feed Additives pursuant to Regulation (EC) No 1831/2003, Annex I: List of additives, available at https://ec.europa.eu/food/sites/food/files/safety/docs/animal-feed-eu-regcomm_register_feed_additives_1831-03.pdf.

The term “probiotic starting culture” refers to a microorganism consortium prior to combination with other ingredients.

The term “excipient” refers to an inert substance added to a pharmaceutical composition to further facilitate administration of a composition. Examples, without limitation, of excipients include calcium carbonate, calcium phosphate, various sugars and types of starch, cellulose derivatives, gelatin, vegetable oils and polyethylene glycols. Techniques for formulation and administration of pharmaceutical compositions are known in the art and may be found in “Remington's Pharmaceutical Sciences,” Mack Publishing Co., Easton, Pa., latest edition, which is incorporated herein by reference.

As various changes could be made in the above compositions and methods without departing from the scope of the invention, it is intended that all matter contained in the above description and in the Examples given below, shall be interpreted as illustrative and not in a limiting sense.

What is claimed is:

1. A biodegradable cleaning composition, comprising:
a. a probiotic starting culture comprising
i. at least one species of microbe selected from the group consisting of at least one species of lactic acid bacteria and at least one species of Bacillus;
ii. at least one carbon source, and
iii. dechlorinated water; and
b. at least one added element selected from the group consisting of at least one essential oil, carbon source, biodetergent, organic acid, preservative, diol, polyol, polymyxin, polysaccharide-lipid complex, fatty acid, terpene, and preservative.

2. The biodegradable cleaning composition of claim 1, wherein the at least one species of lactic acid bacteria is selected from the group consisting of a species of Carnobacterium sp. Enterococcus sp. Lactobacillus sp. Lactococcus sp. Leuconostoc sp. Oenococcus sp. Streptococcus sp. Tetragenococcus sp. Vagococcus sp. and Weissella sp.

3. The biodegradable cleaning composition of claim 1, wherein the at least one species of Bacillus is selected from the group consisting of Bacillus licheniformis, Bacillus coagulans, and Bacillus subtilis.

4. The biodegradable cleaning composition of claim 1, wherein the at least one added element is at least one essential oil selected from the group consisting of African lemon bush (Lippia javanica) oil, anise oil, bay oil, bergamot oil, boronia oil, canola oil, carrot oil, cassia oil, catnip oil, cedarwood oil, chamomile oil, cilantro oil, cinnamon oil, citronella oil, clary sage oil, clove oil, coriander oil, cypress oil, eucalyptus oil, galbanum oil, garlic oil, ginger oil, geranium oil, grapefruit oil, hazelnut oil, jasmine oil, jojoba oil, lavender oil, lavandin oil, lemon oil, lemongrass oil, lime oil, mandarin oil, nutmeg oil, orange oil, palma rosa oil, patchouli oil, pine oil, Peru balsams, peppermint oil, rosemary oil, rosewood oil, sage oil, sandalwood oil, spear mint oil, star anise oil, tea tree oil, tangerine oil, thyme oil, tolu balsam oil, verbena oil, white clover oil, and ylang ylang oil.

5. The biodegradable cleaning composition of claim 1, wherein the at least one carbon source is selected from the group consisting of rum, molasses, glucose, starch, cellulose, fructose, sucrose, arabinose, mannose and maltose.

6. The biodegradable cleaning composition of claim 1, wherein the at least one added element is at least one biodetergent selected from the group consisting of surfactin, iturin, fengycin, arthrofactin, emulsan.

7. The biodegradable cleaning composition of claim 1, wherein the at least one added element is a biodetergent produced by at least one species of microbe selected from the group consisting of Bacillus sp. Bacillus atrophaeus, Bacillus licheniformis, Bacillus subtilis, Bacillus siamensis, Bacillus thuringiensis, Bacillus pumilus, Bacillus cereus, Torulopsis sp. Pseudomonas sp. Rhodococcus sp. Candida sp. Candida bogoriensis, Acinetobacter sp. Corynebacterium lepus, Candida petrophilum, Candida tropicalis, Corynebacterium hydrocarboclastus, Flavobacterium sp. Achromobacter sp. Arthrobacter sp. Micrococcus sp. and Paenibacillus sp.

8. The biodegradable cleaning composition of claim 1, wherein the at least one added element is at least one organic acid selected from the group consisting of acetic acid, adipic acid, azelaic acid, carboxylic acid, benzoic acid, homo citric acid, isocitric acid, itaconic acid, gluconic acid, glycolic acid, lactic acid, malic acid, methylmaleic acid, propionic acid, pyruvic acid, succinic acid, sebacic acid, tartaric acid, and uric acid.

9. The biodegradable cleaning composition of claim 1, wherein the at least one added element is at least one diol selected from the group consisting of 1,2-propanediol (propylene glycol), 2,2-propanediol, 1,1-propanediol, 1,3-propanediol, butane diol(s), 1,4-butanediol, ethylene glycol, geminal diols, vicinal diols, 1,3-diols, 1,4-diols, 1,5-diols, longer than 1,5-diols, 5-(1-Hydroxy-1-methylethyl)-2-methyl-2-cyclohexene-1,4-diol, and aliphatic diols.

10. The biodegradable cleaning composition of claim 1, wherein the at least one added element is at least one polyol selected from the group consisting of polyethylene glycol, glycerol, glycerol trilaurate, erythritol, threitol, arabitol, D-(+)-arabitol, L-(−)-arabitol, xylitol, ribitol, mannitol, D-mannitol, sorbitol, glucitol, D-glucitol, galactitol, fucitol, iditol, inositol, volemitol, isomalt, maltitol, lactitol, maltotriitol, maltotetraitol, and polyglycitol.

11. The biodegradable cleaning composition of claim 1, wherein the at least one added element is at least one polymyxin is selected from the group consisting of polymyxin A, polymyxin B, polymyxin B1, polymyxin B nonapeptide, polymyxin C, polymyxin D, and polymyxin E (colistin), and other cationic cyclic decapeptides.

12. The biodegradable cleaning composition of claim 1, wherein the at least one added element is at least one polysaccharide-lipid complex selected from the group consisting of a lipopolysaccharide, lipooligosaccharide, or endotoxins produced by a microbe of the group comprising but not limited to E. coli O26, E. coli EH-100, E. coli 0111, E. coli 055, E. coli 0127, E. coli 0128, E. coli F-583, E. coli J5, E. coli K-235, Pseudomonas aeroginosa 10, Salmonella, Salmonella enteritidis, Salmonella minnesota, Salmonella minnesota strain Re595, Salmonella typhimurium, Salmonella typhimurium strain SL1181, Salmonella typhimurium strain TV119, Salmonella typhosa, and Serratia marcescens.

13. The biodegradable cleaning composition of claim 1, wherein the at least one added element is at least one fatty acid selected from the group consisting of formic acid, acetic acid, propionic acid, butyric acid, isobutyric acid, valeric acid, isovaleric acid, caproic acid, enanthic acid, caprylic acid, pelargonic acid, capric acid, undecylic acid, lauric acid, tridecylic acid, myristic acid, pentadecanoic acid, palmitic acid, margaric acid, stearic acid, nonadecylic acid, arachidic acid, heneicosylic acid, behenic acid, tricosylic acid, lignoceric acid, pentacosylic acid, cerotic acid, heptacosylic acid, montanic acid, nonacosylic acid, melissic acid, hentriacontylic acid, lacceroic acid, psyllic acid, geddic acid, ceroplastic acid, hexatriacontylic acid, heptatriacontanoic acid, octatriacontanoic acid, nonatriacontanoic acid, tetracontanoic acid, octanoic acid, decanoic acid, decadienoic acid, eicosatrienoic acid, hexadecatrienoic acid, lauroleic acid, laurolinoleic acid, myristovaccenic acid, myristolinoleic acid, myristolinolenic acid, palmitolinolenic acid, palmitidonic acid, α-linolenic acid, stearidonic acid, dihomo-α-linolenic acid, eicosatrienoic acid, eicosatetraeonic acid, eicosapentaenoic acid, heneicosapentaenoic acid, clupanodonic acid, docosahexaenoic acid, docosapentaenoic acid tetracosapentaenoic acid, tetracosahexaenoic acid, myristoleic acid, palmitovaccenic acid, α-eleostearic acid, β-eleostearic acid, punicic acid, 7,10,13-octadecatrienoic acid, 9,12,15-eicosatrienoic acid, and β-eicosatetraenoic acid, 8-tetradecenoic acid, 12-octadecenoic acid, linoleic acid, linolelaidic acid, gamma-linolenic acid, calendic acid, eicosadienoic acid, pinolenic acid, dihomo-linoleic acid, dihomo-gamma-linolenic acid, docosadienoic acid, arachidonic acid, tetracosatetraenoic acid, tetracosapentaenoic acid, adrenic acid, and osbond acid, palmitoleic acid, vaccenic acid, 11-octadecanoic acid, cis-vaccenic acid, rumenic acid, paullinic acid, 5-dodecenoic acid, 7-tetradecenoic acid, 7,10,13-eicosatrienoic acid, 15-docosenoic acid, 17-tetracosenoic acid, oleic acid, elaidic acid, gondoic acid, erucic acid, nervonic acid, 8,11-eicosadienoic acid, ximenic acid, mead acid, sapienic acid, gadoleic acid, 4-hexadecenoic acid, petroselinic acid, and 8-eicosenoic acid.

14. The biodegradable cleaning composition of claim 1, wherein the at least one added element is at least one terpene selected from the group consisting of 3-carene, ascaridole, bornane, borneol, camphene, camphor, camphorquinone, carvacrol, carveol, carvone, carvonic acid, chrysanthemic acid, chrysanthenone, citral, a-citral, b-citral, citronellal, citronellol, cuminaldehyde, p-cymene, cymenes, epomediol, eucalyptol, 1,8-cineole (11, eucalyptol), 2,3-dehydro-1,8-cineole, fenchol, fenchone, geranic acid, geraniol, geranyl acetate, geranyl pyrophosphate, grandisol, grapefruit mercaptan, halomon, hinokitiol, hydroxycitronellal, 8-hydroxygeraniol, incarvillateine, (s)-ipsdienol, jasmolone, lavandulol, lavandulol acetate, lavandulyl acetate, levoverbenone, limonene, linalool, 6,7-dihydro-7-hydroxylinalool, linalyl acetate, lineatin, p-menthane-3,8-diol, menthofuran, menthol, menthone, menthoxypropanediol, menthyl acetate, 2,6-octadien-1-ol, 3,7-dimethyl-, acetate, 2-methylisoborneol, myrcene, myrcenol, nerol, neryl alcohol, nerol, neryl alcoholic acid, ocimene, 8-oxogeranial, paramenthane hydroperoxide, perilla ketone, perillaldehyde, perillartine, perillene, phellandrene, α-phellandrene, α-phellandrene-8-ol, β-phellandrene, picrocrocin, pinene, alpha-pinene, beta-pinene, piperitone, pulegone, rhodinol, rose oxide, sabinene, safranal, sobrerol, terpinen-4-ol, terpinene, terpineol or a-terpineol, thujaplicin, thujene, thujone, thymol, thymoquinone, umbellulone, verbenol, verbenone, wine lactone, abscisic acid, amorpha-4,11-diene, aristolochene, artemether, artemotil, artesunate, bergamotene, bisabolene, bisabolol, bisacurone, botrydial, cadalene, cadinene, y-cadinene, cadina-1,4 diene, cadina-1(10),4-diene, alpha-cadinol, delta-cadinol, capnellene, capsidiol, carotol, caryophyllene, b-caryophyllene, caryphyllene oxide, cedrene, cedrol, copaene, cubebene, cubebol, curdione, curzerene, curzerenone, dictyophorine, drimane, elemene, farnesene, farnesol, farnesyl pyrophosphate, germacrene, germacrone, guaiazulene, guaiene, guaiol, gyrinal, hernandulcin, humulene, indometacin farnesyl, ionone, isocomene, juvabione, khusimol, koningic acid, ledol, longifolene, matricin, mutisianthol, nardosinone, nerol, neryl alcoholidol, nootkatone, norpatchoulenol, onchidal, patchoulol, periplanone b, petasin, phaseic acid, polygodial, rishitin, α-santalol, β-santalol, santonic acid, selinene, spathulenol, thujopsene, tripfordine, triptofordin c-2, valencene, velleral, verrucarin a, vetivazulene, α-vetivone, and zingiberene.

15. The biodegradable cleaning composition of claim 1, wherein the at least one added element is at least one preservative selected from the group consisting of potassium sorbate, calcium sorbate, calcium ascorbate, sodium sorbate, sodium ascorbate, sodium erythorbate, sodium benzoate, sodium sulfite, sodium bisulfite, sodium metabisulfite, sodium nitrite, sodium nitrate, sodium iso-ascorbate, potassium ascorbate, potassium acetate, potassium benzoate, potassium bisulphite, potassium nitrate, potassium nitrite, potassium bisulfite, potassium metabisulfite, potassium diacetate, potassium lactate, butylated hydroxyanisole (BHA), butylated hydroxytolu balsam oilene (BHT), disodium ethylenediaminetetraacetic acid (EDTA), citric acid, organic citric acid, sulphur dioxide, propyl paraben, methyl paraben, benzene, acetic acid, tocopherol, ascorbic acid, erythorbic acid, iso-ascorbic acid, benzoic acid, wood smoke, ethyl lauroyl arginate, 4-hexylresorcinol, methyl-ρ-hydroxy benzoate, nisin, propionic acid, propyl-ρ-hydroxy benzoate, sorbic acid, natamycin, and dimethyl decarbonate.

16. The biodegradable cleaning composition of claim 15, wherein the at least one preservative is present in a ratio of from about 0.1-0.3 wt/wt %.

17. The biodegradable cleaning composition of claim 1, further comprising at least one second additional element selected from the group consisting of cyclohexene, 3-acetoxy-4-(1-hydroxy-1-methylethyl)-1-methyl, cycloehexane, 2-furaldehyde (furfural), sulcatone, 4-nonanone, tagalose, D-(−)-tagalose, D-(+)-tagalose, mannopyranose, b-D-(+)-mannopyranose, b-D-(−)-mannopyranose, sulctone, 2,3-dehydro-1,8-cineole, a-phellandren-8-ol, 2,6-octadien-1-ol, 3,7-dimethyl-acetate, caryophyllene, g-cadinene, cadina-1(10),4-diene, carophyllene oxide, pentasiloxane, and [(2-Ethyl-5-methylfuran-3,4-diyl)bis(oxy)]bis(trimethylsilane).

18. The biodegradable cleaning composition of claim 1, wherein the biodegradable cleaning composition has a surface tension between about 20 dyne/cm and about 38 dyne/cm.

19. The biodegradable cleaning composition of claim 1, wherein the biodegradable cleaning composition is about 80 to about 85 wt/wt % dechlorinated water.

20. The biodegradable cleaning composition of claim 1, wherein the biodegradable cleaning composition is about 90 to about 95 wt/wt % dechlorinated water.

21. A kit comprising a textile treated with an application of the biodegradable cleaning composition of any one of claims 1-16, wherein the application is performed according to a ratio, and wherein said textile is contained within an openable container.

22. The kit of claim 21, wherein the ratio is from about 5 ml per textile sheet to about 15 ml per textile sheet.

23. The kit of claim 22, wherein the textile is selected from the group consisting of lyocell, rayon, cotton polyester, and polypropylene.

24. A method of manufacturing a biodegradable cleaning composition comprising the steps of:
a. obtaining a probiotic starting culture comprising at least one species of microbe selected from the group consisting of at least one species of lactic acid bacteria and at least one Bacillus species; at least one organic acid; at least one carbon source; and dechlorinated water;
b. beginning a fermentation period, wherein the probiotic starting culture is fermented in at least one fermentation tank for at least one fermentation period;
c. adding at least one additional element selected from the group consisting of at least one essential oil, carbon source, biodetergent, organic acid, preservative, diol, polyol, polymyxin, polysaccharide-lipid complex, fatty acid, terpene, and preservative.
d. allowing the probiotic starting culture and the at least one additional element to ferment into a fermented product;
e. ending the fermentation period;
f. decanting the fermented product; and
g. extracting the biodegradable cleaning composition.

25. The method of claim 24, wherein the decanting step is performed using a solid-liquid separation centrifuge operating at 22,000-23,000 revolutions per minute.

26. The method of claim 25, wherein the decanting step further comprises passing the fermented product into the centrifuge at a material feed rate of 150 cc/minute.

27. The method of claim 26, wherein the decanting step further comprises passing the fermented product through a 30-micron filter one or more times.

28. A biodegradable cleaning composition produced by the method of claim 24.

29. A biodegradable cleaning composition produced by the method of claim 27.
